(19) United States
(12) Patent Application Publication
(10) Pub. No.: US 2026/0332339 A1
(43) Pub. Date: Oct. 22, 2026

(54) METHOD AND DEVICE FOR TRANSMITTING AND RECEIVING UPLINK REFERENCE SIGNALS IN WIRELESS COMMUNICATION SYSTEM

(71) Applicant: SAMSUNG ELECTRONICS CO., LTD., Suwon-si, Gyeonggi-do (KR)

(72) Inventors: Youngrok JANG, Suwon-si (KR); Ameha Tsegaye ABEBE, Suwon-si (KR); Seongmok LIM, Suwon-si (KR); Hyoungju JI, Suwon-si (KR); Kyungjun CHOI, Suwon-si (KR)

(21) Appl. No.: 19/103,523

(22) PCT Filed: Aug. 11, 2023
(86) PCT No.: PCT/KR2023/011920

§ 371 Date: Feb. 12, 2025

(30) Foreign Application Priority Data
Aug. 12, 2022 (KR) 10-2022-0101058

(51) Int. Cl. H04L 5/00; H04W 8/24

(52) U.S. Cl. CPC H04L 5/0051; H04L 5/0007; H04W 8/24

(57) ABSTRACT

The present disclosure relates to a 5G or 6G communication system for supporting higher data transmission rates. A method performed by a terminal of a communication system according to one embodiment of the present disclosure comprises the steps of: receiving, from a base station, configuration information including the number (Nₛ) of orthogonal frequency division multiplexing (OFDM) symbols associated with a sounding reference signal (SRS) resource and the number (N) of antenna ports associated with the SRS resource; identifying the antenna ports mapped to each of the OFDM symbols associated with the SRS resource; and transmitting SRSs to the base station in the OFDM symbols associated with the SRS resource on the basis of the antenna ports mapped to each of the OFDM symbols, wherein N may be 8 or greater.

### TECHNICAL FIELD

The present disclosure relates to the operation of a terminal and a base station in a wireless communication system. Specifically, the present disclosure relates to a method for transmitting and receiving an uplink reference signal in a wireless communication system and a device capable of performing the same.

### BACKGROUND ART

5G mobile communication technologies define broad frequency bands such that high transmission rates and new services are possible, and may be implemented not only in “Sub 6 GHz” bands such as 3.5 GHz, but also in “Above 6 GHz” bands referred to as mm Wave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles on the basis of information regarding positions and states of vehicles transmitted by the vehicles and for enhancing user convenience, NR-U (New Radio Unlicensed) aimed at system operations conforming to various regulation-related requirements in unlicensed bands, NR user equipment (UE) Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIOT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services on the basis of UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next generation distributed computing technology for implementing services at levels of complexity exceeding the limit of UE operation capability by utilizing ultra-high-performance communication and computing resources.

### DISCLOSURE OF INVENTION

### Technical Problem

The disclosed embodiment is intended to provide a device and method capable of effectively providing a service in a mobile communication system.

### Solution to Problem

According to one embodiment of the present invention for achieving the technical problem as described above, a method performed by a terminal of a communication system comprises the steps of: receiving, from a base station, configuration information including the number (Nₛ) of orthogonal frequency division multiplexing (OFDM) symbols associated with a sounding reference signal (SRS) resource and the number (N) of antenna ports associated with the SRS resource; identifying the antenna ports mapped to each of the OFDM symbols associated with the SRS resource; and transmitting an SRSs to the base station in the OFDM symbols associated with the SRS resource on the basis of the antenna ports mapped to each of the OFDM symbols, wherein N may be 8 or greater.

In addition, a method performed by a base station of a communication system according to one embodiment of the present invention comprises the steps of: transmitting, to a terminal, configuration information including the number (Nₛ) of orthogonal frequency division multiplexing (OFDM) symbols associated with a sounding reference signal (SRS) resource and the number (N) of antenna ports associated with the SRS resource; identifying the antenna ports mapped to each of the OFDM symbols associated with the SRS resource; and receiving an SRS from the terminal in the OFDM symbols associated with the SRS resource on the basis of the antenna ports mapped to each of the OFDM symbols, wherein N may be 8 or greater.

In addition, a terminal of a communication system according to one embodiment of the present invention comprises a transceiver; and a control unit configured to receive, from a base station, configuration information including the number (Nₛ) of orthogonal frequency division multiplexing (OFDM) symbols associated with a sounding reference signal (SRS) resource and the number (N) of antenna ports associated with the SRS resource, identify the antenna ports mapped to each of the OFDM symbols associated with the SRS resource, and transmit an SRS to the base station in an OFDM symbol associated with the SRS resource on the basis of the antenna ports mapped to each of the OFDM symbols, wherein N may be 8 or greater.

In addition, a base station of a communication system according to one embodiment of the present invention comprises a transceiver; and a control unit configured to transmit, to a terminal, configuration information including the number (Nₛ) of orthogonal frequency division multiplexing (OFDM) symbols associated with a sounding reference signal (SRS) resource and the number (N) of antenna ports associated with the SRS resource, identify the antenna ports mapped to each of the OFDM symbols associated with the SRS resource, and receive an SRS from the terminal in the OFDM symbols associated with the SRS resource on the basis of the antenna ports mapped to each of the OFDM symbols, wherein N may be 8 or greater.

### Advantageous Effects of Invention

The disclosed embodiment provides a device and method capable of effectively providing a service in a mobile communication system.

### BRIEF DESCRIPTION OF DRAWINGS

FIG. 1 is a diagram illustrating a basic structure of a time-frequency domain in a wireless communication system according to one embodiment of the present disclosure.

FIG. 2 is a diagram illustrating a frame, subframe, and slot structure in a wireless communication system according to one embodiment of the present disclosure.

FIG. 3 is a diagram illustrating an example of bandwidth part configurations in a wireless communication system according to one embodiment of the present disclosure.

FIG. 4 is a diagram illustrating an example of configuring a control resource set of a downlink control channel in a wireless communication system according to one embodiment of the present disclosure.

FIG. 5a is a diagram illustrating the structure of a downlink control channel in a wireless communication system according to one embodiment of the present disclosure.

FIG. 5b is a diagram illustrating a case in which a terminal may have multiple PDCCH monitoring positions within a slot through span in a wireless communication system according to one embodiment of the present disclosure.

FIG. 6 is a diagram illustrating an example of DRX operation in a wireless communication system according to one embodiment of the present disclosure.

FIG. 7 is a diagram illustrating an example of base station beam allocation according to TCI state configurations in a wireless communication system according to one embodiment of the present disclosure.

FIG. 8 is a diagram illustrating an example of a TCI state allocation method for a PDCCH in a wireless communication system according to one embodiment of the present disclosure.

FIG. 9 is a diagram illustrating a TCI indication MAC CE signaling structure for PDCCH DMRS in a wireless communication system according to one embodiment of the present disclosure.

FIG. 10 is a diagram illustrating an example of beam configuration of a control resource set and a search space in a wireless communication system according to one embodiment of the present disclosure.

FIG. 11 is a diagram explaining a method for a base station and a terminal to transmit and receive data in consideration of a downlink data channel and rate matching resources in a wireless communication system according to one embodiment of the present disclosure.

FIG. 12 is a diagram for explaining a method for selecting a control resource set that may be received by a terminal while considering priorities when receiving a downlink control channel in a wireless communication system according to one embodiment of the present disclosure.

FIG. 13 is a diagram illustrating an example of frequency domain resource allocation of a PDSCH in a wireless communication system according to one embodiment of the present disclosure.

FIG. 14 is a diagram illustrating an example of time domain resource allocation of PDSCH in a wireless communication system according to one embodiment of the present disclosure.

FIG. 15 is a diagram illustrating an example of time domain resource allocation according to subcarrier spacing of a data channel and a control channel in a wireless communication system according to one embodiment of the present disclosure.

FIG. 16 illustrates a process for beam configuration and activation of PDSCH.

FIG. 17 is a diagram illustrating an example of PUSCH repetition transmission type B in a wireless communication system according to one embodiment of the present disclosure.

FIG. 18 is a diagram illustrating a wireless protocol structure of a base station and a terminal in a single cell, carrier aggregation, and dual connectivity situation in a wireless communication system according to one embodiment of the present disclosure.

FIG. 19 is a diagram illustrating a structure in which SRS is allocated for each subband.

FIG. 20 is a diagram illustrating the operation of a terminal for SRS transmission according to one embodiment of the present disclosure.

FIG. 21 is a diagram illustrating the operation of a base station for SRS reception according to one embodiment of the present disclosure.

FIG. 22 is a diagram illustrating the structure of a terminal in a wireless communication system according to one embodiment of the present disclosure.

FIG. 23 is a diagram illustrating the structure of a base station in a wireless communication system according to one embodiment of the present disclosure.

### MODE FOR THE INVENTION

Hereinafter, embodiments of the present disclosure will be described in detail with reference to the attached drawings.

In describing the embodiments, descriptions of technical contents that are well known in the technical field to which the present disclosure belongs and are not directly related to the present disclosure are omitted. This is to convey the gist of the present disclosure more clearly without obscuring it by omitting unnecessary descriptions.

For the same reason, some components in the attached drawings are exaggerated, omitted, or schematically illustrated. In addition, the size of each component does not entirely reflect the actual size. The same or corresponding components in each drawing are assigned the same reference numbers.

The advantages and features of the present disclosure and methods for achieving them will become clear by reference to the embodiments described in detail below along with the accompanying drawings. However, the present disclosure is not limited to the embodiments disclosed below, but may be implemented in a variety of different forms and the present embodiments are merely provided to ensure that the disclosure of the present disclosure is complete and to fully inform the scope of the disclosure to persons of ordinary knowledge in the technical field to which the present disclosure pertains, and the present disclosure is only defined by the scope of the claims. Throughout the specification, the same reference numerals refer to the same components. In addition, when describing the present disclosure, if it is determined that a detailed description of a related function or configuration may unnecessarily obscure the gist of the present disclosure, the detailed description will be omitted. In addition, the terms described below are terms defined in consideration of the functions in the present disclosure and may vary depending on the intention or custom of the user or operator. Therefore, the definition should be made on the basis of the contents throughout this specification.

Hereinafter, the base station is an entity that performs resource allocation of a terminal, and may be at least one of a gNode B, an eNode B, a Node B, a base station (BS), a wireless access unit, a base station controller, or a node on a network. The terminal may include a user equipment (UE), a mobile station (MS), a cellular phone, a smartphone, a computer, or a multimedia system capable of performing a communication function. In the present disclosure, the downlink (DL) refers to a wireless transmission path of a signal that a base station transmits to a terminal, and the uplink (UL) refers to a wireless transmission path of a signal that a terminal transmits to a base station. In addition, although the LTE or LTE-A system may be described as an example below, the embodiments of the present disclosure may be applied to other communication systems having a similar technical background or channel type. For example, the 5th generation mobile communication technology (5G, new radio, NR) developed after LTE-A may be included here, and the 5G below may be a concept that includes existing LTE, LTE-A, and other similar services. In addition, the present disclosure may be applied to other communication systems through some modifications without significantly departing from the scope of the present disclosure, as judged by a person having skilled technical knowledge.

In this case, it will be understood that each block of the processing flowchart illustrations and combinations of the flowchart illustrations may be performed by computer program instructions. These computer program instructions may be mounted on a processor of a general purpose computer, a special purpose computer, or other programmable data processing equipment, such that the instructions, when executed by the processor of the computer or other programmable data processing equipment, create means for performing the functions described in the flowchart block(s). These computer program instructions may be stored in computer-usable or computer-readable memory that may be directed to a computer or other programmable data processing equipment to implement the functions in a specific manner, so that the instructions stored in the computer-usable or computer-readable memory may produce a manufactured item comprising instructional means for performing the functions described in the flowchart block(s). The computer program instructions may also be mounted on a computer or other programmable data processing equipment and a series of operational steps are performed on the computer or other programmable data processing equipment to create a computer-executable process, such that the instructions performing the computer or other programmable data processing equipment may also provide steps for performing the functions described in the flowchart block(s).

In addition, each block may represent a module, a segment, or a portion of code comprising one or more executable instructions for performing a specified logical function(s). It should also be noted that in some alternative embodiments, the functions recited in the blocks may occur out of sequence. For example, two blocks shown one after the other may in fact be performed substantially simultaneously, or the blocks may be performed in reverse order according to the functions they sometimes perform.

In this case, the term ‘~unit’ used in the present embodiment refers to software or a hardware component such as a Field Programmable Gate Array (FPGA) or Application Specific Integrated Circuit (ASIC), which may perform any of the roles. However, ‘~unit’ is not software or hardware specific. It may be configured to reside on an addressable storage medium, or it may be configured to execute one or more processors. Therefore, in one example, ‘~unit’ includes components such as software components, object-oriented software components, class components, and task components, processes, functions, properties, procedures, subroutines, segments of program code, drivers, firmware, microcode, circuits, data, databases, data structures, tables, arrays, and variables. The functionality provided within the components and ‘~units’ may be combined into fewer components and ‘~units’, or further separated into additional components and ‘~units’. Furthermore, the components and ‘~units’ may be implemented to play one or more CPUs within the device or the security multimedia card. In addition, in the embodiment, ‘~unit’ may include one or more processors.

Wireless communication systems have evolved from providing initially voice-oriented services to broadband wireless communication systems that provide high-speed, high-quality packet data services, for example, using communication standards such as 3GPP's High Speed Packet Access (HSPA), Long Term Evolution (LTE) or Evolved Universal Terrestrial Radio Access (E-UTRA), LTE-Advanced (LTE-A), LTE-Pro, 3GPP2's High Rate Packet Data (HRPD), Ultra Mobile Broadband (UMB), and IEEE's 802.16e.

As a representative example of the broadband wireless communication system, the LTE system adopts the Orthogonal Frequency Division Multiplexing (OFDM) method for the downlink (DL) and the Single Carrier Frequency Division Multiple Access (SC-FDMA) method for the uplink (UL). Uplink refers to a wireless link in which a terminal (User Equipment (UE) or Mobile Station (MS)) transmits data or control signals to a base station (eNode B, or base station (BS)), and downlink refers to a wireless link in which a base station transmits data or control signals to a terminal. In the above multiple access method, the data or control information of each user may be distinguished by allocating and operating the time-frequency resources to carry data or control information for each user so that they do not overlap, i.e., orthogonality is established.

As a future communication system after LTE, i.e., 5G communication system should be able to freely reflect various requirements of users and service providers, so services that satisfy various requirements simultaneously should be supported. The services considered for 5G communication systems include enhanced Mobile Broadband (eMBB), massive Machine Type Communication (mMTC), and Ultra Reliability Low Latency Communication (URLLC).

eMBB aims to provide higher data rates than those supported by conventional LTE, LTE-A, or LTE-Pro. For example, in a 5G communication system, eMBB should be able to provide a peak data rate of 20 Gbps in the downlink and 10 Gbps in the uplink from the perspective of one base station. In addition, 5G communication systems must provide peak data rates while also providing increased user perceived data rates. To meet these requirements, various transmission and reception technologies will need to be improved, including more advanced multi-antenna (Multi Input Multi Output, MIMO) transmission technologies. In addition, while LTE uses up to 20 MHz transmission bandwidth in the 2 GHz band to transmit signals, 5G communication systems will use wider frequency bandwidths than 20 MHz in the 3-6 GHz or 6 GHz or higher frequency bands to meet the data transmission rates required by 5G communication systems.

At the same time, mMTC is being considered to support application services such as the Internet of Things (IoT) in 5G communication systems. In order to efficiently deliver the Internet of Things, mMTC needs to support the access of a large number of terminals within a cell, improve coverage of terminals, improve battery life, and reduce the cost of terminals. Since the Internet of Things will be attached to multiple sensors and various devices to provide communication capabilities, it must be able to support a large number of terminals (e.g., 1,000,000 terminals/km2) within a cell. Additionally, due to the nature of the service, mMTC-enabled terminals are likely to be located in shadowed areas that are not covered by cells, such as the basement of a building, and may require greater coverage than other services provided by 5G communication systems. The mMTC-enabled devices will need to be low-cost devices and may require very long battery life times, such as 10 to 15 years, as it is difficult to replace the device's battery frequently.

Lastly, URLLC is a cellular-based wireless communication service used for specific mission-critical purposes. Examples include services used for remote control of robots or machinery, industrial automation, unmanned aerial vehicles, remote health care, emergency alerts, etc. As such, the communication provided by URLLC must be extremely low latency and highly reliable. For example, services that support URLLC must satisfy an air interface latency of less than 0.5 milliseconds, while simultaneously having a packet error rate requirement of 75 or less. Therefore, for services supporting URLLC, the 5G system may need to provide a smaller Transmit Time Interval (TTI) than other services, and at the same time, the design may require a large resource allocation in the frequency band to ensure the reliability of the communication link.

The three services of 5G, namely eMBB, URLLC, and mMTC, may be multiplexed and transmitted in one system. In this case, different transmission and reception techniques and transmission and reception parameters may be used among the services to satisfy the different requirements of each service. Of course, 5G is not limited to the above three services.

### [NR Time-Frequency Resource]

In the following, the frame structure of the 5G system will be described in more detail with reference to the drawings.

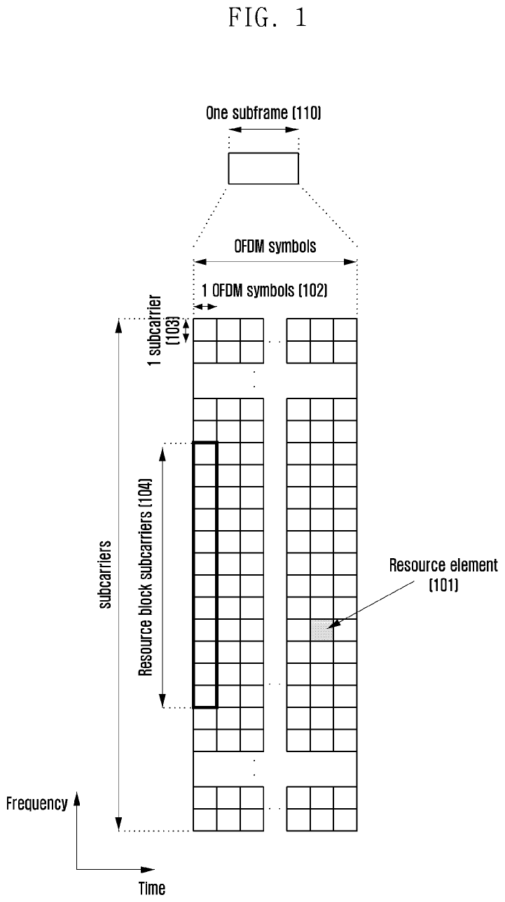

FIG. 1 is a diagram illustrating the basic structure of the time-frequency domain, which is a radio resource domain where data or control channels are transmitted in a 5G wireless communication system.

With reference to FIG. 1, the horizontal domain represents the time domain, and the vertical domain represents the frequency domain. The basic unit of resources in the time and frequency domains is a Resource Element (RE) 101, which is defined as 1 Orthogonal Frequency Division Multiplexing (OFDM) symbol 102 on the time domain and 1 subcarrier 103 on the frequency domain. In the frequency domain,

$${N}_{sc}^{RB}$$

(for example, 12) consecutive REs may constitute one Resource Block (RB) 104.

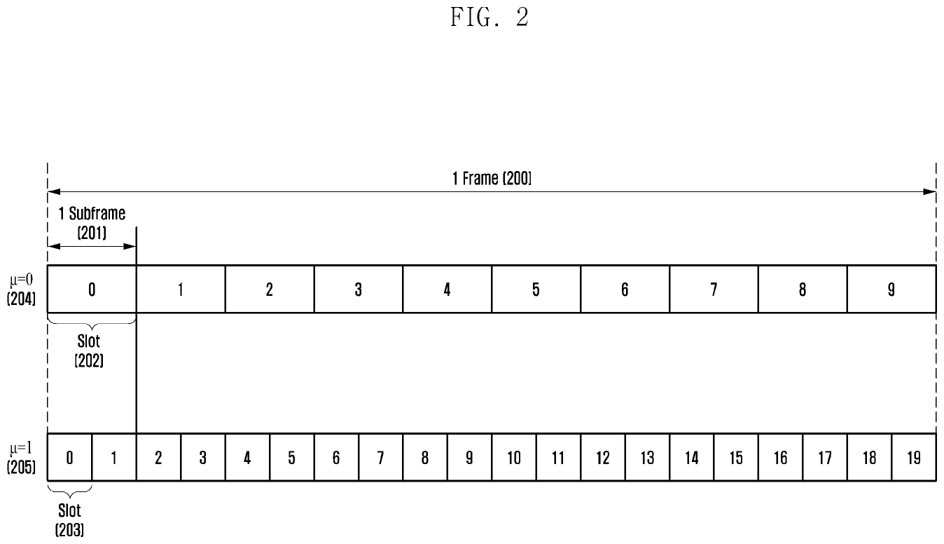

FIG. 2 is a diagram illustrating a frame, subframe, and slot structure in a wireless communication system according to one embodiment of the present disclosure.

With reference to FIG. 2, an example of a structure of a frame 200, a subframe 201, and a slot 202 is illustrated. 1 frame 200 may be defined as 10 ms. 1 subframe 201 may be defined as 1 ms, and therefore 1 frame 200 may consist of a total of 10 subframes 201. 1 slot 202 and 203 may be defined by 14 OFDM symbols (that is, the number of symbols per slot

$$( {N}_{symb}^{slot} ) = 14 ) .$$

1 subframe 201 may consist of one or multiple slots 202 and 203, and the number of slots 202 and 203 per 1 subframe 201 may vary depending on the configuration value μ 204 and 205 for the subcarrier spacing. In an example of FIG. 2, a case where μ=0 204 and a case where μ=1 205 are illustrated as the subcarrier spacing configuration value. When μ=0 204, 1 subframe 201 may consist of one slot 202, and when μ=1 205, 1 subframe 201 may consist of two slots 203. That is, the number of slots per subframe

$$( {N}_{slot}^{subframe , μ} )$$

may vary depending on the configuration value u for the subcarrier spacing, and the number of slots per one frame

$$( {N}_{slot}^{frame , μ} )$$

may vary accordingly.

$${N}_{slot}^{subframe , μ} and {N}_{slot}^{frame , μ}$$

according to each subcarrier spacing configuration μ may be defined as [Table 1] below.

TABLE 1

| μ | N_{symb}^{slot} | Nₛₗₒₜ^{frame,μ} | Nₛₗₒₜ^{subframe,μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

### [Bandwidth Part (BWP)]

Next, Bandwidth Part (BWP) configurations in the 5G communication system will be described in detail with reference to the drawings.

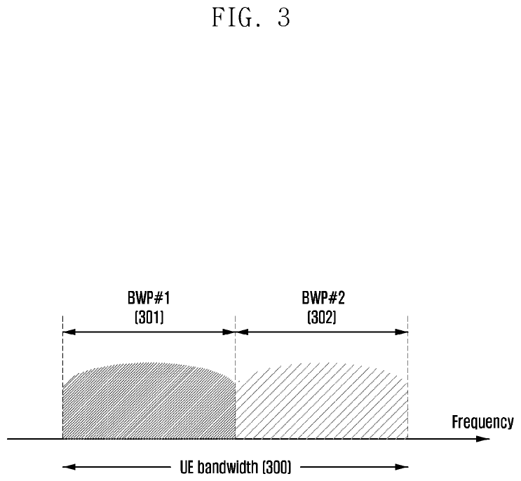

FIG. 3 is a diagram illustrating an example of bandwidth part configurations in a wireless communication system according to one embodiment of the present disclosure.

With reference to FIG. 3, an example is shown where the UE bandwidth 300 is configured to two bandwidth parts, that is, bandwidth part #1(BWP #1) 301 and bandwidth part #2(BWP #2) 302. The base station may configure one or more bandwidth parts to the terminal and may configure the following information for each bandwidth part.

TABLE 2

| | |
|---|---|
| BWP ::= | SEQUENCE { |
| bwp-Id | BWP-Id, |
| locationAndBandwidth | INTEGER (1..65536), |
| subcarrierSpacing | ENUMERATED {n0, n1, |
| n2, n3, n4, n5}, | |
| cyclicPrefix | ENUMERATED { extended |
| } | |
| } | |

Of course, the configurations for the bandwidth part are not limited to the above examples, and various parameters related to the bandwidth part may be configured to the terminal in addition to the above configuration information. The configuration information may be transmitted by the base station to the terminal through higher layer signaling, e.g., Radio Resource Control (RRC) signaling. At least one bandwidth part of the configured one or more bandwidth parts may be activated. The activation status for a configured bandwidth part may be semi-statically transmitted from the base station to the terminal through RRC signaling or dynamically transmitted through Downlink Control Information (DCI).

According to some embodiments, the terminal prior to the Radio Resource Control (RRC) connection may receive the Initial Bandwidth Part (Initial BWP) for the initial connection from the base station through the Master Information Block (MIB). More specifically, during the initial connection phase, the terminal may receive configuration information for the Control Resource Set (CORESET) and the search space in which a PDCCH may be transmitted to receive the system information required for the initial connection (which may correspond to Remaining System Information (RMSI) or System Information Block 1 (SIB1)) through the MIB. The control resource set and search space configured by the MIB may be regarded as Identity (ID) 0, respectively. The base station may notify the terminal of configuration information such as frequency allocation information, time allocation information, and numerology for control resource set #0 through the MIB. In addition, the base station may notify the terminal of the monitoring period and occasion for the control resource set #0 through the MIB, that is, the configuration information for the search space #0. The terminal may regard the frequency domain configured in the control resource set #0 obtained from the MIB as the initial bandwidth part for the initial connection. In this case, the identity (ID) of the initial bandwidth part may be regarded as 0.

The configuration for the bandwidth part supported by the 5G wireless communication system may be used for various purposes.

According to some embodiments, the configuration for the bandwidth part may be used when the bandwidth supported by the terminal is smaller than the system bandwidth. For example, the base station may configure the frequency location of the bandwidth part (configuration information 2) to the terminal, allowing the terminal to transmit and receive data at a specific frequency location within the system bandwidth.

In addition, according to some embodiments, the base station may configure multiple bandwidth parts to the terminal for the purpose of supporting different numerologies. For example, to support both data transmission and reception using a subcarrier spacing of 15 kHz and a subcarrier spacing of 30 kHz for a terminal, the base station may configure the two bandwidth parts to the subcarrier spacing of 15 kHz and 30 kHz, respectively. Different bandwidth parts may be frequency division multiplexed, and when the base station wants to transmit and receive data at a specific subcarrier interval, the bandwidth part configured at the corresponding subcarrier interval may be activated.

In addition, according to one embodiment, for the purpose of reducing power consumption of the terminal, the base station may configure bandwidth parts with bandwidths of different sizes to the terminal. For example, if the terminal supports a very large bandwidth, for example, 100 MHz, and always transmits and receives data through that bandwidth, very large power consumption may occur. In particular, monitoring unnecessary downlink control channels with a large bandwidth of 100 MHz in a situation where there is no traffic may be very inefficient in terms of power consumption. For the purpose of reducing the power consumption of the terminal, the base station may configure a relatively small bandwidth part, for example, a bandwidth part of 20 MHz, to the terminal. In a situation where there is no traffic, the terminal may perform monitoring operations in the 20 MHz bandwidth part, and when data is generated, it may transmit and receive data in the 100 MHz bandwidth part according to the instructions of the base station.

In the method of configuring the bandwidth part, terminals before RRC connection may receive configuration information regarding the Initial Bandwidth Part through Master Information Block (MIB) in the initial connection stage. To be more specific, the terminal may have a Control Resource Set (CORESET) be configured for the downlink control channel through which Downlink Control Information (DCI) scheduling System Information Block (SIB) may be transmitted from the MIB of Physical Broadcast Channel (PBCH). The bandwidth of the Control Resource Set configured as MIB may be regarded as the initial bandwidth part, and through the configured initial bandwidth part, the terminal may receive Physical Downlink Shared Channel (PDSCH) on which the SIB is transmitted. In addition to receiving SIB, the initial bandwidth part may also be used for Other System Information (OSI), Paging, and Random Access.

### [Bandwidth Part (BWP) Change]

If one or more bandwidth parts are configured, the base station may instruct the terminal to change (or switch, transition) the bandwidth part using the bandwidth part indicator field in the DCI. For example, in FIG. 3, if the currently activated bandwidth part of the terminal is bandwidth part #1 301, the base station may instruct the terminal to use the bandwidth part indicator in the DCI to indicate bandwidth part #2 302, and the terminal may perform a bandwidth part switch to bandwidth part #2 302 as indicated by the bandwidth part indicator in the received DCI.

As described above, since the DCI based bandwidth part switch may be directed by the DCI scheduling the PDSCH or PUSCH, the terminal shall be able to receive or transmit the PDSCH or PUSCH scheduled by that DCI in the switched bandwidth part without any difficulty when it receives the bandwidth part switch request. To this end, the standard specifies requirements for the required time delay (T_{BWP}) for a bandwidth part switch, which may be defined, for example, as follows.

TABLE 3

| | NR Slot | BWP switch delay T^{BWP} (slots) | |
|---|---|---|---|
| μ | length (ms) | Type 1^{Note1} | Type 2^{Note1} |
| 0 | 1 | 1 | 3 |
| 1 | 0.5 | 2 | 5 |
| 2 | 0.25 | 3 | 9 |
| 3 | 0.125 | 6 | 18 |

Note 1:
Depends on UE capability.
Note 2:
If the BWP switch involves changing of SCS, the BWP switch delay is determined by the larger one between the SCS before BWP switch and the SCS after BWP switch.

Requirements for bandwidth part switch delay time may support type 1 or type 2 depending on the UE capability. The terminal may report the supportable bandwidth part delay time type to the base station.

According to the requirements for bandwidth part switch time delay described above, when the terminal receives a DCI including a bandwidth part change indicator in slot n, the terminal may complete the change to the new bandwidth part indicated by the bandwidth part change indicator at a time not later than slot n+T_{BWP}, and may perform transmission and reception on the data channel scheduled by the DCI in the new bandwidth part. When the base station wants to schedule a data channel with a new bandwidth part, the base station may determine the time domain resource allocation for the data channel by considering the bandwidth part change delay time (T_{BWP}) of the terminal. That is, when the base station schedules a data channel with a new bandwidth part, the base station may schedule the data channel after the bandwidth part change delay time in determining the time domain resource allocation for the data channel. Accordingly, the terminal may not expect a DCI indicating a bandwidth part change to indicate a slot offset (K0 or K2) value that is less than the bandwidth part change delay time (T_{BWP}).

If the terminal has received a DCI (e.g., DCI format 1_1 or 0_1) that indicates a bandwidth part change, the terminal may not perform any transmissions or receptions during the time interval from the third symbol of the slot in which it received the PDCCH including that DCI to the beginning of the slot indicated by the slot offset (K0 or K2) value indicated by the time domain resource allocation indicator field within that DCI. For example, if a terminal receives a DCI instructing a bandwidth part change in slot n, and the slot offset value indicated by that DCI is K, the terminal may not perform any transmissions or receptions from the third symbol of slot n until the symbol before slot n+K (i.e., the last symbol of slot n+K−1).

### [SS/PBCH Block]

Next, the SS (Synchronization Signal)/PBCH block in the 5G wireless communication system will be described.

SS/PBCH block may refer to a physical layer channel block consisting of primary SS (PSS), secondary SS (SSS), and PBCH. Specifically, it may be as follows.
PSS: It is a signal that serves as a standard for downlink time/frequency synchronization and provides some information about the cell ID.
SSS: It is the standard for downlink time/frequency synchronization and provides the remaining cell ID information not provided by PSS. Additionally, it can serve as a reference signal for demodulation of PBCH.
PBCH: It provides essential system information necessary for transmitting and receiving data channels and control channels of the terminal. Essential system information may include search space-related control information indicating radio resource mapping information of the control channel, scheduling control information for a separate data channel transmitting system information, etc.
SS/PBCH block: SS/PBCH block consists of a combination of PSS, SSS, and PBCH. One or more SS/PBCH blocks may be transmitted within 5 ms, and each transmitted SS/PBCH block may be distinguished by an index.

The terminal may detect PSS and SSS in the initial access stage and decode the PBCH. The MIB may be obtained from the PBCH, and a control resource set (CORE SET) #0 (which may correspond to a control resource set with a control resource set index of 0) may be configured from this. The terminal may perform monitoring on control resource set #0 assuming that the selected SS/PBCH block and the Demodulation Reference Signal (DMRS) transmitted in control resource set #0 are in Quasi Co Location (QCL). The terminal may receive system information through downlink control information transmitted from control resource set #0. The terminal may obtain Random Access Channel (RACH) related configuration information necessary for initial access from the received system information. The terminal may transmit Physical RACH (PRACH) to the base station in consideration of the SS/PBCH index selected, and the base station receiving the PRACH may obtain information about the SS/PBCH block index selected by the terminal. The base station may know which block the terminal has selected among each SS/PBCH block and monitor the control resource set #0 related to it.

### [DRX]

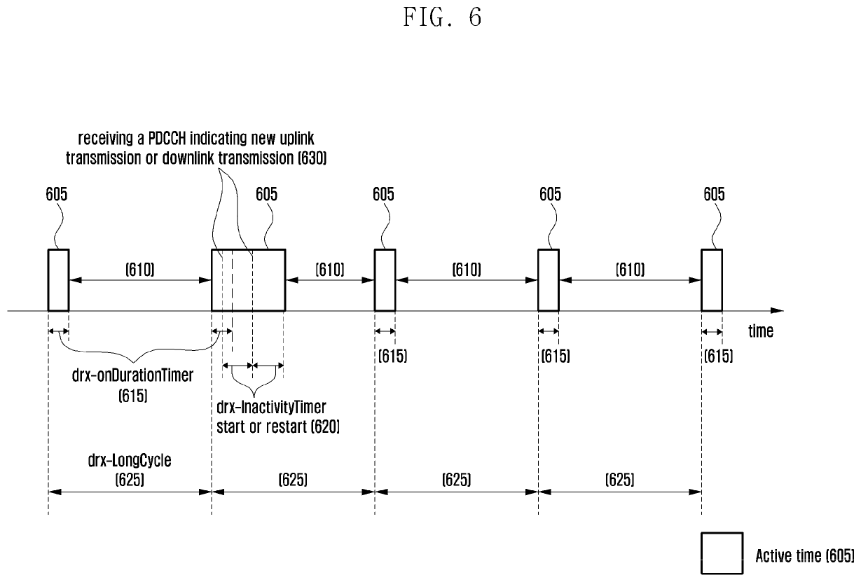

FIG. 6 is a diagram for explaining DRX (Discontinuous Reception).

DRX (Discontinuous Reception) is an operation in which a terminal using a service discontinuously receives data in an RRC connected state where a radio link is established between the base station and the terminal. When DRX is applied, the terminal turns on the receiver at a specific point in time to monitor the control channel, and turns off the receiver if no data is received for a certain period of time to reduce the power consumption of the terminal. The DRX operation may be controlled by a MAC layer device on the basis of various parameters and timers.

With reference to FIG. 6, Active time 605 is the time when the terminal wakes up every DRX cycle and monitors the PDCCH. Active time 605 may be defined as follows.
drx-onDurationTimer or drx-InactivityTimer or drx-RetransmissionTimerDL or drx-RetransmissionTimerUL or ra-ContentionResolutionTimer is running; or
a Scheduling Request is sent on PUCCH and is pending; or
a PDCCH indicating a new transmission addressed to the C-RNTI of the MAC entity has not been received after successful reception of a Random Access Response for the Random Access Preamble not selected by the MAC entity among the contention-based Random Access Preamble

drx-onDurationTimer, drx-InactivityTimer, drx-Retransmission TimerDL, drx-RetransmissionTimerUL, ra-ContentionResolutionTimer, etc. are timers whose values are configured by the base station, and they have the function of configuring the terminal to monitor the PDCCH when certain conditions are met.

drx-onDurationTimer 615 is a parameter to configure the minimum time for which the terminal stays awake in a DRX cycle. drx-InactivityTimer 620 is a parameter to configure the additional time for which the terminal stays awake when receiving 630 a PDCCH indicating new uplink transmission or downlink transmission. drx-RetransmissionTimerDL is a parameter to configure the maximum time for which the terminal stays awake to receive downlink retransmission in a downlink HARQ procedure. drx-Retransmission TimerUL is a parameter to configure the maximum time for which the terminal stays awake to receive uplink retransmission grant in an uplink HARQ procedure. drx-onDurationTimer, drx-InactivityTimer, drx-RetransmissionTimerDL, and drx-RetransmissionTimerUL may be configured to, for example, time, the number of subframes, the number of slots, etc. ra-ContentionResolutionTimer is a parameter for monitoring PDCCH in random access procedure.

The inActive time 610 is a time configured not to monitor PDCCH during DRX operation and/or a time configured not to receive PDCCH. The remaining time excluding the Active time 605 from the entire time of performing the DRX operation may be the inActive time 610. If the terminal does not monitor the PDCCH during the Active time 605, it may enter a sleep or inActive state to reduce power consumption.

DRX cycle refers to the period during which the terminal wakes up and monitors the PDCCH. In other words, it refers to the period of occurrence of the time interval or on duration after the terminal monitors the PDCCH and until it monitors the next PDCCH. There are two types of DRX cycles: short DRX cycle and long DRX cycle. The short DRX cycle may be applied as an option.

Long DRX cycle 625 is the longer cycle among the two DRX cycles configured in the terminal. While operating in Long DRX, the terminal starts drx-onDurationTimer 615 again at a point in time when Long DRX cycle 625 has elapsed from the starting point (e.g., start symbol) of drx-onDuration Timer 615. When operating in Long DRX cycle 625, the terminal may start drx-onDurationTimer 615 in a slot after drx-SlotOffset in a subframe satisfying Mathematical Formula 1 below. Here, drx-SlotOffset means a delay before starting drx-onDurationTimer 615. drx-SlotOffset may be configured to, for example, time, the number of slots, etc.

$$[ ( SFN X 10 ) + subframe number ] modulo ( drx - LongCycle ) = drx - StartOffset \qquad [ Equation 1 ]$$

At this time, drx-LongCycleStartOffset may be used to define a Long DRX cycle 625 and drx-StartOffset may be used to define a subframe to start the Long DRX cycle 625. drx-LongCycleStartOffset may be configured to, for example, time, number of subframes, number of slots, etc.

### [PDCCH: DCI Related]

Next, we will specifically explain downlink control information (DCI) in the 5G system.

In a 5G system, scheduling information for uplink data (or physical uplink shared channel (PUSCH)) or downlink data (or physical downlink shared channel (PDSCH)) is transmitted from a base station to a terminal through DCI. The terminal may monitor a DCI format for fallback and a DCI format for non-fallback for PUSCH or PDSCH. The fallback DCI format may be composed of fixed fields defined between the base station and the terminal, and the non-fallback DCI format may include configurable fields.

DCI may be transmitted through PDCCH (Physical Downlink Control Channel) which is a physical downlink control channel after going through channel coding and modulation process. CRC (Cyclic Redundancy Check) is attached to DCI message payload, and CRC may be scrambled with RNTI (Radio Network Temporary Identifier) corresponding to the identity of the terminal. Different RNTIs may be used depending on the purpose of DCI message, such as UE-specific data transmission, power control command, or random access response. That is, RNTI is not transmitted explicitly, but is included in the CRC calculation process and transmitted. When receiving DCI message transmitted on PDCCH, the terminal identifies CRC using allocated RNTI, and if CRC identification result is correct, the terminal may know that the message was transmitted to the terminal.

For example, a DCI scheduling a PDSCH for System Information (SI) may be scrambled with SI-RNTI. A DCI scheduling a PDSCH for a Random Access Response (RAR) message may be scrambled with RA-RNTI. A DCI scheduling a PDSCH for a Paging message may be scrambled with P-RNTI. A DCI notifying a Slot Format Indicator (SFI) may be scrambled with SFI-RNTI. A DCI notifying a Transmit Power Control (TPC) may be scrambled with TPC-RNTI. A DCI scheduling a UE-specific PDSCH or PUSCH may be scrambled with C-RNTI (Cell RNTI).

DCI format 0_0 may be used as a fallback DCI for scheduling PUSCH, where the CRC may be scrambled with C-RNTI. DCI format 0_0 with the CRC scrambled with C-RNTI may include, for example, the following information.

TABLE 4

Identifier for DCI formats - [1] bit
Frequency domain resource assignment -
$[ ⌈ {log}_{2} ( {N}_{RB}^{UL , BWP} ( {N}_{RB}^{UL , BWP} + 1 ) / 2 ) ⌉ ] bits$
Time domain resource assignment - X bits
Frequency hopping flag - 1 bit.
Modulation and coding scheme - 5 bits
New data indicator - 1 bit
Redundancy version - 2 bits
HARQ process number - 4 bits
TPC command for scheduled PUSCH - [2] bits
UL/SUL indicator - 0 or 1 bit

DCI format 0_1 may be used as a fallback DCI for scheduling PUSCH, where the CRC may be scrambled with C-RNTI. DCI format 0_1 with the CRC scrambled with C-RNTI may include, for example, the following information.

```
TABLE 5
  Carrier indicator - 0 or 3 bits
  UL/SUL indicator - 0 or 1 bit
  Identifier for DCI formats - [1] bits
  Bandwidth part indicator - 0, 1 or 2 bits
  Frequency domain resource assignment
    $For resource allocation type 0 , ⌈ {N}_{RB}^{UL , BWP} / P ⌉ bits$
    For resource allocatin type 1,
    $[ ⌈ {log}_{2} ( {N}_{RB}^{UL , BWP} ( {N}_{RB}^{UL , BWP} + 1 ) / 2 ) ⌉ ] bits$
    Time domain resource assignment -1, 2, 3, or 4 bits
    VRB-to-PRB mapping - 0 or 1 bit, only for resource
    allocation type 1.
      0 bit if only resource allocation type 0 is configured;
      1 bit otherwise.
    Frequency hopping flag - 0 or 1 bit, only for resource
    allocation type 1.
      0 bit if only resource allocation type 0 is configured;
      1 bit otherwise.
    Modulation and coding scheme - 5 bits
    New data indicator - 1 bit
    Redundancy version - 2 bits
    HARQ process number - 4 bits
    1st downlink assignment index - 1 or 2 bits
      1 bit for semi-static HARQ-ACK codebook;
      2 bits for dynamic HARQ-ACK codebook with single
      HARQ-ACK codebook.
    2nd downlink assignment index - 0 or 2 bits
      2 bits for dynamic HARQ-ACK codebook with two
      HARQ-ACK sub-codebooks;
      0 bit otherwise.
    TPC command for scheduled PUSCH - 2 bits
      $SRS resource indicator - ⌈ {log}_{2} ( {{\sum }_{k = 1}}^{{L}_{max}} ( \begin{matrix}{N}_{SRS} \\ k\end{matrix} ) ) ⌉ or ⌈ {log}_{2} ( {N}_{SRS} ) ⌉$
bits
        $⌈ {log}_{2} ( {{\sum }_{k = 1}}^{{L}_{max}} ( \begin{matrix}{N}_{SRS} \\ k\end{matrix} ) ) ⌉ bits for non - codebook based$
        PUSCH transmission;
        ┌log₂(N_{SRS})┐ bits for codebook based PUSCH
        transmission.
      Precoding information and number of layers - up to 6 bits
      Antenna ports - up to 5 bits
      SRS request - 2 bits
      CSI request - 0, 1, 2, 3, 4, 5, or 6 bits
      CBG transmission information - 0, 2, 4, 6, or 8 bits
      PTRS-DMRS association - 0 or 2 bits.
      beta_offset indicator - 0 or 2 bits
    DMRS sequence initialization - 0 or 1 bit
```

DCI format 1_0 may be used as a fallback DCI for scheduling PDSCH, where the CRC may be scrambled with C-RNTI. DCI format 1_0 with the CRC scrambled with C-RNTI may include, for example, the following information.

TABLE 6

Identifier for DCI formats - [1] bit
Frequency domain resource assignment -
$[ ⌈ {log}_{2} ( {N}_{RB}^{DL , BWP} ( {N}_{RB}^{DL , BWP} + 1 ) / 2 ) ⌉ ] bits$
Time domain resource assignment - X bits
VRB-to-PRB mapping - 1 bit.
Modulation and coding scheme - 5 bits
New data indicator - 1 bit
Redundancy version - 2 bits
HARQ process number - 4 bits
Downlink assignment index - 2 bits
TPC command for scheduled PUCCH - [2] bits
PUCCH resource indicator - 3 bits
PDSCH-to-HARQ feedback timing indicator - [3] bits

DCI format 1_1 may be used as a fallback DCI for scheduling PDSCH, where the CRC may be scrambled with C-RNTI. DCI format 1_1 with the CRC scrambled with C-RNTI may include, for example, the following information.

```
TABLE 7
  Carrier indicator - 0 or 3 bits
  Identifier for DCI formats - [1] bits
  Bandwidth part indicator - 0, 1 or 2 bits
  Frequency domain resource assignment
    $For resource allocation type 0 , ⌈ {N}_{RB}^{DL , BWP} / P ⌉ bits$
    For resource allocation type 1,
    $⌈ {log}_{2} ( {N}_{RB}^{DL , BWP} ( {N}_{RB}^{DL , BWP} + 1 ) / 2 ) ⌉ bits$
  Time domain resource assignment -1, 2, 3, or 4 bits
  VRB-to-PRB mapping - 0 or 1 bit, only for resource allocation type 1.
    0 bit if only resource allocation type 0 is configured;
    1 bit otherwise.
  PRB bundling size indicator - 0 or 1 bit
  Rate matching indicator - 0, 1, or 2 bits
  ZP CSI-RS trigger - 0, 1, or 2 bits
For transport block 1:
  Modulation and coding scheme - 5 bits
  New data indicator - 1 bit
  Redundancy version - 2 bits
For transport block 2:
  Modulation and coding scheme - 5 bits
  New data indicator - 1 bit
  Redundancy version - 2 bits
  HARQ process number - 4 bits
  Downlink assignment index - 0 or 2 or 4 bits
  TPC command for scheduled PUCCH - 2 bits
  PUCCH resource indicator - 3 bits
  PDSCH-to-HARQ_feedback timing indicator - 3 bits
  Antenna ports - 4, 5 or 6 bits
  Transmission configuration indication - 0 or 3 bits
  SRS request - 2 bits
  CBG transmission information - 0, 2, 4, 6, or 8 bits
  CBG flushing out information - 0 or 1 bit
  DMRS sequence initialization - 1 bit
```

### [PDCCH: CORESET, REG, CCE, Search Space]

In the following, the downlink control channel in a 5G communication system will be described in more detail with reference to drawings.

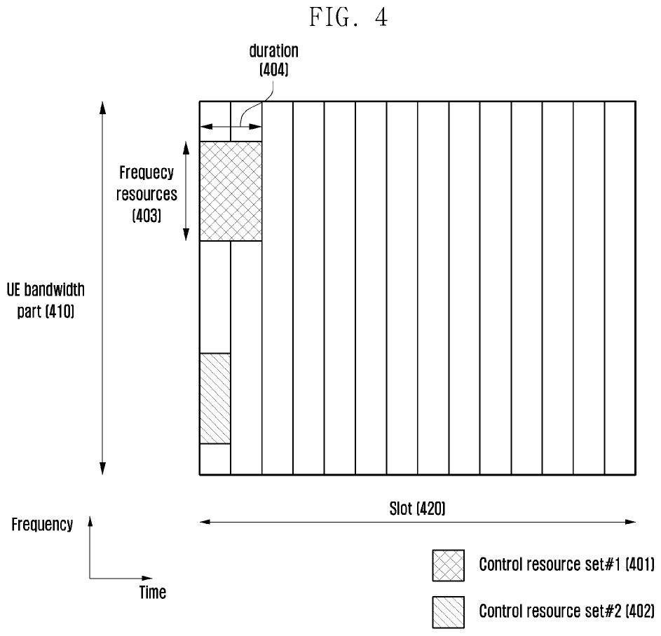

FIG. 4 is a diagram illustrating an example of a Control Resource Set (CORESET) through which a downlink control channel is transmitted in a 5G wireless communication system. FIG. 4 illustrates an example where the UE bandwidth part 410 is configured on the frequency domain, and two control resource sets (control resource set #1 401, control resource set #2 402) are configured within one slot 420 on the time domain. The control resource sets 401 and 402 may be configured to specific frequency resources 403 within the overall UE bandwidth part 410 on the frequency domain. The control resource sets 401 and 402 may be configured to one or more OFDM symbols on the time domain, which may be defined as a control resource set duration 404. With reference to the example shown in FIG. 4, control resource set #1 401 is configured to a control resource set duration of 2 symbols, and control resource set #2 402 is configured to a control resource set duration of 1 symbol.

The control resource set in the aforementioned 5G may be configured by the base station to the terminal through higher layer signaling (e.g., System Information, Master Information Block (MIB), Radio Resource Control (RRC) signaling). Configuring a control resource set to the terminal means providing information such as the control resource set identity, the frequency location of the control resource set, and the symbol length of the control resource set. For example, the information may include the following.

TABLE 8

| | |
|---|---|
| ControlResourceSet ::= | SEQUENCE { |

```
        -- Corresponds to L1 parameter 'CORESET-ID'
    controlResourceSetId
        ControlResourceSetId,
```

| | |
|---|---|
| frequencyDomainResources | BIT STRING |

```
    (SIZE (45)),
    duration
        INTEGER (1..maxCoReSetDuration),
    cce-REG-MappingType
        CHOICE {
        interleaved
            SEQUENCE {
            reg-BundleSize
                ENUMERATED {n2, n3, n6},
            precoderGranularity
```

| | |
|---|---|
| ENUMERATED | {sameAsREG-bundle, |

```
            allContiguousRBs},
            interleaverSize
                ENUMERATED {n2, n3, n6}
            shiftIndex
                INTEGER(0..maxNrofPhysicalResourceBlocks-1)
                OPTIONAL
},
```

| | |
|---|---|
| nonInterleaved | NULL |

```
    },
    tci-StatesPDCCH
        SEQUENCE(SIZE (1..maxNrofTCI-StatesPDCCH)) OF TCI-
```

| | |
|---|---|
| StateId | OPTIONAL, |

```
    tci-PresentInDCI
        ENUMERATED {enabled}
        OPTIONAL, -- Need S
}
```

In [Table 8], the tci-StatesPDCCH (simply named Transmission Configuration Indication (TCI) state) configuration information may include information of one or more Synchronization Signal (SS)/Physical Broadcast Channel (PBCH) Block indices or Channel State Information Reference Signal (CSI-RS) indices that are in a Quasi Co Location (QCL) relationship with the DMRS transmitted by the corresponding control resource set.

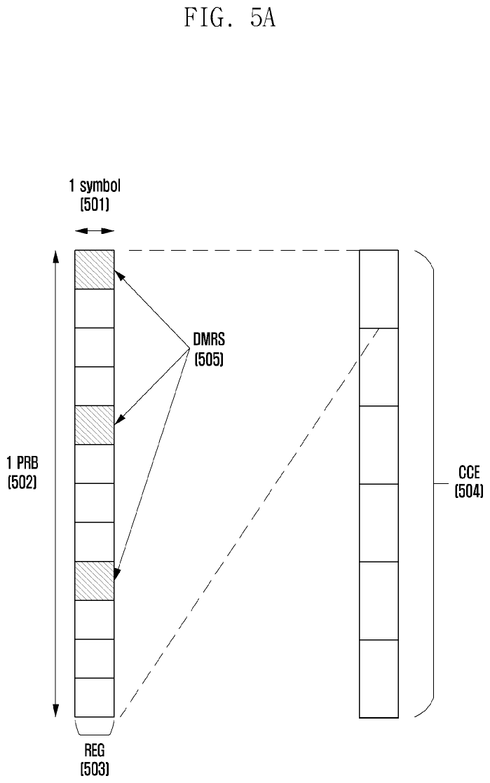

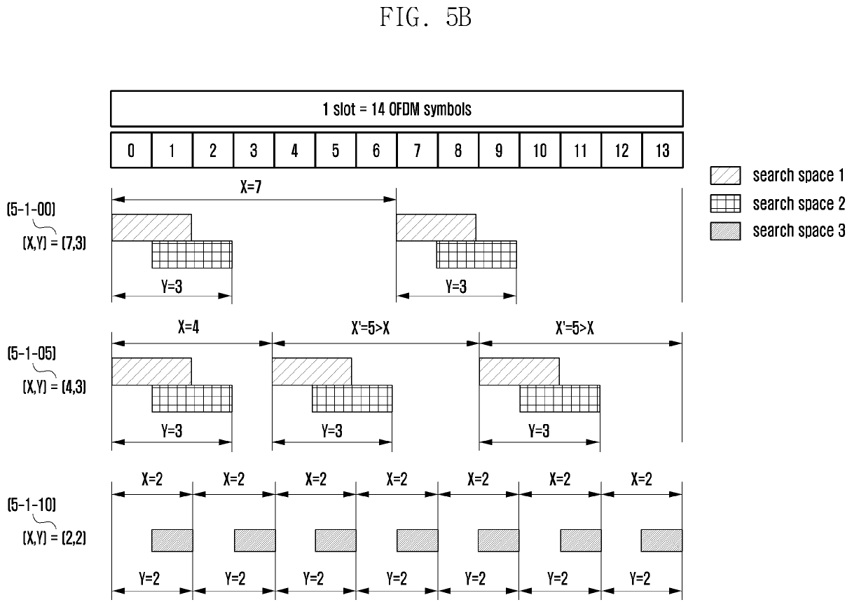

FIG. 5a is a diagram illustrating an example of the basic units of time and frequency resources constituting a downlink control channel that may be used in 5G. According to FIG. 5a, the basic unit of time and frequency resources constituting a control channel may be a Resource Element Group (REG) 503, wherein the REG 503 may be defined by 1 OFDM symbol 501 on the time domain and 1 Physical Resource Block (PRB) 502 on the frequency domain, i.e., 12 subcarriers. The base station may configure a downlink control channel allocation unit by concatenating REGs 503.

As illustrated in FIG. 5a, if the basic unit to which a downlink control channel is assigned in 5G is referred to as a Control Channel Element (CCE) 504, one CCE 504 may consist of multiple REGs 503. Using the REG 503 shown in FIG. 5a as an example, the REG 503 may consist of 12 REs, and if one CCE 504 consists of six REGs 503, then one CCE 504 may consist of 72 REs. When a downlink control resource set is configured, the corresponding area may consist of multiple CCEs 504, and a particular downlink control channel may be mapped to one or more CCEs 504 for transmission on the basis of an Aggregation Level (AL) within the control resource set. The CCEs 504 within the control resource set may be numbered, wherein the CCEs 504 may be numbered according to a logical mapping method.

The basic unit of the downlink control channel illustrated in FIG. 5a, i.e., the REG 503, may include both REs to which DCIs are mapped and areas to which DMRSs 505, which are reference signals for decoding them, are mapped. As illustrated in FIG. 5a, three DMRSs 505 may be transmitted within one REG 503. The number of CCEs required to transmit the PDCCH may be 1, 2, 4, 8, or 16 depending on the Aggregation Level (AL), and different numbers of CCEs may be used to implement link adaptation of the downlink control channel. For example, when AL=L, one downlink control channel may be transmitted through L CCEs. Since the terminal must detect the signal without knowing the information about the downlink control channel, a search space representing the set of CCEs is defined for blind decoding. A search space is a set of downlink control channel candidates consisting of CCEs that the terminal must attempt to decode at a given aggregation level, and since there are several aggregation levels that create bundles of 1, 2, 4, 8, and 16 CCEs, a terminal may have multiple search spaces. A search space set may be defined as the set of search spaces at all configured aggregation levels.

The search space may be categorized into common search space and UE-specific search space. The common search space of the PDCCH may be searched by a certain group of terminals or all terminals to receive cell common control information such as dynamic scheduling or paging messages for system information. For example, PDSCH scheduling allocation information for the transmission of SIBs including the cell's operator information, etc. may be received by searching the common search space of the PDCCH. The common search space may be defined as the set of CCEs that are pre-defined because a certain group of terminals or all terminals should receive the PDCCH. Scheduling assignment information for a UE-specific PDSCH or PUSCH may be received by searching the UE-specific search space of the PDCCH. The UE-specific search space may be defined UE-specifically as a function of the identity of the terminal and various system parameters.

In 5G, parameters for the search space for the PDCCH may be configured from the base station to the terminal by higher layer signaling (e.g., SIB, MIB, RRC signaling). For example, the base station may configure to the terminal the number of PDCCH candidates at each aggregation level L, the monitoring period for the search space, the monitoring occasion per symbol in the slot for the search space, the type of search space (common search space or UE-specific search space), the combination of DCI format and RNTI to be monitored in the search space, and the control resource set index to monitor the search space. For example, the parameters for a search space for a PDCCH may include the following information.

TABLE 9

| | |
|---|---|
| SearchSpace ::= | SEQUENCE { |

```
        Identity of the search space. SearchSpaceId = 0 identifies the
        SearchSpace configured via PBCH (MIB) or
        ServingCellConfigCommon.
    searchSpaceId
        SearchSpaceId,
    controlResourceSetId
        ControlResourceSetId,
```

| | |
|---|---|
| monitoringSlotPeriodicity AndOffset | CHOICE { |

```
        sl1
            NULL,
        sl2
            INTEGER (0..1),
        sl4
            INTEGER (0..3),
        sl5
            INTEGER (0..4),
        sl8
            INTEGER (0..7),
        sl10
            INTEGER (0..9),
        sl16
            INTEGER (0..15),
        sl20
            INTEGER (0..19)
    }
        OPTIONAL,
```

| | |
|---|---|
| duration | INTEGER (2..2559) |

| | |
|---|---|
| monitoringSymbolsWithinSlot | BIT |

```
    STRING (SIZE (14))
                                  OPTIONAL,
    nrofCandidates
        SEQUENCE {
        aggregationLevel1
            ENUMERATED {n0, n1, n2, n3, n4, n5, n6, n8},
        aggregationLevel2
            ENUMERATED {n0, n1, n2, n3, n4, n5, n6, n8},
        aggregationLevel4
            ENUMERATED {n0, n1, n2, n3, n4, n5, n6, n8},
        aggregationLevel8
            ENUMERATED {n0, n1, n2, n3, n4, n5, n6, n8},
        aggregationLevel16
            ENUMERATED {n0, n1, n2, n3, n4, n5, n6, n8}
    },
    searchSpace Type
        CHOICE {
        Configures this search space as common search space (CSS)
        and DCI formats to monitor.
        common
            SEQUENCE {
}
```

| ▪ | ue-Specific | |
|---|---|---|
| | SEQUENCE { | |
| ▪ | Indicates whether the UE monitors in this USS for DCI | |
| | formats 0-0 and 1-0 or for formats 0-1 and 1-1. | |
| | i. | formats |
| | | ENUMERATED { formats0-0-And-1-0, |
| | | formats0-1-And-1-1}, |
| | ii. | ... |

| | |
|---|---|
| ▪ | } |

On the basis of the configuration information, the base station may configure one or more search space sets for the terminal. According to some embodiments, the base station may configure a search space set 1 and a search space set 2 for the terminal, and may configure DCI format A scrambled with X-RNTI in search space set 1 to be monitored in a common search space, and may configure DCI format B scrambled with Y-RNTI in search space set 2 to be monitored in a UE-specific search space.

According to the configuration information, one or more sets of search spaces may exist in the common search space or the UE-specific search space. For example, search space set #1 and search space set #2 may be configured as the common search spaces, and search space set #3 and search space set #4 may be configured as the UE-specific search spaces.

In the common search space, the combination of the following DCI format and RNTI may be monitored. Of course, this is not limited to the following examples.
DCI format 0_0/1_0 with CRC scrambled by C-RNTI, CS-RNTI, SP-CSI-RNTI, RA-RNTI, TC-RNTI, P-RNTI, SI-RNTI
DCI format 2_0 with CRC scrambled by SFI-RNTI
DCI format 2_1 with CRC scrambled by INT-RNTI
DCI format 2_2 with CRC scrambled by TPC-PUSCH-RNTI, TPC-PUCCH-RNTI
DCI format 2_3 with CRC scrambled by TPC-SRS-RNTI

In the UE-specific search space, the combination of the following DCI format and RNTI may be monitored. Of course, this is not limited to the following examples.
DCI format 0_0/1_0 with CRC scrambled by C-RNTI, CS-RNTI, TC-RNTI
DCI format 1_0/1_1 with CRC scrambled by C-RNTI, CS-RNTI, TC-RNTI

The specified RNTIs may have the following definitions and uses.
C-RNTI (Cell RNTI): Used for UE-specific PDSCH scheduling
TC-RNTI (Temporary Cell RNTI): Used for UE-specific PDSCH scheduling
CS-RNTI (Configured Scheduling RNTI): Used for semi-statically configured UE-specific PDSCH scheduling
RA-RNTI (Random Access RNTI): Used for PDSCH scheduling in the random access phase
P-RNTI (Paging RNTI): Used for PDSCH scheduling where paging is transmitted
SI-RNTI (System Information RNTI): Used for PDSCH scheduling where system information is transmitted
INT-RNTI (Interruption RNTI): Used to indicate whether puncturing has been applied to the PDSCH
TPC-PUSCH-RNTI (Transmit Power Control for PUSCH RNTI): Used to indicate power control commands to PUSCH
TPC-PUCCH-RNTI (Transmit Power Control for PUCCH RNTI): Used to indicate power control commands to PUCCH
TPC-SRS-RNTI (Transmit Power Control for SRS RNTI): Used to indicate power control commands to SRS

The DCI formats specified above may follow the definitions below.

TABLE 10

| DCI format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and OFDM |
| | symbol(s) where UE may assume no transmission is |
| | intended for the UE |
| 2_2 | Transmission of TPC commands for PUCCH and PUSCH |
| 2_3 | Transmission of a group of TPC commands for SRS |
| | transmissions by one or more UEs |

In 5G, the search space of the aggregation level L in the control resource set p and the search space set s may be expressed as the following equation 2.

$$L \cdot \{ ( {Y}_{p , {n}_{s , f}^{μ}} + ⌊ \frac{{m}_{s , {n}_{CI}} \cdot {N}_{CCB , μ}}{L \cdot {M}_{s , max}^{( L )}} ⌋ + {n}_{CI} ) mod ⌊ \frac{{N}_{CCS , μ}}{L} ⌋ \} + i \qquad [ Equation 2 ]$$

L: Aggregation level
n_{CI}: Carrier index
N_{CCE,p}: Total number of CCEs existing in control resource set p

$${n}_{s , f}^{μ} :$$

Slot index

$${M}_{s , max}^{( L )} :$$

Number of PDCCH candidates at aggregation level L.
m_{s,n}_{_{CI}}=0, . . . ,

$${M}_{s , max}^{( L )} - 1 :$$

PDCCH candidate index of aggregation level L i=0, . . . , L−1

$${Y}_{p , {n}_{s , f}^{μ}} = ( {A}_{p} \cdot {Y}_{p , {n}_{s , f}^{μ} - 1} ) mod D ,$$

Y_{p,-1}=n_{RNTI}≠0, Aₚ>=39827 for p mod 3=0, Aₚ=39829 for p mod3=1, Aₚ=39839 for p mod 3=2, D=65537
u_{RNTI}: Terminal identifier

The value

$${Y}_{p , {n}_{s , f}^{μ}}$$

may correspond to 0 in the case of a common search space.

In the case of a UE-specific search space, the value

$${Y}_{p , {n}_{s , f}^{μ}}$$

may correspond to a value that changes depending on the terminal's identity (C-RNTI or ID configured for the terminal by the base station) and time index.

In 5G, since multiple search space sets may be configured with different parameters (e.g., the parameters in Table 9), the set of search space sets monitored by the terminal at each point in time may be different. For example, if search space set #1 is configured with an X-slot period, search space set #2 is configured with a Y-slot period, and X and Y are different, the terminal may monitor both search space set #1 and search space set #2 in a specific slot, or may monitor either search space set #1 or search space set #2 in a specific slot.

### [PDCCH: Span]

A terminal may perform UE capability reporting for each subcarrier interval when having multiple PDCCH monitoring positions within a slot, and at this time, the concept of span may be used. A span refers to consecutive symbols within a slot in which the terminal may monitor a PDCCH, and each PDCCH monitoring position is within one span. A span may be expressed as (X, Y), where x refers to the minimum number of symbols that must be spaced between the first symbols of two consecutive spans, and Y refers to the number of consecutive symbols in which the PDCCH may be monitored within one span. In this case, the terminal may monitor the PDCCH in the section from the first symbol of the span to Y symbols within the span.

FIG. 5b is a diagram illustrating a case in which a terminal may have multiple PDCCH monitoring positions within a slot in a wireless communication system through span. Span may be (X,Y)=(7,3), (4,3), and (2,2), and each of the three cases is expressed as (5-1-00), (5-1-05), and (5-1-10) in FIG. 5b. For example, (5-1-00) represents a case in which there are two spans, which may be expressed as (7,4), within a slot. The interval between the first symbols of the two spans is expressed as X=7, and PDCCH monitoring positions may exist within a total of Y=3 symbols from the first symbol of each span, and it is shown that search spaces 1 and 2 each exist within Y=3 symbols. As another example, (5-1-05) represents a case where there are a total of three spans in the slot that may be expressed as (4,3), and the interval between the second and third spans is X′=5 symbols, which is larger than X=4.

### [PDCCH: UE Capability Report]

The slot positions where the above-described common search space and UE-specific search space are located are indicated by the monitoringSymbolsWitninSlot parameter of Table 11-1, and the symbol positions within the slot are indicated as a bitmap through the monitoringSymbolsWithinSlot parameter of Table 9. Meanwhile, the symbol positions within the slot where the terminal can monitor the search space may be reported to the base station through the following UE capabilities.
UE capability 1 (hereinafter referred to as FG 3-1). This UE capability means the capability to monitor a monitoring occasion (MO) for a Type 1 and Type 3 common search space or a UE-specific search space when one MO exists in a slot, and the MO is located within the first three symbols of the slot, as shown in Table 9a below. This UE capability is a mandatory capability that all terminals supporting NR must support, and whether or not this capability is supported is not explicitly reported to the base station.

TABLE 11-1

| | | | Field |
|---|---|---|---|
| | Feature | | name in TS |
| Index | group | Components | 38.331 [2] |
| 3-1 | Basic DL | 1) One configured CORESET per BWP per cell in addition to | n/a |
| | control | CORESET0 | |
| | channel | CORESET resource allocation of 6RB bit-map and duration of 1 | |
| | | 3 OFDM symbols for FR1 | |
| | | For type 1 CSS without dedicated RRC configuration and for | |
| | | type 0. 0A, and 2 CSSs, CORESET resource allocation of 6RB | |
| | | bit-map and duration 1-3 OFDM symbols for FR2 | |
| | | For type 1 CSS with dedicated RRC configuration and for type 3 | |
| | | CSS, UE specific SS, CORESET resource allocation of 6RB | |
| | | bit-map and duration 1-2 OFDM symbols for FR2 | |
| | | REG-bundle sizes of 2/3 RBs or 6 RBs | |
| | | Interleaved and non-interleaved CCE-to-REG mapping | |
| | | Precoder-granularity of REG-bundle size | |
| | | PDCCH DMRS scrambling determination | |
| | | TCI state(s) for a CORESET configuration | |
| | | 2) CSS and UE-SS: configurations for unicast PDCCH | |
| | | transmission per BWP per cell | |
| | | PDCCH aggregation levels 1, 2, 4, 8, 16 | |
| | | UP to 3 search space sets in a slot for a scheduled SCell per | |
| | | BWP | |
| | | This search space limit is before applying all dropping rules. | |
| | | For type 1 CSS with dedicated RRC configuration, type 3 CSS, | |
| | | and UE-SS, the monitoring occasion is within the first 3 OFDM | |
| | | symbols of a slot | |
| | | For type 1 CSS without dedicated RRC configuration and for | |
| | | type 0, 0A, and 2 CSS, the monitoring occasion can be any | |
| | | OFDM symbol(s) of a slot, with the monitoring occasions for any | |
| | | of Type 1-CSS without dedicated RRC configuration, or Types 0; | |
| | | OA, or 2. CSS configurations within a single span of three. | |
| | | consecutive OFDM symbols within a slot | |
| | | 3) Monitoring DCI formats 0_0, 1_0, 0_1, 1_1 | |
| | | 4) Number of PDCCH blind decodes per slot with a given SCS | |
| | | follows Case 1-1 table | |
| | | 5) Processing one unicast DCI scheduling DL and one unicast | |
| | | DCI scheduling UL per slot per scheduled CC for FDD | |
| | | 6) Processing one unicast DCI scheduling DL and 2 unicast DCI | |
| | | scheduling UL per slot per scheduled CC for TDD | |

UE capability 2 (hereinafter referred to as FG 3-2). This UE capability means the capability to monitor regardless of the starting symbol position of a MO, if there is one MO for a common search space or a UE-specific search space in a slot, as shown in Table 11-2 below. This UE capability may be optionally supported by the terminal, and whether or not this capability is supported is explicitly reported to the base station.

TABLE 11-2

| Index | Feature group | Components | Field name in TS 38.331 [2] |
|---|---|---|---|
| 3-2 | PDCCH | For a given UE, all search | pdcchMonitoringSingleOccasion |
| | monitoring | space configurations are | |
| | on any span | within the same span of | |
| | of up to 3 | 3 consecutive OFDM | |
| | consecutive | symbols in the slot | |
| | OFDM | | |
| | symbols | | |
| | of a slot | | |

UE capability 3 (hereinafter referred to as FG 3-5, 3-5a, 3-5b). This UE capability indicates a pattern of multiple monitoring occasions (MOs) that the terminal can monitor when multiple MOs exist for a common search space or a UE-specific search space in a slot, as shown in Table 11-3 below. The above-described pattern is composed of an interval X between start symbols between different MOs, and a maximum symbol length Y for an MO. The combination of (X, Y) supported by the terminal may be one or more of {(2,2), (4,3), (7,3)}. This UE capability may be optionally supported by the terminal, and whether or not this capability is supported and the above-described combination of (X, Y) are explicitly reported to the base station.

TABLE 11-3

| Index | Feature group | Components | Field name in TS 38.331 [2] |
|---|---|---|---|
| 3-5 | For type 1 | For type 1 CSS with dedicated RRC configuration, | pdcch-MonitoringAnyOccasions |
| | CSS with | type 3 CSS, and UE-SS, monitoring occasion can | { |
| | dedicated | be any OFDM symbol(s) of a slot for Case 2 | 3-5. withoutDCI-Gap |
| | RRC | | 3-5a, withDCI-Gap |
| | configuration, | | } |
| | type 3 CSS, | | |
| | and UE-SS, | | |
| | monitoring | | |
| | occasion can | | |
| | be any OFDM | | |
| | symbol(s) of a | | |
| | slot for | | |
| | Case 2 | | |
| 3-5a | For type 1 | For type 1 CSS with dedicated RRC configuration, | |
| | CSS with | type 3 CSS and UE-SS, monitoring occasion can be | |
| | dedicated | any OFDM symbol(s) of a slot for Case 2, with | |
| | RRC | minimum time separation (including the cross-slot | |
| | configuration, | boundary case) between two DL unicast DCIs, | |
| | type 3 CSS, | between two UL unicast DCIs, or between a DL and | |
| | and UE-SS, | an UL unicast DCI in different monitoring occasions | |
| | monitoring | where at least one of them is not the monitoring | |
| | occasion can | occasions of FG-3-1, for a same UE as | |
| | be any OFDM | 2OFDM symbols for 15 kHz | |
| | symbol(s) of a | 4OFDM symbols for 30 kHz | |
| | slot for Case | 7OFDM symbols for 60 kHz with NCP | |
| | 2 with a | 11OFDM symbols for 120 kHz | |
| | DCI gap | Up to one unicast DL DCI and up to one unicast UL | |
| | | DCI in a monitoring occasion except for the | |
| | | monitoring occasions of FG 3-1. | |
| | | In addition for TDD the minimum separation. | |
| | | between the first two UL unicast DCIs within the first | |
| | | 3 OFDM symbols of a slot can be zero OFDM | |
| | | symbols. | |
| 3-5b | All POCCH | PDCCH monitoring occasions of FG-3-1, plus | |
| | monitoring | additional PDCCH monitoring occasion(s) can be | |
| | occasion can | any OFDM symbol(s) of a slot for Case 2, and for any | |
| | be any OFDM | two PDCCH monitoring occasions belonging to | |
| | symbol(s) of a | different spans, where at least one of them is not the | |
| | slot for Case | monitoring occasions of FG-3-1, in same or different | |
| | 2 with a span | search spaces, there is a minimum time separation | |
| | gap | of X OFDM symbols (including the cross-slot | |
| | | boundary case) between the start of two spans, | |
| | | where each span is of length up to Y consecutive | |
| | | OFDM symbols of a slot. Spans do not overlap. | |
| | | Every span is contained in a single slot. The same | |
| | | span pattern repeats in every slot. The separation | |
| | | between consecutive spans within and across slots | |
| | | may be unequal but the same (X, Y) limit must be | |
| | | satisfied by all spans. Every monitoring occasion is | |
| | | fully contained in one span. In order to determine a | |
| | | suitable span pattern, first a bitmap b(I), 0 = \| <= 13 is | |
| | | generated, where b(I) = 1 if symbol I of any slot is part | |
| | | of a monitoring occasion, b(I) = 0 otherwise. The first | |
| | | span in the span pattern begins at the smallest i for | |
| | | which b(I) = 1. The next span in the span pattern | |
| | | begins at the smallest I not included in the previous | |
| | | span(s) for which b(I) = 1. The span duration is | |
| | | max{maximum value of all CORESET durations, | |
| | | minimum value of Y in the UE reported candidate | |
| | | value} except possibly the last span in a slot which | |
| | | can be of shorter duration: A particular PDCCH | |
| | | monitoring configuration meets the UE capability | |
| | | limitation if the span arrangement satisfies the gap | |
| | | separation for at least one (X, Y) in the UE reported | |
| | | candidate value set in every slot, including cross slot | |
| | | boundary. | |
| | | For the set of monitoring occasions which are within | |
| | | the same span: | |
| | | Processing one unicast DCI scheduling DL | |
| | | and one unicast DCI scheduling UL per scheduled | |
| | | CC across this set of monitoring occasions for FDD | |
| | | Processing one unicast DCI scheduling DL | |
| | | and two unicast DCI scheduling UL per scheduled | |
| | | CC across this set of monitoring occasions for TDD | |
| | | Processing two unicast DCI scheduling DL | |
| | | and one unicast DCI scheduling UL per scheduled | |
| | | CC across this set of monitoring occasions for TDD | |
| | | The number of different start symbol indices of spans | |
| | | for all PDCCH monitoring occasions per slot, | |
| | | including PDCCH monitoring occasions of FG-3-1, | |
| | | no more than floor(14/X) (X is minimum among | |
| | | is values reported by UE). | |
| | | The number of different start symbol indices of | |
| | | PDCCH monitoring occasions per slot including | |
| | | PDCCH monitoring occasions of FG-3-1, is no more | |
| | | than 7. | |
| | | The number of different start symbol indices of | |
| | | PDCCH monitoring occasions per half-slot including | |
| | | POCCH monitoring occasions of FG-3-1 is no more | |
| | | than 4 in SCell. | |

The terminal may report to the base station whether it supports the UE capability 2 and/or UE capability 3 described above and the related parameters. The base station may perform time domain resource allocation for the common search space and the UE-specific search space on the basis of the reported UE capability. When allocating the resource, the base station may prevent the terminal from positioning the MO in a location that cannot be monitored.

### [PDCCH: BD/CCE Limit]

When multiple search space sets are configured for a terminal, the following conditions may be considered in determining the search space set that the terminal should monitor.

If the terminal has configured the value of monitoringCapabilityConfig-r16, which is an upper layer signaling, to r15monitoringcapability, the terminal defines the maximum values for the number of PDCCH candidates that may be monitored and the number of CCEs that constitute the entire search space (wherein the entire search space means the entire set of CCEs corresponding to the union area of multiple search space sets) per slot, and if the value of monitoringCapabilityConfig-r16 is configured to r16monitoringcapability, the terminal defines the maximum values for the number of PDCCH candidates that may be monitored and the number of CCEs that constitute the entire search space (wherein the entire search space means the entire set of CCEs corresponding to the union area of multiple search space sets) per span.

### [Condition 1: Maximum PDCCH Candidates Number Limit]

As described above, depending on the configuration value of the upper layer signaling, the maximum number of PDCCH candidates, M^{μ}, that the terminal can monitor may follow Table 12-1 below when defined on a slot basis in a cell configured to a subcarrier spacing of 15·2^{μ} kHz, and may follow Table 12-2 below when defined on a span basis.

TABLE 12-1

| | Maximum number |
|---|---|
| | of PDCCH |
| | candidates per |
| | slot and per |
| μ | serving cell (M^{μ}) |
| 0 | 44 |
| 1 | 36 |
| 2 | 22 |
| 3 | 20 |

TABLE 12-2

| | Maximum | | |
|---|---|---|---|
| | number | | |
| | M^{μ} of | | |
| | monitored | | |
| | PDCCH | | |
| | candidates | | |
| | per span for | | |
| | combination | | |
| | (X, Y) and per | | |
| | serving cell | | |
| μ | (2, 2) | (4, 3) | (7, 3) |
| 0 | 14 | 28 | 44 |
| 1 | 12 | 24 | 36 |

### [Condition 2: Maximum CCE Number Limit]

As described above, depending on the configuration value of the upper layer signaling, the maximum number of CCEs, CH, that constitute the entire search space (here, the entire search space means the entire CCE set corresponding to the union area of multiple search space sets) may follow Table 12-3 below when defined on a slot basis in a cell configured to a subcarrier spacing of 15·2^{μ} kHz, and may follow Table 12-4 below when defined on a span basis.

TABLE 12-3

| | Maximum |
|---|---|
| | number of |
| | non-overlapped |
| | CCEs per |
| | slot and per |
| μ | serving cell (C^{μ}) |
| 0 | 56 |
| 1 | 56 |
| 2 | 48 |
| 3 | 32 |

TABLE 12-4

| | Maximum | | |
|---|---|---|---|
| | number C^{μ} of | | |
| | non-overlapped | | |
| | CCEs per span | | |
| | for combination | | |
| | (X, Y) and per | | |
| | serving cell | | |
| μ | (2, 2) | (4, 3) | (7, 3) |
| 0 | 18 | 36 | 56 |
| 1 | 18 | 36 | 56 |

For convenience of explanation, let us define a situation where both conditions 1 and 2 are satisfied at a certain point in time as “condition A”. Therefore, not satisfying condition A may mean not satisfying at least one of conditions 1 and 2.

### [PDCCH: Overbooking]

Depending on the configuration of the search space sets of the base station, there may be cases where condition A is not satisfied at a certain point in time. If condition A is not satisfied at a certain point in time, the terminal may select and monitor only some of the search space sets that are configured to satisfy condition A at that point in time, and the base station may transmit a PDCCH to the selected search space set.

The following method may be used to select a portion of the search space from the entire set of search spaces.

If condition A for a PDCCH is not satisfied at a specific point in time (slot), the terminal (or base station) may preferentially select a search space set whose search space type is configured to a common search space among the search space sets existing at that point in time over a search space set that is configured to a UE-specific search space.

If all search space sets configured as common search spaces are selected (i.e., if condition A is satisfied even after all search spaces configured as common search spaces are selected), the terminal (or base station) may select search space sets configured as UE-specific search spaces. At this time, if there are multiple search space sets configured as UE-specific search spaces, a search space set with a lower search space set index may have a higher priority. Considering the priority, the UE-specific search space sets may be selected within the range where condition A is satisfied.

### [QCL, TCI State]

In a wireless communication system, one or more different antenna ports (or one or more channels, signals, and combinations thereof, but hereinafter referred to collectively as different antenna ports for convenience) may be associated with each other by a Quasi Co Location (QCL) configuration as shown in Table 10 below. The TCI state is intended to announce the QCL relationship between PDCCH (or PDCCH DMRS) and other RSs or channels, and when a reference antenna port A (reference RS #A) and another target antenna port B (target RS #B) are QCLed, it means that the terminal is allowed to apply some or all of the large-scale channel parameters estimated at antenna port A to the channel measurements from antenna port B. The QCL may need to relate different parameters depending on the situation, such as 1) time tracking, which is affected by average delay and delay spread, 2) frequency tracking, which is affected by Doppler shift and Doppler spread, 3) radio resource management (RRM), which is affected by average gain, and 4) beam management (BM), which is affected by spatial parameters. Therefore, NR supports four types of QCL relationships as shown in Table 13 below.

TABLE 13

| QCL type | Large-scale characteristics |
|---|---|
| A | Doppler shift, Doppler spread, |
| | average delay, delay spread |
| B | Doppler shift, Doppler spread |
| C | Doppler shift, average delay |
| D | Spatial Rx parameter |

The spatial RX parameter may collectively refer to any or all of various parameters such as Angle of arrival (AoA), Power Angular Spectrum (PAS) of AoA, Angle of departure (AoD), PAS of AoD, transmit/receive channel correlation, transmit/receive beamforming, spatial channel correlation, etc.

The QCL relationship may be configured to the terminal through the RRC parameter TCI-State and QCL-Info as shown in Table 14 below. With reference to Table 14, the base station may configure one or more TCI states to inform the terminal of up to two QCL relationships (qcl-Type1, qcl-Type2) for the RS referring to the ID of the TCI state, i.e., the target RS. At this time, each QCL information (QCL-Info) included in each TCI state includes the serving cell index and BWP index of the reference RS indicated by the corresponding QCL information, the type and ID of the reference RS, and the QCL type as shown in Table 13.

TABLE 14

| | |
|---|---|
| TCI-State ::= | SEQUENCE { |

| | |
|---|---|
| tci-StateId | TCI-StateId, |
| qcl-Type1 | QCL-Info, |
| qcl-Type2 | QCL-Info |

```
                      OPTIONAL, -- Need R
    ...
}
```

| | |
|---|---|
| QCL-Info ::= | SEQUENCE { |

| | |
|---|---|
| cell | ServCellIndex |

OPTIONAL, -- Need R

| | |
|---|---|
| bwp-Id | BWP-Id |

OPTIONAL, -- Cond CSI-
RS-Indicated

| | |
|---|---|
| referenceSignal | CHOICE { |

```
        csi-rs
            NZP-CSI-RS-ResourceId,
        ssb
            SSB-Index
    },
    qcl-Type
        ENUMERATED {typeA, typeB, typeC, typeD},
    ...
}
```

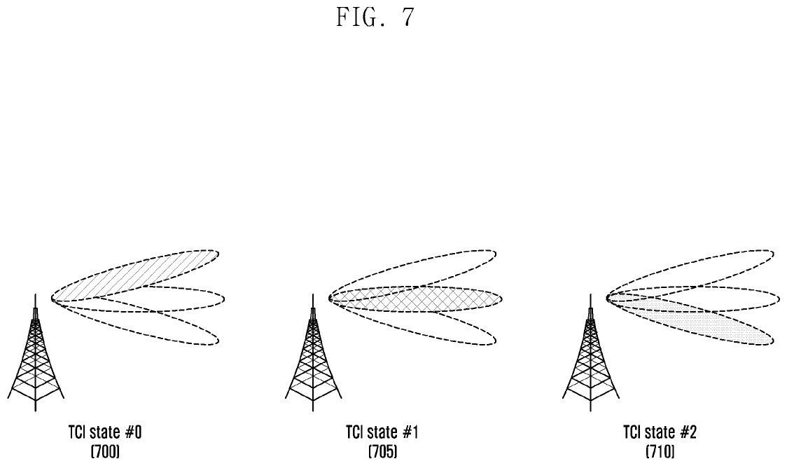

FIG. 7 is a diagram illustrating an example of base station beam allocation according to TCI state configurations. With reference to FIG. 7, the base station may communicate information about different N beams to the terminal through different N TCI states. For example, in the case of N=3 as shown in FIG. 7, the base station may communicate that the antenna ports referencing the three TCI states 700, 705, and 710 have different spatial Rx parameters, i.e., different beams, by ensuring that the qcl-Type2 parameters included in the three TCI states 700, 705, and 710 are associated with CSI-RS or SSB corresponding to different beams and are configured to QCL type D.

Tables 15-1 to 15-5 below show valid TCI state configurations according to target antenna port type.

Table 15-1 illustrates valid TCI state configurations when the target antenna port is CSI-RS for tracking (TRS). The TRS refers to an NZP CSI-RS in which the repetition parameter is not configured, and trs-Info is configured to true among CSI-RSs. Configuration number 3 in Table 15-1 may be used for aperiodic TRS.

TABLE 15-1
Valid TCI state configurations when the target
antenna port is CSI-RS for tracking (TRS)

| Valid TCI | | | DL RS 2 | qcl-Type2 |
|---|---|---|---|---|
| state | | | (if | (if |
| Configuration | DL RS 1 | qcl-Type1 | configured) | configured) |
| 1 | SSB | QCL-TypeC | SSB | QCL-TypeD |
| 2 | SSB | QCL-TypeC | CSI-RS (BM) | QCL-TypeD |
| 3 | TRS (periodic) | QCL-TypeA | TRS (same as | QCL-TypeD |
| | | | DL RS 1) | |

Table 15-2 illustrates valid TCI state configurations when the target antenna port is CSI-RS for CSI. The CSI-RS for CSI refers to an NZP CSI-RS in which a parameter indicating repetition (e.g., repetition parameter) is not configured and trs-Info is also not configured to true among CSI-RSs.

TABLE 15-2
Valid TCI state configurations when the
target antenna port is CSI-RS for CSI

| Valid | | | | |
|---|---|---|---|---|
| TCI state | DL | | DL RS 2 | qcl-Type2 |
| Configuration | RS 1 | qcl-Type1 | (if configured) | (if configured) |
| 1 | TRS | QCL-TypeA | SSB | QCL-TypeD |
| 2 | TRS | QCL-TypeA | CSI-RS for BM | QCL-TypeD |
| 3 | TRS | QCL-TypeÅ | TRS (same as | QCL-TypeD |
| | | | DL RS 1) | |
| 4 | TRS | QCL-TypeB | | |

Table 15-3 illustrates valid TCI state configurations when the target antenna port is CSI-RS for beam management (BM, same meaning as CSI-RS for L1 RSRP reporting). The CSI-RS for BM refers to an NZP CSI-RS in which the repetition parameter is configured and has a value of On or Off, and trs-Info is not configured to true among CSI-RSs.

TABLE 15-3
Valid TCI state configurations when the target antenna
port is CSI-RS for BM (for L1 RSRP reporting)

| Valid | | | | |
|---|---|---|---|---|
| TCI state | DL | | DL RS 2 | qcl-Type2 |
| Configuration | RS 1 | qcl-Type1 | (if configured) | (if configured) |
| 1 | TRS | QCL-TypeA | TRS (same | QCL-TypeD |
| | | | as DL RS 1) | |
| 2 | TRS | QCL-TypeA | CSI-RS (BM) | QCL-TypeD |
| 3 | SS/PBCH | QCL-TypeC | SS/PBCH | QCL-TypeD |
| | Block | | Block | |

Table 15-4 illustrates valid TCI state configurations when the target antenna port is PDCCH DMRS.

TABLE 15-4
Valid TCI state configurations when target
antenna port is PDCCH DMRS

| Valid | | | | |
|---|---|---|---|---|
| TCI state | DL | | DL RS 2 | qcl-Type2 |
| Configuration | RS 1 | qcl-Type1 | (if configured) | (if configured) |
| 1 | TRS | QCL-TypeA | TRS (same as | QCL-TypeD |
| | | | DL RS 1) | |
| 2 | TRS | QCL-TypeA | CSI-RS (BM) | QCL-TypeD |
| 3 | CSI-RS (CSI) | QCL-TypeA | CSI-RS (same | QCL-TypeD |
| | | | as DL RS 1) | |

Table 15-5 illustrates valid TCI state configurations when the target antenna port is PDSCH DMRS.

TABLE 15-5
Valid TCI state configurations when target
antenna port is PDSCH DMRS

| Valid | | | | |
|---|---|---|---|---|
| TCI state | DL | | DL RS 2 | qcl-Type2 |
| Configuration | RS 1 | qcl-Type1 | (if configured) | (if configured) |
| 1 | TRS | QCL-TypeA | TRS | QCL-TypeD |
| 2 | TRS | QCL-TypeA | CSI-RS (BM) | QCL-TypeD |
| 3 | CSI-RS (CSI) | QCL-TypeA | CSI-RS (CSI) | QCL-TypeD |

The representative QCL configuration method according to the Tables 15-1 to 15-5 is to configure the target antenna port and reference antenna port for each step as “SSB”-> “TRS”-> “CSI-RS for CSI, or CSI-RS for BM, or PDCCH DMRS, or PDSCH DMRS”. This allows the statistical features measured from SSB and TRS to be linked to each antenna port to help the reception operation of the terminal.

### [PDCCH: TCI State Related]

Specifically, the TCI state combinations applicable to the PDCCH DMRS antenna port are as shown in Table 16 below. The fourth row in Table 16 is the combination assumed by the terminal before RRC configuration, and configuration after RRC is not possible.

TABLE 16

| Valid | | | | |
|---|---|---|---|---|
| TCI state | DL | | DL RS 2 | qcl-Type2 |
| Configuration | RS 1 | qcl-Type1 | (if configured) | (if configured) |
| 1 | TRS | QCL-TypeA | TRS | QCL-TypeD |
| 2 | TRS | QCL-TypeA | CSI-RS (BM) | QCL-TypeD |
| 3 | CSI-RS | QCL-TypeA | | |
| | (CSI) | | | |
| 4 | SS/PBCH | QCL-TypeA | SS/PBCH | QCL-TypeD |
| | Block | | Block | |

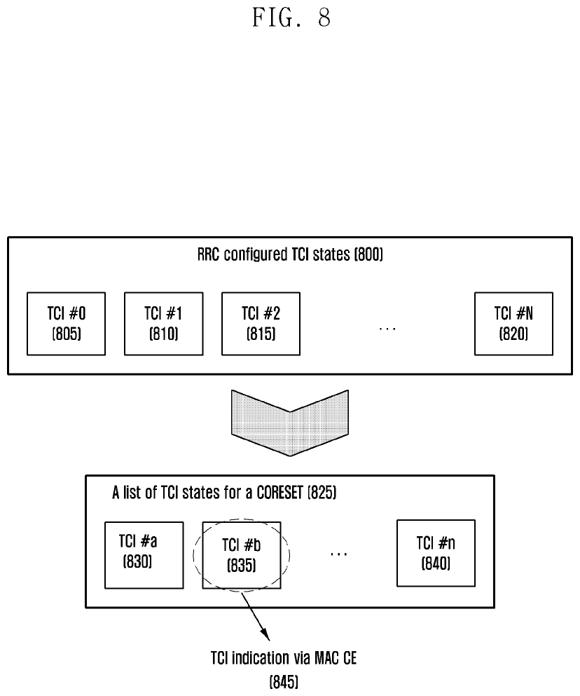

The NR supports a hierarchical signaling method, as illustrated in FIG. 8, for dynamic allocation of PDCCH beams. With reference to FIG. 8, the base station may configure N TCI states 805, 810, . . . , 820 to the terminal through RRC signaling 800, some of which may be configured as TCI states for CORESET 825. The base station may then indicate one of the TCI states 830, 835, and 840 for CORESET to the terminal through MAC CE signaling 845. The terminal then receives a PDCCH on the basis of beam information that includes the TCI state indicated by the MAC CE signaling.

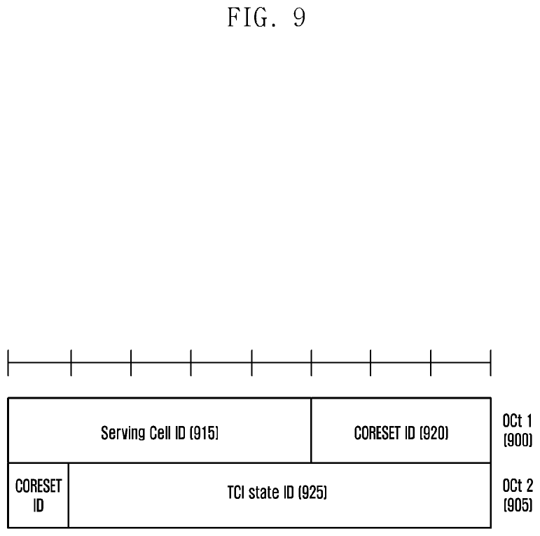

FIG. 9 is a diagram illustrating a TCI indication MAC CE signaling structure for the PDCCH DMRS. With reference to FIG. 9, the TCI indication MAC CE signaling for the PDCCH DMRS consists of 2 bytes (16 bits) and includes a 5-bit serving cell ID 915, a 4-bit CORESET ID 920, and a 7-bit TCI state ID 925.

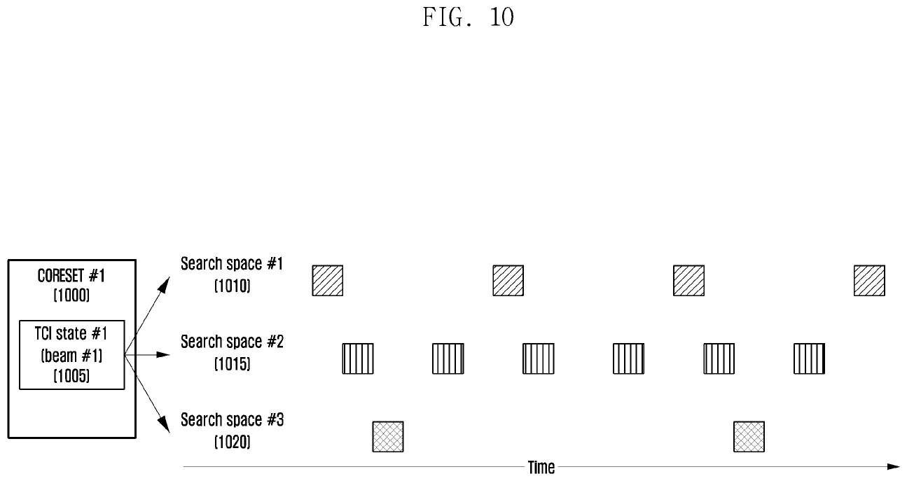

FIG. 10 is a diagram illustrating an example of beam configurations of a control resource set (CORESET) and search space according to the above description. With reference to FIG. 10, the base station may indicate one of the TCI state lists included in the CORESET 1000 configuration through MAC CE signaling 1005. Afterwards, until a different TCI state is subsequently indicated to that CORESET through another MAC CE signaling, the terminal considers that the same QCL information (beam #1) 1005 applies to all of the one or more search spaces 1010, 1015, and 1020 associated with the CORESET.

The above-described PDCCH beam allocation method has the disadvantage that it is difficult to indicate a beam change faster than the MAC CE signaling delay, and also has the disadvantage that the same beam is applied to all of the CORESETs regardless of the search space features, which makes it difficult to operate flexible PDCCH beams. The following embodiments of the present invention provide a more flexible PDCCH beam configuration and operation method. Hereinafter, in describing the embodiments of the present invention below, several distinct examples are provided for ease of explanation, but they are not mutually exclusive and may be combined with each other as appropriate depending on the situation.

The base station may configure one or more TCI states for a specific control area to the terminal and may activate one of the configured TCI states through the MAC CE activation command. For example, if control area #1 has {TCI state #0, TCI state #1, TCI state #2} configured as the TCI state for control area #1, the base station may transmit a command to the terminal through MAC CE to enable the terminal to assume TCI state #0 as the TCI state for control area #1. On the basis of the activation command for the TCI state received by the MAC CE, the terminal may correctly receive DMRS for the corresponding control area on the basis of the QCL information in the activated TCI state.

For the control area (control area #0) with index configured to 0, if the terminal does not receive a MAC CE activation command for the TCI state of control area #0, the terminal may assume that the DMRS transmitted from control area #0 is QCL with the SS/PBCH block identified in the initial access process or in the non-contention based random access process that is not triggered by the PDCCH command.

For a control area (control area #X) with an index configured to a value other than 0, if the terminal has not received a TCI state for control area #X, or if it has received one or more TCI states but has not received a MAC CE activation command to activate one of them, the terminal may assume that it is QCL with the SS/PBCH block identified during the initial connection process for DMRS transmitted from control area #X.

### [PDCCH: QCL Prioritization Rule Related]

In the following, the QCL priority determination operation for PDCCH will be described in detail.

If the terminal operates in single cell or intra-band carrier aggregation and multiple control resource sets within the activated bandwidth part of a single or multiple cells overlap in time with the same or different QCL-TypeD attributes in a particular PDCCH monitoring occasion, the terminal may select a particular control resource set according to the QCL prioritization operation and monitor the control resource sets with the same QCL-TypeD attributes as the corresponding control resource set. In other words, when multiple control resource sets overlap in time, only one QCL-TypeD attribute may be received. In this case, the criteria for determining QCL priority may be as follows.
Criterion 1. Within the cell corresponding to the lowest index of the cells including the common search space, the control resource set associated with the lowest indexed common search space.
Criterion 2. Within the cell corresponding to the lowest index of the cells including the UE-specific search space, the control resource set associated with the lowest indexed UE-specific search space.

As described above, for each of the above criteria, the next criterion shall be applied if the corresponding criterion is not met. For example, if control resource sets overlap in time in a particular PDCCH monitoring occasion, and if all control resource sets are connected to a UE-specific search interval and not to a common search interval, i.e., if criterion 1 is not met, the terminal may omit applying criterion 1 and apply criterion 2.

When selecting the control resource set according to the criteria described above, the terminal may additionally consider two points regarding the QCL information configured in the control resource set as follows. First, if control resource set 1 has CSI-RS 1 as a reference signal with a QCL-TypeD relationship, the reference signal with which this CSI-RS 1 has a QCL-TypeD relationship is SSB 1, and another control resource set 2 has a reference signal with which a QCL-TypeD relationship is SSB 1, the terminal may consider that these two control resource sets 1 and 2 have different QCL-TypeD features. Secondly, if control resource set 1 has CSI-RS 1 configured in cell 1 as the reference signal with QCL-TypeD relationship, the reference signal with which CSI-RS 1 has QCL-TypeD relationship is SSB 1, control resource set 2 has CSI-RS 2 configured in cell 2 as the reference signal with QCL-TypeD relationship, and the reference signal with which CSI-RS 2 has QCL-TypeD relationship is the same SSB 1, the terminal may consider the two control resource sets to have the same QCL-TypeD features.

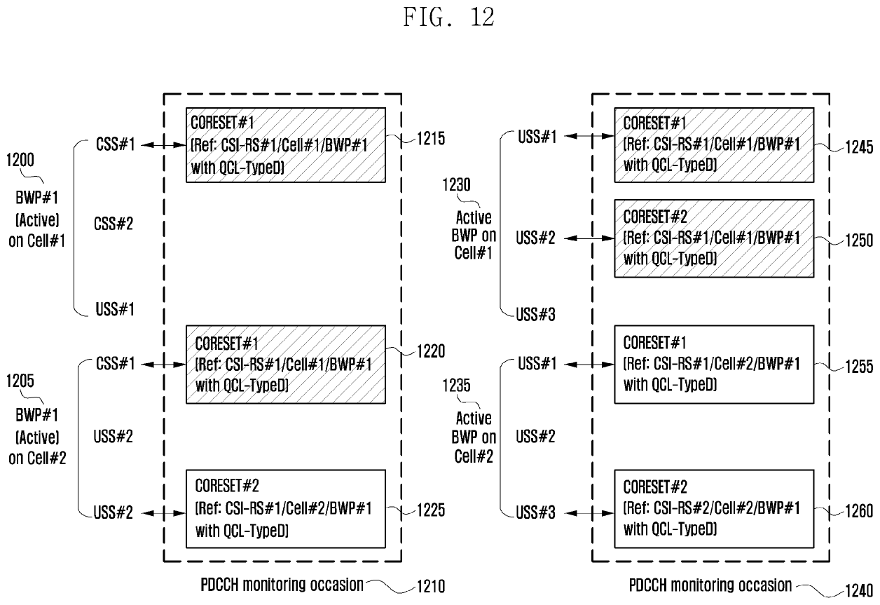

FIG. 12 is a diagram for explaining a method for selecting a control resource set that may be received by a terminal in consideration of priorities when receiving a downlink control channel in a wireless communication system according to one embodiment of the present disclosure. For example, a terminal may be configured to receive multiple control resource sets that overlap in time in a specific PDCCH monitoring occasion 1210, and these multiple control resource sets may be connected to a common search space or a UE-specific search space for multiple cells. In the corresponding PDCCH monitoring occasion, a first control resource set 1215 connected to the first common search section may exist in a first bandwidth part 1200 of a first cell, and a first control resource set 1220 connected to the first common search section and a second control resource set 1225 connected to the second UE-specific search section may exist in a first bandwidth part 1205 of a second cell. Control resource sets 1215 and 1220 may have a relationship of QCL-TypeD with the first CSI-RS resource set within the first bandwidth part of the first cell, and control resource set 1225 may have a relationship of QCL-TypeD with the first CSI-RS resource set within the first bandwidth part of the second cell. Therefore, if criterion 1 is applied to the corresponding PDCCH monitoring occasion 1210, all other control resource sets having the same QCL-TypeD reference signal as the first control resource set 1215 may be received. Therefore, the terminal may receive control resource sets 1215 and 1220 in the corresponding PDCCH monitoring occasion 1210. As another example, a terminal may be configured to receive multiple control resource sets that overlap in time in a specific PDCCH monitoring occasion 1240, and these multiple control resource sets may be connected to a common search space or a UE-specific search space for multiple cells. Within the PDCCH monitoring occasion, in the first bandwidth part 1230 of the first cell, there may exist a first control resource set 1245 connected to the first UE-specific search interval and a second control resource set 1250 connected to the second UE-specific search interval, and in the first bandwidth part 1235 of the second cell, there may exist a first control resource set 1255 connected to the first UE-specific search interval and a second control resource set 1260 connected to the third UE-specific search interval. Control resource sets 1245 and 1250 have a relationship with the first CSI-RS resource set in the first bandwidth part of the first cell and QCL-TypeD, control resource set 1255 has a relationship with the first CSI-RS resource set in the first bandwidth part of the second cell and QCL-TypeD, and control resource set 1260 may have a relationship with the second CSI-RS resource set in the first bandwidth part of the second cell and QCL-TypeD. However, if criterion 1 is applied to the corresponding PDCCH monitoring occasion 1240, there is no common search section, so the next criterion, criterion 2, may be applied. If criterion 2 is applied to the corresponding PDCCH monitoring occasion 1240, all other control resource sets having the same QCL-TypeD reference signal as the control resource set 1245, may be received. Accordingly, the terminal may receive control resource sets 1245 and 1250 in the corresponding PDCCH monitoring occasion 1240. [Rate Matching/Puncturing Related] In the following, the rate matching operation and puncturing operation are described in detail.

When a time and frequency resource A for transmitting an arbitrary symbol sequence A overlaps with an arbitrary time and frequency resource B, a rate matching or puncturing operation may be considered as a transmission and reception operation of channel A considering a resource C, the area where resource A and resource B overlap.

### Rate Matching Operation

The base station may map and transmit channel A only for the remaining resource areas excluding resource C corresponding to the overlapping area with resource B among the entire resource A that wants to transmit symbol sequence A to the terminal. For example, if symbol sequence A is composed of {Symbol #1, Symbol #2, Symbol #3, Symbol #4}, and if resource A is {Resource #1, Resource #2, Resource #3, Resource #4}, and resource B is {Resource #3, Resource #5}, the base station may sequentially map and transmit symbol sequence A to the remaining resources {Resource #1, Resource #2, Resource #4} excluding {Resource #3} corresponding to resource C among resources A. As a result, the base station may transmit symbol sequences {Symbol #1, Symbol #2, Symbol #3} by mapping them to {Resource #1, Resource #2, Resource #4}, respectively.

The terminal may determine resource A and resource B from scheduling information for symbol sequence A from the base station, and may thereby determine resource C, which is an area where resource A and resource B overlap. The terminal may receive symbol sequence A, assuming that symbol sequence A is mapped and transmitted in the remaining area except for resource C among the entire resource A. For example, if symbol sequence A is composed of {Symbol #1, Symbol #2, Symbol #3, Symbol #4}, and resource A is {Resource #1, Resource #2, Resource #3, Resource #4}, and resource B is {Resource #3, Resource #5}, the terminal may receive symbol sequence A, assuming that symbol sequence A is sequentially mapped to {Resource #1, Resource #2, Resource #4}, which are the remaining resources among resource A except for {Resource #3} corresponding to resource C. As a result, the terminal may assume that the symbol sequence {Symbol #1, Symbol #2, Symbol #3} is transmitted by being mapped to {Resource #1, Resource #2, Resource #4}, respectively, and perform a series of subsequent receiving operations.

### Puncturing Operation

If a base station wants to transmit symbol sequence A to a terminal, and there is a resource C corresponding to an area overlapping with resource B among the entire resource A, the base station maps symbol sequence A to the entire resource A, but does not perform transmission in the resource area corresponding to resource C, and may perform transmission only for the remaining resource areas of resource A excluding resource C. For example, if symbol sequence A is composed of {Symbol #1, Symbol #2, Symbol #3, Symbol #4}, and resource A is {Resource #1, Resource #2, Resource #3, Resource #4}, and resource B is {Resource #3, Resource #5}, the base station may map symbol sequence A {Symbol #1, Symbol #2, Symbol #3, Symbol #4} to resource A {Resource #1, Resource #2, Resource #3, Resource #4} respectively, and may transmit only the symbol sequences {Symbol #1, Symbol #2, Symbol #4} corresponding to the remaining resources {Resource #1, Resource #2, Resource #4} excluding {Resource #3} corresponding to resource C among resource A, and may not transmit {Symbol #3} mapped to {Resource #3} corresponding to resource C. As a result, the base station may transmit the symbol sequence {Symbol #1, Symbol #2, Symbol #4} by mapping them to {Resource #1, Resource #2, Resource #4}, respectively.

The terminal may determine resources A and B from scheduling information for symbol sequence A from the base station, and through this, determine resource C, which is an area where resources A and B overlap. The terminal may receive symbol sequence A assuming that symbol sequence A is mapped to the entire resource A, but is transmitted only in the remaining area of resource area A excluding resource C. For example, if symbol sequence A is composed of {Symbol #1, Symbol #2, Symbol #3, Symbol #4}, and resource A is {Resource #1, Resource #2, Resource #3, Resource #4}, and resource B is {Resource #3, Resource #5}, the terminal may assume that symbol sequence A {Symbol #1, Symbol #2, Symbol #3, Symbol #4} is mapped to resource A {Resource #1, Resource #2, Resource #3, Resource #4} respectively, but {Symbol #3} mapped to {Resource #3} corresponding to resource C is not transmitted, and may receive the terminal assuming that symbol sequences {Symbol #1, Symbol #2, Symbol #4} corresponding to {Resource #1, Resource #2, Resource #4}, which are the remaining resources among resource A except {Resource #3} corresponding to resource C, are mapped and transmitted. As a result, the terminal may assume that the symbol sequence {Symbol #1, Symbol #2, Symbol #4} is transmitted by being mapped to {Resource #1, Resource #2, Resource #4}, respectively, and perform a series of subsequent receiving operations.

In the following, a method for configuring rate matching resources for the purpose of rate matching in a 5G communication system is described. Rate matching means that the size of a signal is adjusted in consideration of the amount of resource that can transmit the signal. For example, rate matching of a data channel may mean that the size of data is adjusted accordingly without mapping and transmitting the data channel for a specific time and frequency resource area.

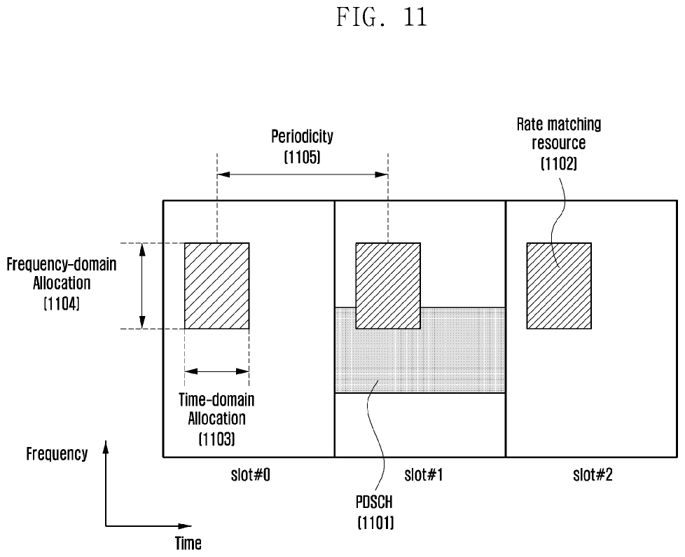

FIG. 11 is a diagram explaining a method for a base station and a terminal to transmit and receive data while considering downlink data channels and rate matching resources.

FIG. 11 illustrates a downlink data channel (PDSCH) 1101 and a rate matching resource 1102. A base station may configure one or more rate matching resources 1102 to a terminal through upper layer signaling (e.g., RRC signaling). The rate matching resource 1102 configuration information may include time domain resource allocation information 1103, frequency-domain resource allocation information 1104, and period information 1105. In the following, a bitmap corresponding to frequency-domain resource allocation information 1104 is named “first bitmap,” a bitmap corresponding to time domain resource allocation information 1103 is named “second bitmap,” and a bitmap corresponding to period information 1105 is named “third bitmap.” If all or part of the time and frequency resources of a scheduled data channel 1101 overlap with the configured rate matching resource 602, the base station may rate-match and transmit the data channel 1101 in the rate matching resource 1102 portion, and the terminal may perform reception and decoding after assuming that the data channel 1101 is rate-matched in the rate matching resource 1102 portion.

The base station may dynamically notify the terminal through DCI whether to rate-match the data channel in the configured rate-matching resource portion through additional configuration (corresponding to the “rate-matching indicator” in the DCI format described above). Specifically, the base station may select some of the configured rate-matching resources and group them into rate-matching resource groups and may use a bitmap method to indicate to the terminal through DCI whether to rate-match the data channel for each rate-matching resource group. For example, if four rate-matching resources, RMR #1, RMR #2, RMR #3, and RMR #4 are configured, the base station may configure RMG #1={RMR #1, RMR #2}, RMG #2={RMR #3, RMR #4} as the rate-matching groups, and may use 2 bits in the DCI field to indicate to the terminal whether to rate-match in RMG #1 and RMG #2, respectively, as a bitmap. For example, if rate matching is required, it may be indicated as “1”, and if rate matching is not required, it may be indicated as “0”.

In 5G, the granularity of “RB symbol level” and “RE level” is supported by configuring the aforementioned rate matching resources to the terminal. More specifically, the following configuration method may be followed.

### RB Symbol Level

A terminal may configure up to four RateMatchPatterns for each bandwidth part through upper layer signaling, and one RateMatchPattern may include the following contents.
As a reserved resource within the bandwidth part, a resource in which the time and frequency resource domains of the reserved resource are configured by combining a bitmap of the RB level and a bitmap of the symbol level along the frequency domain may be included. The reserved resource may span one or two slots. A time domain pattern (periodicityAndPattern) in which the time and frequency domains composed of each RB level and symbol level bitmap pair are repeated may be additionally configured.
It may include a time and frequency domain resource area configured as a control resource set within the bandwidth part and a resource area corresponding to a time domain pattern configured as a search space configuration in which the resource area is repeated.

### RE Level

The terminal may be configured with the following contents through upper layer signaling.
The configuration information (lte-CRS-ToMatchAround) for RE corresponding to the LTE CRS (Cell-specific Reference Signal or Common Reference Signal) pattern may include the number of ports (nrofCRS-Ports) of LTE CRS and the LTE-CRS-vshift(s) value (v-shift), the location information (carrierFreqDL) of the center subcarrier of the LTE carrier from the reference frequency point (for example, reference point A), the bandwidth size (carrierBandwidthDL) information of the LTE carrier, and the subframe configuration information (mbsfn-SubframConfigList) corresponding to the MBSFN (Multicast-broadcast single-frequency network). On the basis of the above-described information, the terminal may determine the location of the CRS within the NR slot corresponding to the LTE subframe.
It may include configuration information for a resource set corresponding to one or more ZP (Zero Power) CSI-RS within the bandwidth part.

### [LTE CRS Rate Match Related]

Next, the rate match process for the LTE CRS described above will be described in detail. In order to coexist between LTE (Long Term Evolution) and NR (New RAT), NR provides a function to configure a pattern of LTE CRS (Cell Specific Reference Signal) to NR terminals. More specifically, the CRS pattern may be provided by RRC signaling including at least one parameter in ServingCellConfig IE (Information Element) or ServingCellConfigCommon IE. Examples of the parameters may include lte-CRS-ToMatchAround, Ite-CRS-PatternList1-r16, Ite-CRS-PatternList2-r16, crs-RateMatch-PerCORESETPoolIndex-r16, etc.

In Rel-15 NR, the lte-CRS-ToMatchAround parameter provides a function that allows one CRS pattern to be configured per serving cell. In Rel-16 NR, the function is extended to allow multiple CRS patterns to be configured per serving cell. More specifically, in a Single-TRP (transmission and reception point) configured terminal, one CRS pattern may be configured per LTE carrier, and in a Multi-TRP configured terminal, two CRS patterns may be configured per LTE carrier. For example, in a Single-TRP configured terminal, up to three

CRS patterns may be configured per serving cell through the lte-CRS-PatternList1-r16 parameter. In another example, in a multi-TRP configured terminal, CRS may be configured per TRP. That is, the CRS pattern for TRP1 may be configured through the lte-CRS-PatternList1-r16 parameter, and the CRS pattern for TRP2 may be configured through the lte-CRS-PatternList2-r16 parameter. Meanwhile, when two TRPs are configured as above, whether both the CRS patterns of TRP1 and TRP2 or only the CRS pattern for one TRP is applied to a specific PDSCH (Physical Downlink Shared Channel) is determined through the crs-RateMatch-PerCORESETPoolIndex-r16 parameter. If the crs-RateMatch-PerCORESETPoolIndex-r16 parameter is configured to enabled, only the CRS pattern of one TRP is applied, and in other cases, the CRS patterns of both TRPs are applied.

Table 17 shows a ServingCellConfig IE including the above CRS pattern, and Table 18 shows a RateMatchPatternLTE-CRS IE including at least one parameter for the CRS pattern.

TABLE 17

| | |
|---|---|
| ServingCellConfig ::= | SEQUENCE { |

| | |
|---|---|
| tdd-UL-DL-ConfigurationDedicated | TDD-UL-DL-ConfigDedicated |

OPTIONAL, -- Cond IDD

| | |
|---|---|
| initialDownlinkBWP | BWP-DownlinkDedicated |

OPTIONAL, -- Need M

| | |
|---|---|
| downlinkBWP-ToReleaseList | SEQUENCE (SIZE (1..maxNrofBWPs)) OF |

| | |
|---|---|
| BWP-Id | OPTIONAL, -- Need N |

| | |
|---|---|
| downlinkBWP-ToAddModList | SEQUENCE (SIZE (1..maxNrofBWPs)) OF |

| | |
|---|---|
| BWP-Downlink | OPTIONAL, -- Need N |

| | |
|---|---|
| firstActiveDownlinkBWP-Id | BWP-Id |

OPTIONAL, -- Cond SyncAndCellAdd

| | |
|---|---|
| bwp-InactivityTimer | ENUMERATED (ms2, ms3, ms4, ms5, ms6, |

ms8, ms10, ma20, ms30,

ms40,ms50, ms60, ms80,ms100,

ms200,ms300, ms500,

ms750, ms1280, ms1920, ms2560,

spare10, spare9, spare8,

spare7, spare6, spare5, spare4,

| | |
|---|---|
| spare3, spare2, spare1 } | OPTIONAL, --Need R |

| | |
|---|---|
| defaultDownlinkBWP-Id | BWP-Id |

OPTIONAL, -- Need S

| | |
|---|---|
| uplinkConfig | UplinkConfig |

OPTIONAL, -- Need M

| | |
|---|---|
| supplementaryUplink | UplinkConfig |

OPTIONAL, -- Need M

| | |
|---|---|
| pdcch-ServingCellConfig | SetupRelease |

| | |
|---|---|
| { PDCCH-ServingCellConfig } | OPTIONAL, -- Need M |

| | |
|---|---|
| pdsch-ServingCellConfig | SetupRelease |

| | |
|---|---|
| { PDSCH-ServingCellConfig } | OPTIONAL, -- Need M |

| | |
|---|---|
| csi-MeasConfig | SetupRelease { CSI-MeasConfig } |

OPTIONAL, -- Need M

| | |
|---|---|
| sCellDeactivationTimer | ENUMERATED {ms20, ms40, ms80, ms160, |

ms200, ms240,

ms320, ms400, ms480, ms520,

ms640, ms720,

ms840, ms1280, spare2,spare1}

OPTIONAL, -- CondServingCellWithoutPUCCH

| | |
|---|---|
| crossCarrierSchedulingConfig | CrossCarrierSchedulingConfig |

OPTIONAL, -- Need M

| | |
|---|---|
| tag-Id | TAG-Id, |
| dummy | ENUMERATED {enabled} |

OPTIONAL, -- Need R

| | |
|---|---|
| pathlossReferenceLinking | ENUMERATED {spCell, sCell} |

OPTIONAL, -- Cond SCellOnly

| | |
|---|---|
| servingCellMO | MeasObjectId |

```
OPTIONAL, -- Cond MeasObject
    ...,
    [[
```

| | |
|---|---|
| lte-CRS-ToMatchAround | SetupRelease |

| | |
|---|---|
| { RateMatchPatternLTE-CRS } | OPTIONAL, -- Need M |

| | |
|---|---|
| rateMatchPatternToAddModList | SEQUENCE (SIZE |

| | |
|---|---|
| (1..maxNrofRateMatchPatterns)) OF RateMatchPattern | OPTIONAL, -- Need N |

| | |
|---|---|
| rateMatchPatternToReleaseList | SEQUENCE (SIZE |

| | |
|---|---|
| (1..maxNrofRateMatchPatterns)) OF RateMatchPatternId | OPTIONAL, -- Need N |

| | |
|---|---|
| downlinkChannelBW-PerSCS-List | SEQUENCE (SIZE (1..maxSCSs)) OF |

| | |
|---|---|
| SCS-SpecificCarrier | OPTIONAL -- Need S |

```
    ]],
    [[
```

| | |
|---|---|
| supplementaryUplinkRelease | ENUMERATED {true} |

OPTIONAL, -- Need N
tdd-UL-DL-ConfigurationDedicated-IAB-MT-r16

| | |
|---|---|
| TDD-UL-DL-ConfigDedicated-IAB-MT-r16 | OPTIONAL, -- |

Cond IDD_IAB

| | |
|---|---|
| dormantBWP-Config-r16 | SetupRelease { DormantBWP-Config-r16 } |

OPTIONAL, -- Need M

| | |
|---|---|
| ca-SlotOffset-r16 | CHOICE { |

| | |
|---|---|
| refSCS15kHz | INTEGER (-2..2), |
| refSCS30KHz | INTEGER (-5..5), |
| refSCS60KHz | INTEGER (-10..10), |
| refSCS120KHz | INTEGER (-20..20) |

}
OPTIONAL, -- Cond AsyncCA

| | |
|---|---|
| channelAccessConfig-r16 | SetupRelease |

| | |
|---|---|
| { ChannelAccessConfig-r16 } | OPTIONAL, -- Need M |

| | |
|---|---|
| intraCellGuardBandsDL-List-r16 | SEQUENCE (SIZE (1..maxSCSs)) OF |
| IntraCellGuardBandsPerSCS-r16 | OPTIONAL, -- Need S |
| intraCellGuardBandsUL-List-r16 | SEQUENCE (SIZE (1..maxSCSs)) OF |
| IntraCellGuardBandsPerSCS-r16 | OPTIONAL, -- Need S |
| csi-RS-ValidationWith-DCI-r16 | ENUMERATED {enabled} |

OPTIONAL, -- Need R

| | |
|---|---|
| lte-CRS-PatternList1-r16 | SetupRelease |

| | |
|---|---|
| { LTE-CRS-PatternList-r16 } | OPTIONAL, -- Need M |

| | |
|---|---|
| lte-CRS-PatternList2-r16 | SetupRelease |

| | |
|---|---|
| { LTE-CRS-PatternList-r16 } | OPTIONAL, -- Need M |

crs-RateMatch-PerCORESETPoolIndex-r16 ENUMERATED {enabled}
OPTIONAL, -- Need R

| | |
|---|---|
| enableTwoDefaultTCI-States-r16 | ENUMERATED {enabled} |

OPTIONAL, -- Need R
enableDefaultTCI-StatePerCoresetPoolIndex-r16 ENUMERATED {enabled}
OPTIONAL, -- Need R

| | |
|---|---|
| enableBeamSwitchTiming-r16 | ENUMERATED {true} |

OPTIONAL, -- Need R

| | |
|---|---|
| cbg-TxDiffTBsProcessingType1-r16 | ENUMERATED {enabled} |

OPTIONAL, -- Need R

| | |
|---|---|
| cbg-TxDiffTBsProcessingType2-r16 | ENUMERATED {enabled} |

OPTIONAL -- Need R
]]
}

TABLE 18
- RateMatchPatternLTE-CRS
The IE RateMatchPatternLTE-CRS is used to configure a pattern to rate match around LTE CRS. See TS
38.214 [19], clause 5.1.4.2.
RateMatchPatternLTE-CRS information element
-- ASN1START
-- TAG-RATEMATCHPATTERNLTE-CRS-START

| | |
|---|---|
| RateMatchPatternLTE-CRS ::= | SEQUENCE { |
| carrierFreqDL | INTEGER (0..16383), |
| carrierBandwidthDL | ENUMERATED {n6, n15, n25, n50, n75, n100, spare2, spare1}, |
| mbsfn-SubframeConfigList | EUTRA-MBSFN-SubframeConfigList |

OPTIONAL, -- Need M

| | |
|---|---|
| nrofCRS-Ports | ENUMERATED {n1, n2, n4}, |
| v-Shift | ENUMERATED {n0, n1, n2, n3, n4, n5} |

}

| | |
|---|---|
| LTE-CRS-PatternList-r16 ::= | SEQUENCE (SIZE (1..maxLTE-CRS-Patterns-r16)) OF |

RateMatchPatternLTE-CRS
-- TAG-RATEMATCHPASTERNLTE-CRS-STOP
-- ASN1STOP
RateMatchPatternLTE-CRS field descriptions
carrierBandwidthDL
BW of the LTE carrier in number of PRBs (see TS 38.214 [19], clause 5.1.4.2).
carrierFreqDL
Center of the LTE carrier (see TS 38.214 [19], clause 5.1.4.2).
mbsfn-SubframeConfigList
LTE MBSFN subframe configuration (see TS 38.214 [19], clause 5.1.4.2).
nrofCRS-Ports
Number of LTE CRS antenna port to rate-match around (see TS 38.214 [19], clause 5.1.4.2).
v-Shift
Shifting value v-shift in LTE to rate match around LTE CRS (see TS 38.214 [19], clause 5.1.4.2).

### [PDSCH: Frequency Resource Allocation Related]

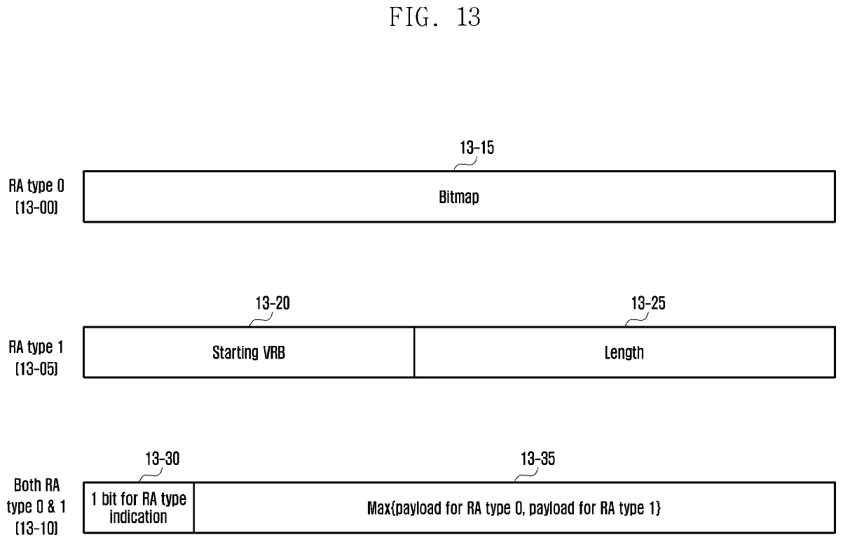

FIG. 13 is a diagram illustrating an example of frequency domain resource allocation of a PDSCH (physical downlink shared channel) in a wireless communication system according to one embodiment of the present disclosure.

FIG. 13 is a diagram illustrating three frequency domain resource allocation methods, type 0 13-00, type 1 13-05, and dynamic switch 13-10, which may be configured through a higher layer in an NR wireless communication system.

With reference to FIG. 13, if a terminal is configured to use only resource type 0 13-00 through upper layer signaling, some downlink control information (DCI) that allocates PDSCH to the terminal includes a bitmap consisting of NRBG bits. The conditions for this will be explained later. At this time, NRBG means the number of RBG (resource block groups) determined according to the BWP size allocated by the BWP indicator and the upper layer parameter rbg-Size as shown in [Table 19] below, and data is transmitted to the RBG indicated as 1 by the bitmap.

TABLE 19

| Bandwidth | Configuration | Configuration |
|---|---|---|
| Part Size | 1 | 2 |
| 1-36 | 2 | 4 |
| 37-72 | 4 | 8 |
| 73-144 | 8 | 16 |
| 145-275 | 16 | 16 |

If the terminal is configured to use only resource type 1 through upper layer signaling 13-05, some DCIs that allocate PDSCH to the terminal include frequency domain resource allocation information consisting of

$$⌈ {log}_{2} ( {N}_{R B}^{DL , BWP} ( {N}_{RB}^{DL , BWP} + 1 ) / 2 ⌉$$

bits. The conditions for this will be explained later. Through this, the base station may configure the starting VRB 13-20 and the length 13-25 of frequency domain resources allocated sequentially therefrom.

If the terminal is configured to use both resource type 0 and resource type 1 through upper layer signaling 13-10, some DCIs that allocate PDSCH to the terminal include frequency domain resource allocation information consisting of bits of the larger value 13-35 among the payload 13-15 for configuring resource type 0 and the payload 13-20 and 13-25 for configuring resource type 1. The conditions for this will be explained later. At this time, one bit may be added to the most significant bit (MSB) of the frequency domain resource allocation information in the DCI, and if the bit has a value of ‘0’, it may indicate that resource type 0 is used, and if it has a value of ‘1’, it may indicate that resource type 1 is used.

### [PDSCH/PUSCH: Time Resource Allocation Related]

In the following, a time domain resource allocation method for data channels in next-generation mobile communication systems (5G or NR system) is described.

A base station may configure a table for time domain resource allocation information for a Physical Downlink Shared Channel (PDSCH) and a Physical Uplink Shared Channel (PUSCH) to a terminal through higher layer signaling (e.g., RRC signaling). A table with up to maxNrofDL-Allocations=16 entries may be configured for PDSCH, and a table with up to maxNrofUL-Allocations=16 entries may be configured for PUSCH. In one embodiment, the time domain resource allocation information may include PDCCH-to-PDSCH slot timing (corresponding to a time interval in slot units between a time point when a PDCCH is received and a time point when a PDSCH scheduled by the received PDCCH is transmitted, denoted as K0), PDCCH-to-PUSCH slot timing (corresponding to a time interval in slot units between a time point when a PDCCH is received and a time point when a PUSCH scheduled by the received PDCCH is transmitted, denoted as K2), information about a position and a length of a start symbol in which a PDSCH or a PUSCH is scheduled within a slot, a mapping type of the PDSCH or PUSCH, etc. For example, information such as [Table 20] or [Table 21] below may be transmitted from a base station to a terminal.

TABLE 20
PDSCH-TimeDomainResourceAllocationList information element

PDSCH-TimeDomainResourceAllocationList ::= SEQUENCE
(SIZE(1..maxNrofDL-Allocations)) OF
PDSCH-TimeDomainResourceAllocation
PDSCH-TimeDomainResourceAllocation ::= SEQUENCE {

| | |
|---|---|
| k0 | INTEGER(0..32) |

OPTIONAL, -- Need S

| | |
|---|---|
| mappingType | ENUMERATED (typeA, typeB), |
| startSymbolAndLength | INTEGER (0..127) |

}

TABLE 21
PUSCH-TimeDomainResourceAllocationList information element

PUSCH-TimeDomainResourceAllocationList ::= SEQUENCE
(SIZE(1..maxNrofDL-Allocations)) OF
PUSCH-TimeDomainResourceAllocation
PUSCH-TimeDomainResourceAllocation ::= SEQUENCE {

| | | |
|---|---|---|
| k2 | INTEGER(0..32) | OPTIONAL, -- Need S |

| | |
|---|---|
| mappingType | ENUMERATED (typeA, typeB), |

| | |
|---|---|
| startSymbolAndLength | INTEGER (0..127) |

}

The base station may notify the terminal of one of the entries in the table for the time domain resource allocation information described above through L1 signaling (e.g., DCI) (e.g., it may be indicated by the ‘time domain resource allocation’ field in the DCI). The terminal may obtain the time domain resource allocation information for the PDSCH or PUSCH on the basis of the DCI received from the base station.

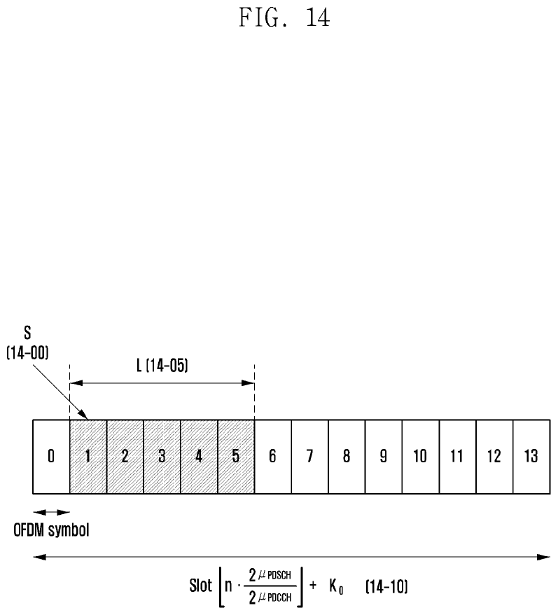

FIG. 14 is a diagram illustrating an example of time domain resource allocation of PDSCH in a wireless communication system according to one embodiment of the present disclosure.

With reference to FIG. 14, the base station may indicate the time domain position of the PDSCH resource according to the subcarrier spacing (SCS) (u PDSCH, U PDCCH) of the data channel and the control channel configured by using the upper layer, the scheduling offset K0 value, and the start position 14-00 and length 14-05 of the OFDM symbol within a slot dynamically indicated through DCI.

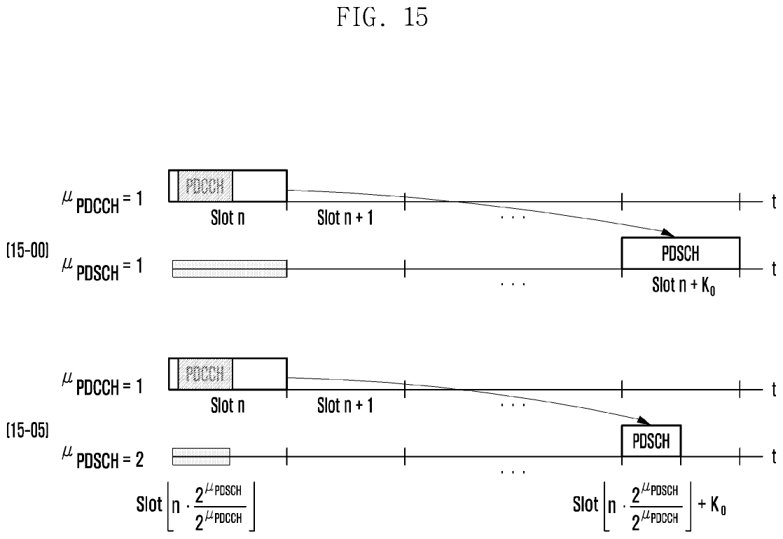

FIG. 15 is a diagram illustrating an example of time domain resource allocation according to subcarrier spacing of a data channel and a control channel in a wireless communication system according to one embodiment of the present disclosure.

With reference to FIG. 15, when the subcarrier spacing of a data channel and a control channel are the same 15-00, μ_{PDSCH}=μ_{PDCCH}, since the slot numbers for data and control are the same, the base station and the terminal may generate a scheduling offset according to a predetermined slot offset K0. On the other hand, when the subcarrier spacing of the data channel and the control channel are different 15-05, μ_{PDSCH}≈μ_{PDCCH}, since the slot numbers for data and control are different, the base station and the terminal may generate a scheduling offset according to a predetermined slot offset K0 on the basis of the subcarrier spacing of the PDCCH.

### [PDSCH: Processing Procedure Time]

Next, the PDSCH processing procedure time is described. When the base station schedules the terminal to transmit the PDSCH using DCI format 1_0, 1_1, or 1_2, the terminal may need PDSCH processing procedure time to receive the PDSCH by applying the transmission method indicated through the DCI (modulation and coding instruction index (MCS), demodulation reference signal related information, time and frequency resource allocation information, etc.). NR defines the PDSCH processing procedure time considering this. The PDSCH processing procedure time of the terminal may follow the following [Equation 3].

$${T}_{p r o c , 1} = ( {N}_{1} + {d}_{1 , 1} + {d}_{2} ) ( 2048 + 144 ) κ {2}^{- μ} {T}_{c} + {T}_{ext} \qquad [ Equation 3 ]$$

Each value of T_{proc,1} described in Equation 3 may have the following meaning.
N₁: The number of symbols determined by the UE processing capability 1 or 2 and the numerology u according to the capability of the terminal. If the UE processing capability is reported as 1 according to the capability report of the terminal, it may have the value of [Table 22], and if the UE processing capability is reported as 2 and it is configured through upper layer signaling that the UE processing capability 2 may be used, it may have the value of [Table 23]. The numerology μ may correspond to the minimum value among μ_{PDCCH}, μ_{PDSCH}, and μ_{UL} to maximize the T_{proc,1} and μ_{PDCCH}, μ_{PDCCH}, and μ_{UL} may mean the numerology of the PDCCH that schedules the PDSCH, the numerology of the scheduled PDSCH, and the numerology of the uplink channel on which HARQ-ACK is to be transmitted, respectively.

TABLE 22
PDSCH processing procedure time when
PDSCH processing capability is 1.

| | PDSCH decoding time N₁ [symbols] | |
|---|---|---|
| | | dmrs-AdditionalPosition |
| | | in higher layer signaling |
| | | DMRS-DownlinkConfig |
| | dmrs-AdditionalPosition | is not pos0 for both |
| | in higher layer signaling | PDSCH mapping |
| | DMRS-DownlinkConfig | type A and B |
| | is pos0 for both PDSCH | or higher layer |
| μ | mapping type A and B | parameter is figured |
| 0 | 8 | N_{1,0} |
| 1 | 10 | 13 |
| 2 | 17 | 20 |
| 3 | 20 | 24 |

TABLE 23
PDSCH processing procedure time when
PDSCH processing capability is 2.

| | PDSCH decoding time N¹ [symbols] |
|---|---|
| | dmrs-AdditionalPosition in higher layer |
| | signaling DMRS-DownlinkConfig is pos0 |
| μ | for both PDSCH mapping type A and B |
| 0 | 3 |
| 1 | 4.5 |
| 2 | 9 |
| | for frequency range 1 |

κ: 64
Tₑₓₜ: If the terminal uses the shared spectrum channel access method, the terminal may calculate Tₑₓₜ and apply it to the PDSCH processing procedure time. Otherwise, Tₑₓₜ is assumed to be 0.
l₁ indicating the PDSCH DMRS location value is 12, N1,0 in the above [Table 22] has a value of 14, otherwise it has a value of 13.
For PDSCH mapping type A, if the last symbol of the PDSCH is the i-th symbol in the slot in which the PDSCH is transmitted, and i<7, then d_{1,1} is 7-i, otherwise d_{1,1} is 0.
d₂: When a PUCCH with a high priority index and a PUCCH or PUSCH with a low priority index overlap in time, d₂ of the PUCCH with the high priority index may be configured to a value reported from the terminal. Otherwise, d₂ is 0.
If PDSCH mapping type B is used for terminal processing capability 1, the value of d_{1,1} may be determined on the basis of L, the number of symbols of the scheduled PDSCH, and d, the number of overlapping symbols between the PDCCH that schedules the PDSCH and the scheduled PDSCH.
If L≥7, then d_{1,1}=0.
If L≥4 and L≤6, then d_{1,1}=7−L.
If L=3, then d_{1,1}=min (d, 1).
If L=2, then d_{1,1=3}+d.
When PDSCH mapping type B is used for terminal processing capability 2, the value of d_{1,1} may be determined on the basis of L, the number of symbols of the scheduled PDSCH, and d, the number of overlapping symbols between the PDCCH that schedules the PDSCH and the scheduled PDSCH.
If L≥7, then d_{1,1}=0.
If L≥4 and L≤6, then d_{1,1}=7−L.
When L=2,
If the scheduled PDCCH exists within a CORESET consisting of three symbols, and the CORESET and the scheduled PDSCH have the same start symbol, d_{1,1}=3.
Otherwise, d_{1,1}=d.
For a terminal supporting capability 2 within a given serving cell, the PDSCH processing procedure time according to terminal processing capability 2 may be applied when the terminal configures processingType2Enabled, which is an upper layer signaling for the cell, to enable.

If the position of the first uplink transmission symbol of the PUCCH including HARQ-ACK information (For the corresponding position, K1-defined as the transmission time point of HARQ-ACK, PUCCH resources used for HARQ-ACK transmission, and timing advance effects may be considered) does not start earlier than the first uplink transmission symbol that comes after T_{proc,1} time from the last symbol of the PDSCH, the terminal shall transmit a valid HARQ-ACK message. That is, the terminal shall transmit the PUCCH including HARQ-ACK only when the PDSCH processing procedure time is sufficient. Otherwise, the terminal may not provide the base station with valid HARQ-ACK information corresponding to the scheduled PDSCH. The T-_{proc,1} may be used for both the normal and the extended CP. In case of a PDSCH having two PDSCH transmission positions in one slot, d_{1,1} is calculated on the basis of the first PDSCH transmission position in the corresponding slot.

### [PDSCH: Reception Preparation Time During Cross-Carrier Scheduling]

Next, in the case of cross-carrier scheduling where μ_{PDCCH}, a numerology through which the scheduled PDCCH is transmitted and μ_{PDSCH}, a numerology through which the PDSCH scheduled through the corresponding PDCCH is transmitted, are different from each other, the PDSCH reception preparation time, N-_{pdsch}, of the terminal defined for the time interval between the PDCCH and the PDSCH, is described.

If μ_{PDCCH}<μ_{PDSCH}, the scheduled PDSCH may not be transmitted earlier than the first symbol of the slot that follows N_{pdsch} symbols from the last symbol of the PDCCH that scheduled the PDSCH. The transmission symbol of the corresponding PDSCH may include a DM-RS.

If μ_{PDCCH}>μ_{PDSCH}, the scheduled PDSCH may be transmitted starting N_{pdsch} symbols after the last symbol of the PDCCH that scheduled the corresponding PDSCH. The transmission symbol of the corresponding PDSCH may include a DM-RS.

TABLE 23
N_{pdsch} according to scheduled
PDCCH subcarrier spacing

| μ_{PDCCH} | N_{pdsch} [symbols] |
|---|---|
| 0 | 4 |
| 1 | 5 |
| 2 | 10 |
| 3 | 14 |

### [PDSCH: TCI State Activation MAC-CE]

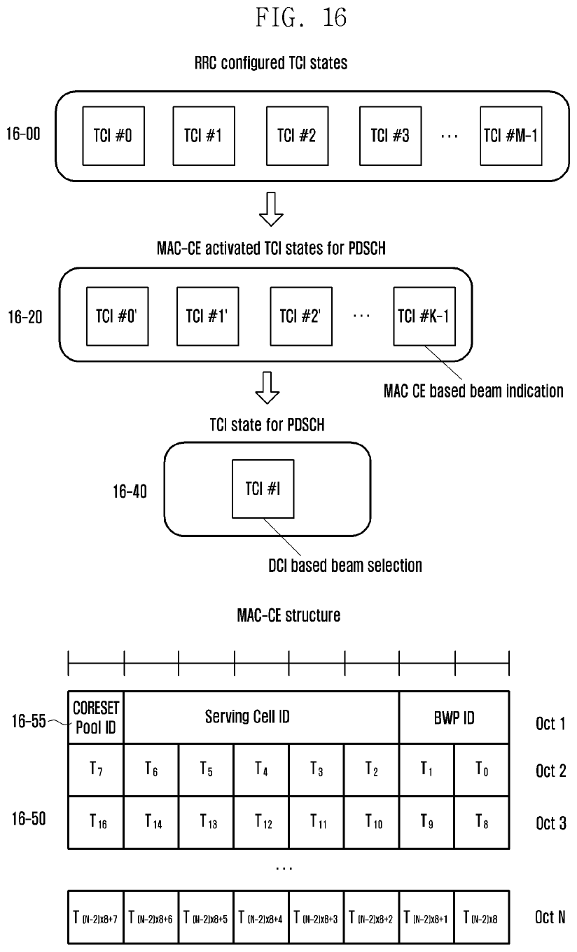

Next, a method for configuring a beam for PDSCH is examined. FIG. 16 illustrates a process for configuring and activating a beam for PDSCH. A list of TCI states for PDSCH may be indicated through a list of upper layers such as RRC (16-00). The list of TCI states may be indicated, for example, by tci-StatesToAddModList and/or tci-StatesToReleaseList in the PDSCH-Config IE for each BWP. Next, some of the list of TCI states may be activated through MAC-CE (16-20). The maximum number of TCI states to be activated may be determined according to the capability reported by the terminal. 16-50 illustrates an example of a MAC-CE structure for PDSCH TCI state activation/deactivation.

The meaning of each field in the above MAC CE and the values that may be configured for each field are as follows.

Serving Cell ID: This field indicates the identity of the Serving Cell for
which the MAC CE applies. The length of the field is 5 bits. If the indicated
Serving Cell is configured as part of a simultaneousTCI-UpdateList1 or
simultaneousTCI-UpdateList2 as specified in TS 38.331 [5], this MAC CE
applies to all the Serving Cells configured in the set simultaneousTCI-
UpdateList1 or simultaneousTCI-UpdateList2, respectively;
BWP ID: This field indicates a DL BWP for which the MAC CE applies
as the codepoint of the DCI bandwidth part indicator field as specified in TS
38.212 [9]. The length of the BWP ID field is 2 bits. This field is ignored if
this MAC CE applies to a set of Serving Cells;
Tᵢ: If there is a TCI state with TCI-StateId i as specified in TS 38.331 [5],
this field indicates the activation/deactivation status of the TCI state with
TCI-StateId i, otherwise MAC entity shall ignore the Ti field. The Ti field is
set to 1 to indicate that the TCI state with TCI-StateId i shall be activated
and mapped to the codepoint of the DCI Transmission Configuration
Indication field, as specified in TS 38.214 [7]. The Ti field is set to 0 to
indicate that the TCI state with TCI-Stateld i shall be deactivated and is not
mapped to the codepoint of the DCI Transmission Configuration Indication
field. The codepoint to which the TCI State is mapped is determined by its
ordinal position among all the TCI States with Ti field set to 1, i.e. the first
TCI State with Ti field set to 1 shall be mapped to the codepoint value 0,
second TCI State with Tᵢ field set to 1 shall be mapped to the codepoint value
1 and so on. The maximum number of activated TCI states is 8;
CORESET Pool ID: This field indicates that mapping between the
activated TCI states and the codepoint of the DCI Transmission
Configuration Indication set by field Ti is specific to the
ControlResourceSetId configured with CORESET Pool ID as specified in
TS 38.331 [5]. This field set to 1 indicates that this MAC CE shall be applied
for the DL transmission scheduled by CORESET with the CORESET pool
ID equal to 1, otherwise, this MAC CE shall be applied for the DL
transmission scheduled by CORESET pool ID equal to 0. If the
coresetPoolIndex is not configured for any CORESET, MAC entity shall
ignore the CORESET Pool ID field in this MAC CE when receiving the
MAC CE. If the Serving Cell in the MAC CE is configured in a cell list that
contains more than one Serving Cell, the CORESET Pool ID field shall be
ignored when receiving the MAC CE.

### [PUSCH: Transmission Method Related]

Next, the scheduling method of PUSCH transmission is described. PUSCH transmission may be dynamically scheduled by UL grant in DCI, or may operate by configured grant Type 1 or Type 2. Dynamic scheduling instruction for PUSCH transmission is possible in DCI format 0_0 or 0_1.

Configured grant Type 1 PUSCH transmission may be semi-statically scheduled by reception of configuredGrantConfig including rrc-ConfiguredUplinkGrant of [Table 25] through higher layer signaling, without reception of UL grant in DCI. Configured grant Type 2 PUSCH transmission may be semi-persistently scheduled by UL grant in DCI after reception of configuredGrantConfig not including rrc-ConfiguredUplinkGrant of [Table 25] through higher layer signaling. When PUSCH transmission operates by configured grant, parameters applied to PUSCH transmission are applied by configuredGrantConfig of [Table 25] through higher layer signaling, except dataScramblingIdentityPUSCH, txConfig, codebookSubset, maxRank, scaling of UCI-OnPUSCH provided by pusch-Config of [Table 26]. If the terminal has been provided with transformPrecoder in configuredGrantConfig, which is the upper signaling of [Table 25], the terminal applies tp-pi2BPSK in pusch-Config of [Table 26] to PUSCH transmission operated by configured grant.

TABLE 25

| | |
|---|---|
| ConfiguredGrantConfig ::= | SEQUENCE { |
| frequencyHopping | ENUMERATED {intraSlot, interSlot} |

OPTIONAL, -- Need S,

| | |
|---|---|
| cg-DMRS-Configuration | DMRS-UplinkConfig, |
| mcs-Table | ENUMERATED {qam256, qam64LowSE} |

OPTIONAL, -- Need S

| | |
|---|---|
| mcs-TableTransformPrecoder | ENUMERATED {qam256, qam64LowSE} |

OPTIONAL, -- Need S

| | |
|---|---|
| uci-OnPUSCH | SetupRelease { CG-UCI-OnPUSCH } |

OPTIONAL, -- Need M

| | |
|---|---|
| resourceAllocation | ENUMERATED { resourceAllocationType0, |

resourceAllocationType1, dynamicSwitch },

| | |
|---|---|
| rbg-Size | ENUMERATED {config2} |

OPTIONAL, -- Need S

| | |
|---|---|
| powerControlLoopToUse | ENUMERATED {n0, n1}, |
| p0-PUSCH-Alpha | P0-PUSCH-AlphaSetId, |
| transformPrecoder | ENUMERATED {enabled, disabled} |

OPTIONAL, -- Need S

| | |
|---|---|
| nrofHARQ-Processes | INTEGER(1..16), |
| repk | ENUMERATED {n1, n2, n4, n8}, |
| repK-RV | ENUMERATED (s1-0231, s2-0303, s3-0000} |

OPTIONAL, -- Need R

| | |
|---|---|
| periodicity | ENUMERATED { |
| | sym2, sym7, sym1x14, sym2x14, |

sym4x14 [symbol] c T [symbol] , sym5x14, sym8x14, sym10x14, sym16x14, sym20x14,

sym32x14, sym40x14, sym64x14, sym80x14,

sym128x14, sym160x14, sym256x14, sym320x14, sym512x14,

sym640x14, sym1024x14, sym1280x14,

sym2560x14, sym5120x14,

sym6, sym1x12, sym2x12, sym4x12,

sym5x12, sym8x12, sym10x12, sym16x12, sym20x12, sym32x12,

sym40x12, sym64x12, sym80x12,

sym128x12, sym160x12, sym256x12, sym320x12, sym512x12, sym640x12,

sym1280x12, sym2560x12

},

| | |
|---|---|
| configuredGrantTimer | INTEGER (1..64) |

OPTIONAL, -- Need R

| | |
|---|---|
| rrc-ConfiguredUplinkGrant | SEQUENCE { |
| timeDomainOffset | INTEGER (0..5119), |
| timeDomainAllocation | INTEGER (0..15), |
| frequencyDomainAllocation | BIT STRING (SIZE(18)), |
| antennaPort | INTEGER (0..31), |
| dmrs-SeqInitialization | INTEGER (0..1) |

OPTIONAL, -- Need R

| | |
|---|---|
| precodingAndNumberOfLayers | INTEGER (0..63), |
| srs-ResourceIndicator | INTEGER (0..15) |

OPTIONAL, -- Need R

| | |
|---|---|
| mcsAndTBS | INTEGER (0..31), |
| frequencyHoppingOffset | INTEGER (1.. |
| maxNrofPhysicalResourceBlocks-1) | OPTIONAL, -- Need R |
| pathlossReferenceIndex | INTEGER |

```
(0..maxNrofPUSCH-PathlossReferenceRSs-1),
        ...
    }
OPTIONAL, -- Need R
    ...
}
```

Next, the PUSCH transmission method is described. The DMRS antenna port for PUSCH transmission is the same as the antenna port for SRS transmission. PUSCH transmission may follow the codebook-based transmission method and the non-codebook-based transmission method, respectively, depending on whether the value of txConfig in the pusch-Config of [Table 26], which is the upper signaling, is ‘codebook’ or ‘nonCodebook’.

As described above, PUSCH transmission may be dynamically scheduled through DCI format 0_0 or 0_1, and may be semi-statically configured by configured grant. If the terminal is instructed to schedule PUSCH transmission through DCI format 0_0, the terminal performs beam configuration for

PUSCH transmission using pucch-spatialRelationInfoID corresponding to the UE-specific PUCCH resource corresponding to the minimum ID within the activated uplink BWP within the serving cell, and at this time, the PUSCH transmission is on the basis of a single antenna port. The UE does not expect scheduling for PUSCH transmission through DCI format 0_0 within a BWP where a PUCCH resource including pucch-spatialRelationInfo is not configured. If the terminal has not configured txConfig in pusch-Config of [Table 26], the terminal does not expect to be scheduled with DCI format 0_1.

TABLE 26

| | |
|---|---|
| PUSCH-Config ::= | SEQUENCE { |
| dataScramblingIdentityPUSCH | INTEGER (0..1023) |
| OPTIONAL, -- Need S | ENUMERATED {codebook, nonCodebook} |
| txConfig | |
| OPTIONAL, -- Need S | |
| dmrs-UplinkForPUSCH-MappingTypeA | SetupRelease { DMRS-UplinkConfig } |
| OPTIONAL, -- Need M | |
| dmrs-UplinkForPUSCH-MappingTypeB | SetupRelease { DMRS-UplinkConfig } |
| OPTIONAL, -- Need M | |
| pusch-PowerControl | PUSCH-PowerControl |
| OPTIONAL, -- Need M | |
| frequencyHopping | ENUMERATED {intraSlot, interSlot} |
| OPTIONAL, -- Need S | |
| frequencyHoppingOffsetLists | SEQUENCE (SIZE (1..4)) OF INTEGER (1.. maxNrofPhysicalResourceBlocks-1) |
| OPTIONAL, -- Need M | |
| resourceAllocation | ENUMERATED { resourceAllocationType0, resourceAllocationType1, |
| | dynamicSwitch}, |
| pusch-TimeDomainAllocationList | SetupRelease { PUSCH-TimeDomainResourceAllocationList } |
| OPTIONAL, -- Need M | |
| pusch-AggregationFactor | ENUMERATED { n2, n4, n8 } |
| OPTIONAL, -- Need S | |
| mcs-Table | ENUMERATED {qam256, qam64LowSE} |
| OPTIONAL, -- Need S | |
| mcs-TableTransformPrecoder | ENUMERATED {qam256, qam64LowSE} |
| OPTIONAL, -- Need S | |
| transformPrecoder | ENUMERATED {enabled, disabled} |
| OPTIONAL, -- Need S | |
| codebookSubset | ENUMERATED {fullyAndPartialAndNonCoherent, |

partialAndNonCoherent,nonCoherent}

| | |
|---|---|
| OPTIONAL, -- Cond codebookBased | INTEGER (1..4) |
| maxRank | |
| OPTIONAL, -- Cond codebookBased | ENUMERATED { config2} |
| rbg-Size | |
| OPTIONAL, -- Need S | |
| uci-OnPUSCH | SetupRelease { UCI-OnPUSCH} |
| OPTIONAL, - Need M | |
| tp-pi2BPSK | ENUMERATED {enabled} |
| OPTIONAL, -- Need S | |
| ... | |
| } | |

Next, codebook-based PUSCH transmission is described. Codebook-based PUSCH transmission may be dynamically scheduled through DCI format 0_0 or 0_1, and may operate semi-statically by configured grant. When codebook-based PUSCH is dynamically scheduled through DCI format 0_1 or semi-statically configured through configured grant, the terminal determines a precoder for PUSCH transmission on the basis of SRS Resource Indicator (SRI), Transmission Precoding Matrix Indicator (TPMI), and transmission rank (the number of PUSCH transmission layers).

At this time, SRI may be given through field SRS resource indicator in DCI or configured through upper signaling srs-ResourceIndicator. When codebook-based PUSCH transmission is performed, the terminal is configured with at least one SRS resource, and may be configured with up to two SRS resources. When the terminal receives SRI through DCI, the SRS resource indicated by the SRI means an SRS resource corresponding to the SRI among the SRS resources transmitted before the PDCCH including the SRI. In addition, TPMI and transmission rank may be given through field precoding information and number of layers in DCI or configured through upper signaling precodingAndNumberOfLayers. TPMI is used to indicate a precoder to be applied to PUSCH transmission. If the terminal is configured with one SRS resource, TPMI is used to indicate a precoder to be applied in the configured one SRS resource. When a terminal is configured with multiple SRS resources, TPMI is used to indicate the precoder to be applied in the SRS resource indicated through SRI.

A precoder to be used for PUSCH transmission is selected from an uplink codebook having the same number of antenna ports as the nrofSRS-Ports value in the upper layer signaling, SRS-Config. In codebook-based PUSCH transmission, the terminal determines a codebook subset on the basis of TPMI and codebookSubset in the upper layer signaling, pusch-Config. The codebookSubset in the upper layer signaling, pusch-Config, may be configured to one of ‘fully AndPartialAndNonCoherent’, ‘partialAndNonCoherent’, or ‘nonCoherent’ on the basis of the UE capability that the terminal reports to the base station. If the terminal reports ‘partialAndNonCoherent’ as the UE capability, the terminal does not expect the value of codebookSubset in the upper layer signaling to be configured to ‘fullyAndPartialAndNonCoherent’. Additionally, if the terminal reports ‘nonCoherent’ as the UE capability, the terminal does not expect the value of codebookSubset in the upper signaling be to configured to ‘fully AndPartial AndNonCoherent’ or ‘partialAndNonCoherent’. If nrofSRS-Ports in the upper signaling SRS-ResourceSet points to two SRS antenna ports, the terminal does not expect the value of codebookSubset in the upper signaling to be configured to ‘partial AndNonCoherent’.

A terminal may receive one SRS resource set in which the usage value in the upper signaling SRS-ResourceSet is configured to ‘codebook’, and one SRS resource in the corresponding SRS resource set may be indicated through SRI. If multiple SRS resources are configured in an SRS resource set in which the usage value in the upper signaling SRS-ResourceSet is configured to ‘codebook’, the terminal expects that the value of nrofSRS-Ports in the upper signaling SRS-Resource is configured to the same value for all SRS resources.

A terminal may transmit to the base station one or multiple SRSs included in SRS resource set in which the usage value is configured to ‘codebook’ according to upper signaling, and the base station selects one of the SRS resources transmitted by the terminal and instructs the terminal to perform PUSCH transmission using transmission beam information of the corresponding SRS resource. At this time, in codebook-based PUSCH transmission, the SRI is used as information for selecting an index of one SRS resource and is included in the DCI. Additionally, the base station includes in the DCI the information indicating TPMI and rank to be used by the terminal for PUSCH transmission. The terminal performs PUSCH transmission by applying the indicated rank and the precoder indicated by the TPMI on the basis of the transmission beam of the corresponding SRS resource using the SRS resource indicated by the SRI.

Next, non-codebook based PUSCH transmission is described. Non-codebook based PUSCH transmission may be dynamically scheduled through a DCI format 0_0 or 0_1, and may operate semi-statically by configured grant. If at least one SRS resource is configured in an SRS resource set in which the value of usage in upper signaling SRS-ResourceSet is configured to ‘nonCodebook’, the terminal may be scheduled for non-codebook based PUSCH transmission through DCI format 0_1.

For an SRS resource set in which the usage value in the upper signaling SRS-ResourceSet is configured to ‘nonCodebook’, the terminal may be configured with one connected NZP CSI-RS (non-zero power CSI-RS) resource. The terminal may perform calculation for a precoder for SRS transmission through measurement of the NZP CSI-RS resource connected to the SRS resource set. If the difference between the last received symbol of the aperiodic NZP CSI-RS resource connected to the SRS resource set and the first symbol of the aperiodic SRS transmission at the terminal is less than 42 symbols, the terminal does not expect information on the precoder for SRS transmission to be updated.

If the value of resourceType in the upper signaling SRS-ResourceSet is configured to ‘aperiodic’, the connected NZP CSI-RS is indicated by the SRS request field in DCI format 0_1 or 1_1. At this time, if the connected NZP CSI-RS resource is an aperiodic NZP CSI-RS resource, it indicates the existence of the connected NZP CSI-RS when the value of the field SRS request in DCI format 0_1 or 1_1 is not ‘00’. At this time, the DCI must not indicate cross carrier or cross BWP scheduling. In addition, if the value of SRS request indicates the existence of the NZP CSI-RS, the NZP CSI-RS is located in the slot in which the PDCCH including the SRS request field is transmitted. At this time, the TCI states configured for the scheduled subcarriers are not configured to QCL-TypeD.

If a periodic or semi-persistent SRS resource set is configured, the associated NZP CSI-RS may be indicated through the associatedCSI-RS in the upper layer signaling SRS-ResourceSet. For non-codebook based transmission, the terminal does not expect that the upper layer signaling spatialRelationInfo for SRS resources and the associatedCSI-RS in the upper layer signaling SRS-ResourceSet are configured together.

When multiple SRS resources are configured, the terminal may determine the precoder and transmission rank to be applied to PUSCH transmission on the basis of the SRI indicated by the base station. At this time, the SRI may be indicated through SRS resource indicator, the field in the DCI, or configured through the upper signaling srs-ResourceIndicator. Similar to the codebook-based PUSCH transmission described above, when the terminal is provided with an SRI through the DCI, the SRS resource indicated by the SRI means an SRS resource corresponding to the SRI among the SRS resources transmitted before the PDCCH including the SRI. The terminal may use one or more SRS resources for SRS transmission, and the maximum number of SRS resources that may be simultaneously transmitted in the same symbol within one SRS resource set and the maximum number of SRS resources are determined by the UE capability that the terminal reports to the base station. At this time, the SRS resources that the UE simultaneously transmits occupy the same RB. The terminal configures one SRS port for each SRS resource. Only one SRS resource configured with the usage value configured to ‘nonCodebook’ in the upper signaling SRS-ResourceSet may be configured, and up to four SRS resources for non-codebook based PUSCH transmission may be configured.

The base station transmits one NZP-CSI-RS associated with an SRS resource set to the terminal, and the terminal calculates a precoder to be used when transmitting one or more SRS resources within the SRS resource set on the basis of a result measured upon reception of the NZP-CSI-RS. When the terminal transmits one or more SRS resources within the SRS resource set of which usage is configured to ‘nonCodebook’ to the base station, the terminal applies the calculated precoder, and the base station selects one or more SRS resources from the received one or more SRS resources. At this time, in non-codebook based PUSCH transmission, SRI represents an index that can express a combination of one or more SRS resources, and the SRI is included in the DCI. At this time, the number of SRS resources indicated by the SRI transmitted by the base station may be the number of transmission layers of the PUSCH, and the terminal transmits the PUSCH by applying the precoder applied to SRS resource transmission for each layer.

### [PUSCH: Preparation Procedure Time]

Next, the PUSCH preparation procedure time is described. When the base station schedules the terminal to transmit the PUSCH using DCI format 0_0, 0_1, or 0_2, the terminal may need a PUSCH preparation procedure time to transmit the PUSCH by applying the transmission method (transmission precoding method of SRS resource, number of transmission layers, spatial domain transmission filter) indicated through the DCI. NR defines the PUSCH preparation procedure time considering this. The PUSCH preparation procedure time of the UE may follow the following [Equation 4].

$${T}_{p roc , 2} = max ( ( {N}_{2} + {d}_{2 , 1} + {d}_{2} ) ( 2048 + 144 ) κ {2}^{- μ} {T}_{c} + {T}_{ext} + {T}_{switch} , {d}_{2 , 2} ) \qquad [ Equation 4 ]$$

In the above-described T_{proc,2} in Equation 4, each variable may have the following meaning.
N₂: The number of symbols determined by the UE processing capability 1 or 2 and the numerology u according to the capability of the terminal. If the UE processing capability is reported as 1 according to the capability report of the terminal, it may have the value of [Table 27], and if the UE processing capability is reported as 2 and it is configured through upper layer signaling that the UE processing capability 2 may be used, it may have the value of [Table 28].

TABLE 27

| | PUSCH preparation |
|---|---|
| μ | time N₂ [symbols] |
| 0 | 10 |
| 1 | 12 |
| 2 | 23 |
| 3 | 36 |

TABLE 28

| | PUSCH preparation |
|---|---|
| μ | time N₂ [symbols] |
| 0 | 5 |
| 1 | 5.5 |
| 2 | 11 |
| | for frequency range 1 |

d_{2,1}: The number of symbols configured to 0 if all resource elements of the first OFDM symbol of PUSCH transmission are configured to consist of only DM-RS, otherwise configured to 1.
κ: 64
μ: Among μ_{DL} or μ_{UL}, T_{proc,2} follows the larger value. μ_{DL} refers to the numerology of the downlink where PDCCH including the DCI scheduling PUSCH is transmitted, and μ_{UL} refers to the numerology of the uplink where PUSCH is transmitted.
T_{c}: it has 1/(Δfₘₐₓ·N_{f}), Δfₘₐₓ=480·10³ H: N_{f}=4096.
d_{2,2}: If the DCI scheduling PUSCH indicates BWP switching, the BWP switching time is followed. Otherwise, it has 0.
d₂: When PUCCH and the OFDM symbols of the PUSCH with a high priority index and the PUCCH with a low priority index overlap in time, the d₂ value of the PUSCH with a high priority index is used. Otherwise, d₂ is 0.
Tₑₓₜ: If the terminal uses the shared spectrum channel access method, the terminal may calculate Tₑₓₜ and apply it to the PUSCH preparation procedure time. Otherwise, Tₑₓₜ is assumed to be 0.
T_{switch}: When the uplink switching interval is triggered, T_{switch} is assumed to be the switching interval time. Otherwise, it is assumed to be 0.

When the base station and the terminal consider the time domain resource mapping information of the PUSCH scheduled through the DCI and the influence of the uplink-downlink timing advance, the base station and the terminal determine that the PUSCH preparation time is not sufficient if the first symbol of the PUSCH starts before the first uplink symbol where the CP starts after T_{proc,2} from the last symbol of the PDCCH including the DCI that scheduled the PUSCH. Otherwise, the base station and the terminal determine that the PUSCH preparation time is sufficient. The terminal transmits the PUSCH only when the PUSCH preparation time is sufficient, and may ignore the DCI that schedules the PUSCH if the PUSCH preparation time is not sufficient.

### [PUSCH: Repetition Transmission Related]

The following describes in detail the repetition transmission of uplink data channels in 5G systems. The 5G system supports two types of repetition transmission methods for uplink data channels: PUSCH repetition transmission type A and PUSCH repetition transmission type B. A terminal may be configured to either PUSCH repetition transmission type A or B through upper layer signaling.

### PUSCH Repetition Transmission Type A

As described above, the symbol length and the position of the start symbol of the uplink data channel are determined by the time domain resource allocation method within one slot, and the base station may notify the terminal of the number of repeated transmissions through higher layer signaling (e.g. RRC signaling) or L1 signaling (e.g. DCI).
The terminal may repeatedly transmit an uplink data channel having the same length and start symbol as the uplink data channel configured on the basis of the number of repeated transmissions received from the base station in consecutive slots. In this case, if a slot is configured by the base station to the terminal as downlink or at least one symbol among the symbols of the uplink data channel configured by the terminal is configured as downlink, the terminal omits the uplink data channel transmission, but counts the number of repeated transmissions of the uplink data channel.

### PUSCH Repetition Transmission Type B

As described above, the start symbol and length of the uplink data channel are determined by the time domain resource allocation method within one slot, and the base station may notify the terminal of the number of repetition transmissions, numberofrepetitions, through upper signaling (e.g. RRC signaling) or L1 signaling (e.g. DCI).
First, the nominal repetition of the uplink data channel is determined on the basis of the start symbol and length of the configured uplink data channel as follows. The slot where the n-th nominal repetition starts is given by

$${K}_{s} + ⌊ \frac{S + n \cdot L}{{N}_{symb}^{slot}} ⌋ ,$$

and the symbol starting in that slot is given by

$$mod ( S + n \cdot L , {N}_{symb}^{slot} ) .$$

The slot where the n-th nominal repetition ends is given by

$${K}_{s} + ⌊ \frac{S + ( n + 1 ) \cdot L - 1}{{N}_{symb}^{slot}} ⌋ ,$$

and the symbol ending in that slot is given by

$$mod ( S + ( n + 1 ) \cdot L - 1 , {N}_{symb}^{slot} ) .$$

Here, n=0, . . . , numberofrepetitions −1, S represents the start symbol of the configured uplink data channel, and L represents the symbol length of the configured uplink data channel. Kₛ represents the slot where the PUSCH transmission starts and

$${N}_{symb}^{slot}$$

represents the number of symbols per slot.
The terminal determines an invalid symbol for PUSCH repetition transmission type B. A symbol configured for downlink by tdd-UL-DL-ConfigurationCommon or tdd-UL-DL-ConfigurationDedicated is determined as an invalid symbol for PUSCH repetition transmission type B. Additionally, an invalid symbol may be configured in a higher layer parameter (e.g., InvalidSymbolPattern). The higher layer parameter (e.g., InvalidSymbolPattern) provides a symbol level bitmap spanning one slot or two slots so that an invalid symbol may be configured. 1 in the bitmap indicates an invalid symbol. Additionally, a period and a pattern of the bitmap may be configured through a higher layer parameter (e.g., periodicity AndPattern). If a higher layer parameter (e.g., InvalidSymbolPattern) is configured and the InvalidSymbolPatternIndicator-ForDCIFormat0_1 or InvalidSymbolPatternIndicator-ForDCIFormat0_2 parameter indicates 1, the terminal applies the invalid symbol pattern, and if the parameter indicates 0, the terminal does not apply the invalid symbol pattern. If a higher layer parameter (e.g., InvalidSymbolPattern) is configured and the InvalidSymbolPatternIndicator-ForDCIFormat0_1 or InvalidSymbolPatternIndicator-ForDCIFormat0_2 parameter is not configured, the terminal applies the invalid symbol pattern.

After the invalid symbol is determined, for each nominal repetition, the terminal may consider symbols other than the invalid symbol as valid symbols. If each nominal repetition includes one or more valid symbols, the nominal repetition may include one or more actual repetitions. Here, each actual repetition includes a continuous set of valid symbols that may be used for PUSCH repetition transmission type B in one slot.

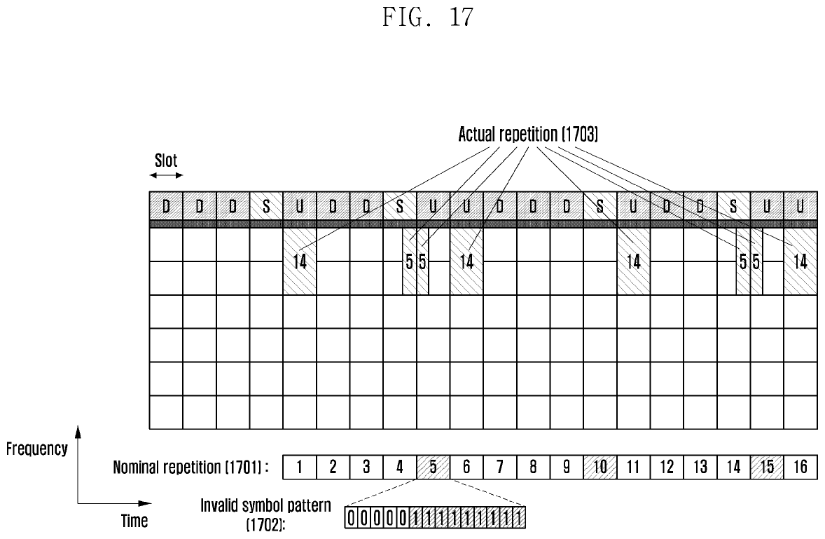

FIG. 17 is a diagram illustrating an example of PUSCH repetition transmission type B in a wireless communication system according to one embodiment of the present disclosure. A terminal may configure a start symbol S of an uplink data channel to 0 and a length L of an uplink data channel to 14, and may configure the number of repetition transmissions to 16. In this case, nominal repetition 1701 is indicated in 16 consecutive slots. After that, the terminal may determine a symbol configured as a downlink symbol in each nominal repetition 1701 as an invalid symbol. In addition, the terminal determines symbols configured to 1 in an invalid symbol pattern 1702 as invalid symbols. If valid symbols that are not invalid symbols in each nominal repetition consist of one or more consecutive symbols in one slot, they are configured as actual repetition 1703 and transmitted.

Additionally, for PUSCH repetition transmissions, NR Release 16 may define the following additional methods for UL grant-based PUSCH transmission across slot boundaries and configured grant-based PUSCH transmission:
Method 1 (mini-slot level repetition): Two or more PUSCH repetition transmissions are scheduled within one slot or across the boundary of consecutive slots through one UL grant. In addition, for Method 1, time domain resource allocation information in the DCI indicates resources of the first repetition transmission. In addition, time domain resource information of the first repetition transmission and time domain resource information of the remaining repetition transmissions may be determined on the basis of the uplink or downlink direction determined for each symbol in each slot. Each repetition transmission occupies consecutive symbols.
Method 2 (multi-segment transmission): Two or more PUSCH repetition transmissions are scheduled in consecutive slots through one UL grant. In this case, one transmission is designated for each slot, and different starting points or repetition lengths may be different for each transmission. In addition, in Method 2, the time domain resource allocation information in the DCI indicates the starting points and repetition lengths of all repetition transmissions. In addition, when performing repetition transmissions in a single slot through Method 2, if there are multiple bundles of consecutive uplink symbols in the slot, each repetition transmission is performed for each bundle of uplink symbols. If there is only one bundle of consecutive uplink symbols in the slot, one PUSCH repetition transmission is performed according to the method of NR Release 15.
Method 3: Two or more PUSCH repeated transmissions are scheduled in consecutive slots through two or more UL grants. In this case, one transmission is designated for each slot, and the n-th UL grant may be received before the PUSCH transmission scheduled by the (n−1)th UL grant ends.
Method 4: One or more PUSCH repetition transmissions in a single slot, or two or more PUSCH repetition transmissions across the boundary of consecutive slots may be supported through one UL grant or one configured grant. The number of repetitions that the base station indicates to the terminal is only a nominal value, and the number of PUSCH repetition transmissions that the terminal actually performs may be greater than the nominal number of repetitions. The time domain resource allocation information in the DCI or the configured grant indicates the resources of the first repetition transmission indicated by the base station. The time domain resource information of the remaining repetition transmissions may be determined by referring at least to the resource information of the first repetition transmission and the uplink or downlink direction of the symbols. If the time domain resource information of the repetition transmission indicated by the base station crosses the slot boundary or includes an uplink/downlink switching point, the corresponding repetition transmission may be divided into multiple repetition transmissions.

In this case, one repetition transmission may be included for each uplink period in one slot.

### [PUSCH: Frequency Hopping Process]

In the following, we specifically describe frequency hopping of the uplink data channel (Physical Uplink Shared Channel; PUSCH) in a 5G system.

In 5G, two methods are supported for each PUSCH repetition transmission type as a frequency hopping method for uplink data channels. First, PUSCH repetition transmission type A supports intra-slot frequency hopping and inter-slot frequency hopping, and PUSCH repetition transmission type B supports inter-repetition frequency hopping and inter-slot frequency hopping.

The intra-slot frequency hopping method supported in PUSCH repetition transmission type A is a method in which a terminal changes the allocated resources of the frequency domain by a configured frequency offset and transmits them in two hops within one slot. In intra-slot frequency hopping, the start RB of each hop may be expressed by Equation 5.

$${RB}_{start} = \{ \begin{matrix}{RB}_{start} & i = 0 \\ ( {RB}_{start} + {RB}_{offset} ) mod {N}_{BWP}^{size} & i = 1\end{matrix} \qquad [ Equation 5 ]$$

In Equation 5, i=0 and i=1 represent the first hop and the second hop, respectively, and RBₛₜₐᵣₜ represents the starting RB in the UL BWP and is calculated from the frequency resource allocation method. RB_{offset} represents the frequency offset between two hops through the upper layer parameters. The number of symbols of the first hop may be represented as

$$⌊ {N}_{symb}^{PUSCH , s} / 2 ⌋ ,$$

and the number of symbols of the second hop may be represented as

$${N}_{symb}^{PUSCH , s} - ⌊ {N}_{s v m b}^{PUSCH , s} / 2 ⌋ . {N}_{symb}^{PUSCH , s}$$

is the length of PUSCH transmission in one slot, which is represented as the number of OFDM symbols.

Next, the inter-slot frequency hopping method supported by PUSCH repetition transmission types A and B is a method in which a terminal changes the allocated resources of the frequency domain by a configured frequency offset for each slot and transmits them. In inter-slot frequency hopping, the starting RB during a

$${n}_{s}^{μ}$$

slot may be expressed by Equation 6.

$$R {B}_{start} ( {n}_{s}^{μ} ) = \{ \begin{matrix}{RB}_{start} & {n}_{s}^{μ} mod 2 = 0 \\ ( {RB}_{start} + {RB}_{offset} ) mod {N}_{BWP}^{size} & {n}_{s}^{μ} mod 2 = 1\end{matrix} \qquad [ Equation 6 ]$$

In Equation 6,

$${n}_{s}^{μ}$$

represents the current slot number in multi-slot PUSCH transmission, RBₛₜₐᵣₜ represents the starting RB in UL BWP and is calculated from the frequency resource allocation method. RB_{offset} represents the frequency offset between two hops through the upper layer parameter.

Next, the inter-repetition frequency hopping method supported in PUSCH repetition transmission type B is to transmit the allocated resources in the frequency domain for one or more actual repetitions within each nominal repetition by shifting them by a configured frequency offset. RBₛₜₐᵣₜ(n), which is the index of the starting RB in the frequency domain for one or more actual repetitions within the n-th nominal repetition, may follow the following Equation 7.

$${RB}_{start} ( n ) = \{ \begin{matrix}{RB}_{start} & n mod 2 = 0 \\ ( {RB}_{start} + {RB}_{offset} ) mod {N}_{BWP}^{size} & n mod 2 = 1\end{matrix} \qquad [ Equation 7 ]$$

In Equation 7, n is the index of nominal repetition, and RB_{offset} represents the RB offset between two hops through the upper layer parameter.

### [UE Capability Reporting Related]

In LTE and NR, a terminal may perform a procedure to report the capabilities supported by the terminal to the serving base station while connected to the serving base station. In the explanation below, this is referred to as a UE capability report.

A base station may transmit a UE capability enquiry message requesting a capability report to a terminal in a connected state. The message may include a UE capability request for each radio access technology (RAT) type of the base station. The RAT type-specific request may include information on a combination of supported frequency bands, etc. In addition, in the case of the UE capability enquiry message, multiple UE capabilities for each RAT type may be requested through one RRC message container transmitted by the base station, or the base station may include the UE capability inquiry message including the UE capability request for each RAT type multiple times and transmit it to the terminal. That is, the UE capability inquiry may be repeated multiple times in one message, and the terminal may configure a corresponding UE capability information message and report it multiple times. In the next-generation mobile communication system, a UE capability request may be made for Multi-RAT dual connectivity (MR-DC), including NR, LTE, and E-UTRA—NR dual connectivity (EN-DC). Additionally, the UE capability inquiry message is typically transmitted initially after the terminal is connected to the base station, but it may be requested under any conditions when the base station is needed.

In the above step, the terminal that receives the UE capability report request from the base station configures the UE capability according to the RAT type and band information requested from the base station. Below is a summary of how the terminal configures the UE capability in the NR system.

1. If the terminal receives a list of LTE and/or NR bands from the base station as a UE capability request, the terminal configures a band combination (BC) for EN-DC and NR stand alone (SA). That is, it configures a candidate list of BCs for EN-DC and NR SA on the basis of the bands requested to the base station as FreqBandList. In addition, the priority of the bands is given in the order listed in FreqBandList.

2. If the bast station requests a UE capability reporting by configuring “eutra-nr-only” flag or the “eutra” flag, the terminal completely removes NR SA BCs from the candidate list of the configured BCs. This operation may only occur when the LTE base station (eNB) requests the “eutra” capability.

3. After that, the terminal removes fallback BCs from the candidate list of BCs configured in the above step. Here, fallback BC means a BC that may be obtained by removing at least one band corresponding to SCell from any BC, and may be omitted because the BC before removing the band corresponding to at least one SCell can already cover the fallback BC. This step is also applied to MR-DC, i.e., to LTE bands. The BCs remaining after this step are the final “candidate BC list.”

4. The terminal selects BCs to report by selecting BCs that match the requested RAT type from the final “candidate BC list” above. In this step, the terminal configures the supported BandCombinationList in a determined order. That is, the terminal configures BCs and UE capabilities to report in the order of the predetermined rat-Type (nr->eutra-nr->eutra). In addition, it configures featureSetCombination for the configured supportedBandCombinationList and configures a list of “candidate feature set combinations” from the candidate BC list from which the list for the fallback BC (which includes capabilities of the same or lower level) is removed. The “candidate feature set combination” above includes feature set combinations for both NR and EUTRA-NR BCS, and may be obtained from feature set combinations of the UE-NR-Capabilities and UE-MRDC-Capabilities containers.

5. In addition, if the requested rat Type is eutra-nr and influential, featureSetCombinations are included in both containers: UE-MRDC-Capabilities and UE-NR-Capabilities. However, the feature set of NR is included only in UE-NR-Capabilities.

After the UE capability is configured, the terminal transmits a UE capability information message containing the UE capability to the base station. On the basis of the UE capability received from the terminal, the base station then performs appropriate scheduling and transmission/reception management for the terminal.

### [CA/DC Related]

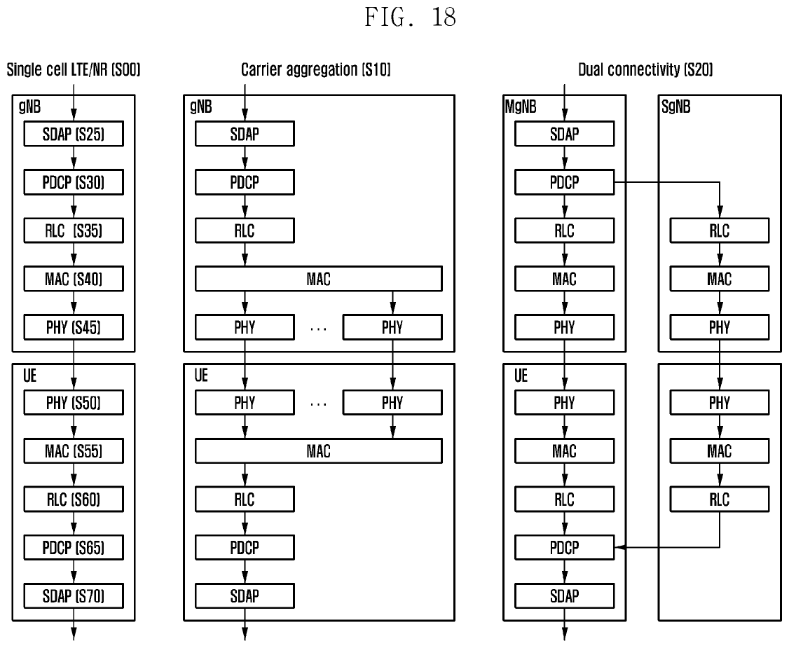

FIG. 18 is a diagram illustrating a wireless protocol structure of a base station and a terminal in a single cell, carrier aggregation, and dual connectivity situation according to one embodiment of the present disclosure.

With reference to FIG. 18, the wireless protocol of the next-generation mobile communication system consists of NR Service Data Adaptation Protocol (SDAP) S25 and S70, NR Packet Data Convergence Protocol (PDCP) S30 and S65, NR Radio Link Control (RLC) S35 and S60, and NR Medium Access Control (MAC) S40 and S55 in the terminal and NR base station, respectively.

Key features of NR SDAP S25 and S70 may include some of the following:
Transfer of user plane data
Mapping between a QoS flow and a DRB for both DL and UL
Marking QoS flow ID in both DL and UL packets
Function to map reflective QoS flow to DRB mapping for the UL SDAP PDUs.

For the above SDAP layer device, the terminal may be configured by an RRC message for each PDCP layer device, by bearer, or by logical channel, whether to use the header of the SDAP layer device or whether to use the function of the SDAP layer device, and if the SDAP header is configured, the terminal may instruct the NAS QoS reflection configuration 1-bit indicator (NAS reflective QoS) and the AS QoS reflection configuration 1-bit indicator (AS reflective QoS) of the SDAP header to update or reconfigure the mapping information for the QoS flow and data bearer of the uplink and downlink. The SDAP header may include QoS flow ID information indicating QoS. The QoS information may be used as data processing priority, scheduling information, etc. to support a desired service.

The main functions of NR PDCP S30 and S65 may include some of the following functions.
Header compression and decompression (ROHC only)
Transfer of user data function
In-sequence delivery of upper layer PDUs
Out-of-sequence delivery of upper layer PDUs
PDCP PDU reordering for reception
Duplicate detection of lower layer SDUs
Retransmission of PDCP SDUs
Ciphering and deciphering functions
Timer-based SDU discard in uplink

The reordering function of the NR PDCP device above refers to a function of reordering PDCP PDUs received from a lower layer in order on the basis of a PDCP sequence number (SN), and may include a function of transmitting data to an upper layer in the reordered order. Alternatively, the reordering function of the NR PDCP device may include a function of directly transmitting data without considering the order, a function of recording lost PDCP PDUs by reordering the order, a function of reporting a status of lost PDCP PDUs to the transmitting side, and a function of requesting retransmission of lost PDCP PDUs.

The main functions of NR RLC S35 and S60 may include some of the following functions.
Transfer of upper layer PDUs
In-sequence delivery of upper layer PDUs
Out-of-sequence delivery of upper layer PDUs
Error Correction through ARQ
Concatenation, segmentation and reassembly of RLC SDUs
Re-segmentation of RLC data PDUs
Reordering of RLC data PDUs
Duplicate detection function
Protocol error detection
RLC SDU discard function
RLC re-establishment function

In the above, the in-sequence delivery function of the NR RLC device means the function of sequentially delivering RLC SDUs received from a lower layer to an upper layer. The in-sequence delivery function of the NR RLC device may include a function of reassembling and delivering a single RLC SDU that is originally divided into multiple RLC SDUs and received, a function of rearranging received RLC PDUs on the basis of the RLC sequence number (SN) or the PDCP sequence number (SN), a function of recording lost RLC PDUs by rearranging the order, a function of reporting the status of lost RLC PDUs to the transmitting side, and a function of requesting retransmission of lost RLC PDUs. The in-sequence delivery function of the NR RLC device may include a function to sequentially deliver to the upper layer only the RLC SDUs up to the lost RLC SDU if there is a lost RLC SDU, or may include a function to sequentially deliver to the upper layer all RLC SDUs received before the timer starts if a predetermined timer has expired even if there is a lost RLC SDU. Alternatively, the in-sequence delivery function of the NR RLC device may include a function to sequentially deliver to the upper layer all RLC SDUs received up to the present if a predetermined timer has expired even if there is a lost RLC SDU. In addition, the RLC PDUs may be processed in the order they are received (in the order of arrival, regardless of the order of the sequence number) and delivered to the PDCP device regardless of the order (out-of-sequence delivery), or in the case of segments, the segments stored in the buffer or to be received later may be received, reconstructed into a single complete RLC PDU, processed, and delivered to the PDCP device. The above NR RLC layer may not include a concatenation function, and the function may be performed in the NR MAC layer or replaced with a multiplexing function of the NR MAC layer.

The out-of-sequence delivery function of the NR RLC device mentioned above refers to the function of directly delivering RLC SDUs received from a lower layer to an upper layer regardless of the order, and may include a function of reassembling and delivering multiple RLC SDUs when one RLC SDU is originally received in multiple RLC SDUs, and may include a function of storing and arranging the RLC SN or PDCP SN of received RLC PDUs to record any lost RLC PDUs.

NR MAC S40 and S55 may be connected to multiple NR RLC layer devices configured in one terminal, and the main functions of NR MAC may include some of the following functions.
Mapping between logical channels and transport channels
Multiplexing/demultiplexing of MAC SDUs
Scheduling information reporting function
HARQ function (Error correction through HARQ)
Priority handling between logical channels of one UE
Priority handling between UEs by means of dynamic scheduling
MBMS service identification function
Transmission format selection function
Padding function

The NR PHY layer S45 and S50 may perform operations of channel coding and modulating upper layer data, converting it into OFDM symbols and transmitting it over a wireless channel, or demodulating and channel decoding OFDM symbols received over a wireless channel and transmitting them to a higher layer.

The above wireless protocol structure may have various detailed structures changed depending on the carrier (or cell) operation method. For example, if a base station transmits data to a terminal on the basis of a single carrier (or cell), the base station and the terminal use a protocol structure having a single structure for each layer, such as S00. On the other hand, if the base station transmits data to a terminal on the basis of carrier aggregation (CA) that uses multiple carriers in a single TRP, the base station and the terminal use a protocol structure that has a single structure up to RLC, but multiplexes the PHY layer through the MAC layer, such as S10. As another example, if the base station transmits data to a terminal on the basis of dual connectivity (DC) that uses multiple carriers in multiple TRPs, the base station and the terminal use a protocol structure that has a single structure up to RLC, but multiplexes the PHY layer through the MAC layer, such as S20.

### [SRS Related]

Next, a method for estimating an uplink channel using a Sounding Reference Signal (SRS) transmission of a terminal is described. A base station may configure at least one SRS configuration for each uplink BWP to transmit configuration information for SRS transmission to a terminal, and may also configure at least one SRS resource set for each SRS configuration. For example, the base station and the terminal may exchange the following upper signaling information to transmit information about the SRS resource set.
srs-ResourceSetId: SRS resource set index
srs-ResourceIdList: A set of SRS resource indices referenced in the SRS resource set
resource Type: This is the time domain transmission configuration of the SRS resource referenced in the SRS resource set, and may be configured to one of ‘periodic’, ‘semi-persistent’, and ‘aperiodic’. If configured to ‘periodic’ or ‘semi-persistent’, associated CSI-RS information may be provided depending on the usage of the SRS resource set. If configured to ‘aperiodic’, an aperiodic SRS resource trigger list and slot offset information may be provided, and associated CSI-RS information may be provided depending on the usage of the SRS resource set.
usage: This is a configuration for the usage of the SRS resource referenced in the SRS resource set, and may be configured to one of ‘beamManagement’, ‘codebook’, ‘nonCodebook’, and ‘antennaSwitching’.
alpha, p0, pathlossReferenceRS, srs-PowerControlAdjustmentStates: Provides parameter configurations for adjusting the transmission power of SRS resources referenced in the SRS resource set.

The terminal may understand that the SRS resource included in the set of SRS resource indices referenced in the SRS resource set follows the information configured in the SRS resource set.

In addition, the base station and the terminal may transmit and receive upper layer signaling information to convey individual configuration information for the SRS resource. For example, the individual configuration information for the SRS resource may include time-frequency domain mapping information within a slot of the SRS resource, which may include information about frequency hopping within a slot or between slots of the SRS resource. In addition, the individual configuration information for the SRS resource may include a time domain transmission configuration of the SRS resource, which may be configured to one of ‘periodic’, ‘semi-persistent’, and ‘aperiodic’. This may be restricted to have the same time domain transmission configuration as an SRS resource set including the SRS resource. If the time domain transmission configuration of the SRS resource is configured to ‘periodic’ or ‘semi-persistent’, an SRS resource transmission period and slot offset (e.g., periodicity AndOffset) may be additionally included in the time domain transmission configuration.

The base station may activate, deactivate, or trigger SRS transmission to the terminal through higher layer signaling including RRC signaling or MAC CE signaling, or L1 signaling (e.g., DCI). For example, the base station may activate or deactivate periodic SRS transmission to the terminal through higher layer signaling. The base station may instruct the terminal to activate an SRS resource set in which resourceType is configured to periodic through higher layer signaling, and the terminal may transmit an SRS resource referenced in the activated SRS resource set. Time-frequency domain resource mapping within a slot of the transmitted SRS resource follows resource mapping information configured in the SRS resource, and slot mapping including a transmission period and a slot offset follows periodicity AndOffset configured in the SRS resource. In addition, a spatial domain transmission filter applied to the transmitted SRS resource may refer to spatial relation info configured in the SRS resource, or may refer to associated CSI-RS information configured in an SRS resource set including the SRS resource. A terminal may transmit SRS resources within an activated uplink BWP for activated periodic SRS resources through upper layer signaling.

For example, the base station may activate or deactivate semi-persistent SRS transmission to the terminal through upper layer signaling. The base station may instruct to activate an SRS resource set through MAC CE signaling, and the terminal may transmit an SRS resource referenced in the activated SRS resource set. The SRS resource set activated through MAC CE signaling may be limited to an SRS resource set of which resourceType is configured to semi-persistent. Time-frequency domain resource mapping within a slot of the transmitted SRS resource follows resource mapping information configured in the SRS resource, and slot mapping including a transmission period and a slot offset follows periodicity AndOffset configured in the SRS resource. In addition, the spatial domain transmission filter applied to the transmitted SRS resource may refer to spatial relation info configured in the SRS resource, or may refer to associated CSI-RS information configured in an SRS resource set including the SRS resource. If spatial relation info is configured in the SRS resource, the spatial domain transmission filter may be determined by referring to the configuration information for spatial relation info delivered through MAC CE signaling that activates semi-persistent SRS transmission without following it. The terminal may transmit the SRS resource within the activated uplink BWP for the semi-persistent SRS resource activated through upper layer signaling.

For example, a base station may trigger aperiodic SRS transmission to a terminal through DCI. The base station may indicate one of aperiodic SRS resource triggers (aperiodicSRS-ResourceTrigger) through an SRS request field of the DCI. The terminal may understand that an SRS resource set including an aperiodic SRS resource trigger indicated through DCI in an aperiodic SRS resource trigger list among configuration information of an SRS resource set is triggered. The terminal may transmit an SRS resource referenced in the triggered SRS resource set. Time-frequency domain resource mapping within a slot of the transmitted SRS resource follows resource mapping information configured in the SRS resource. In addition, the slot mapping of the transmitted SRS resource may be determined through a slot offset between a PDCCH including DCI and the SRS resource, and this may refer to value(s) included in a slot offset set configured in the SRS resource set. Specifically, the slot offset between the PDCCH including DCI and the SRS resource may apply a value indicated in the time domain resource assignment field of the DCI among the offset value(s) included in the slot offset configured in the SRS resource set. In addition, the spatial domain transmission filter applied to the transmitted SRS resource may refer to the spatial relation info configured in the SRS resource, or may refer to the associated CSI-RS information configured in the SRS resource set including the SRS resource. The terminal may transmit the SRS resource within the activated uplink BWP for the aperiodic SRS resource triggered through the DCI.

When a base station triggers an aperiodic SRS transmission to a terminal through DCI, a minimum time interval may be required between a PDCCH including the DCI triggering the aperiodic SRS transmission and the SRS to be transmitted, in order for the terminal to transmit the SRS by applying configuration information for the SRS resource. The time interval for the SRS transmission of the terminal may be defined as the number of symbols between the last symbol of the PDCCH including the DCI triggering the aperiodic SRS transmission and the first symbol to which the SRS resource to be transmitted is mapped first among the SRS resource(s) to be transmitted. The minimum time interval may be determined with reference to the PUSCH preparation procedure time required for the terminal to prepare for the PUSCH transmission. In addition, the minimum time interval may have different values depending on the usage of the SRS resource set including the SRS resource to be transmitted. For example, the minimum time interval may be determined as N2 symbols defined by considering the terminal processing ability according to the capability of the terminal with reference to the PUSCH preparation procedure time of the terminal. In addition, considering the usage of the SRS resource set including the SRS resource to be transmitted, if the usage of the SRS resource set is configured to ‘codebook’ or ‘antennaSwitching’, the minimum time interval may be configured to N2 symbols, and if the usage of the SRS resource set is configured to ‘nonCodebook’ or ‘beamManagement’, the minimum time interval may be configured to N2+14 symbols. The terminal transmits an aperiodic SRS if the time interval for aperiodic SRS transmission is greater than or equal to the minimum time interval, and may ignore the DCI that triggers the aperiodic SRS if the time interval for aperiodic SRS transmission is less than the minimum time interval.

TABLE 29

| | |
|---|---|
| SRS-Resource ::= | SEQUENCE { |
| srs-ResourceId | SRS-ResourceId, |
| nrofSRS-Ports | ENUMERATED {port1, ports2, ports4}, |
| ptrs-PortIndex | ENUMERATED {n0, n1 } |
| OPTIONAL, -- Need R | |
| transmissionComb | CHOICE { |
| n2 | SEQUENCE { |
| combOffset-n2 | INTEGER (0..1), |
| cyclicShift-n2 | INTEGER (0..7) |
| }, | |
| n4 | SEQUENCE { |
| combOffset-n4 | INTEGER (0..3), |
| cyclicShift-n4 | INTEGER (0..11) |
| } | |
| }, | |
| resourceMapping | SEQUENCE { |
| startPosition | INTEGER (0..5), |
| nrofSymbols | ENUMERATED {n1, n2, n4}, |
| repetitionFactor | ENUMERATED {n1, n2, n4} |
| }, | |
| freqDomainPosition | INTEGER (0..67), |
| freqDomainShift | INTEGER (0..268), |
| freqHopping | SEQUENCE { |
| c-SRS | INTEGER (0..63), |
| b-SRS | INTEGER (0..3), |
| b-hop | INTEGER (0..3) |
| }, | |
| groupOrSequenceHopping | ENUMERATED { neither, groupHopping, |

sequenceHopping },

| | |
|---|---|
| resourceType | CHOICE { |
| aperiodic | SEQUENCE { |
| ... | |
| }, | |
| semi-persistent | SEQUENCE { |
| periodicityAndOffset-sp | SRS-PeriodicityAndOffset, |
| ... | |
| }, | |
| periodic | SEQUENCE { |
| periodicityAndOffset-p | SRS-PeriodicityAndOffset, |
| ... | |
| } | |
| }, | |
| sequenceId | INTEGER (0..1023), |
| spatialRelationInfo | SRS-SpatialRelationInfo |
| OPTIONAL, -- Need R | |
| ..., | |
| [[ | |
| resourceMapping-r16 | SEQUENCE { |
| startPosition-r16 | INTEGER (0..13), |
| nrofSymbols-r16 | ENUMERATED {n1, n2, n4}, |
| repetitionFactor-r16 | ENUMERATED {n1, n2, n4} |

```
      } OPTIONAL -- Need R
      ]],
      [[
```

| | |
|---|---|
| spatialRelationInfo-PDC-r17 | SetupRelease { SpatialRelationInfo-PDC-r17 } |

OPTIONAL, -- Need M

| | |
|---|---|
| resourceMapping-r17 | SEQUENCE { |

```
          startPosition-r17 INTEGER (0..13),
          nrofSymbols-r17 ENUMERATED {n1, n2, n4, n8, n10, n12, n14},
          repetitionFactor-r17 ENUMERATED {n1, n2, n4, n5, n6, n7, n8, n10, n12, n14}
      } OPTIONAL, -- Need R
```

| | |
|---|---|
| partialFreqSounding-r17 | SEQUENCE { |
| startRBIndexFScaling-r17 | CHOICE{ |

```
              startRBIndexAndFreqScalingFactor2-r17 INTEGER (0..1),
              startRBIndexAndFreqScalingFactor4-r17 INTEGER (0..3)
      },
      enableStartRBHopping-r17 ENUMERATED {enable} OPTIONAL -- Need R
      } OPTIONAL, -- Need R
      transmissionComb-n8-r17 SEQUENCE {
          combOffset-n8-r17 INTEGER (0..7),
          cyclicShift-n8-r17 INTEGER (0..5)
      } OPTIONAL, -- Need R
      srs-TCIState-r17 CHOICE {
          srs-UL-TCIState-r17 TCI-UL-State-Id-r17,
          srs-DLorJoint-TCIState-r17 TCI-StateId
      } OPTIONAL -- Need R
      ]]
    }
}
```

The following SRS parameters may be configured semi-statically by the upper layer parameter SRS-Resource.
srs-ResourceId determines the SRS resource configuration identifier.
The number of SRS ports may be configured by the upper layer parameter nrofSRS-Ports and may be configured to 1, 2 or 4. If nrofSRS-Ports is not configured, nrofSRS-Ports is 1.
The time domain behavior of SRS resource placement, as indicated by the upper layer parameter resourceType, may be one of ‘periodic’, ‘semi-persistent’, or ‘aperiodic’ SRS transmission.
When the SRS resource type is periodic or semi-persistent, the slot level period and slot level offset are determined by the upper layer parameters periodicity AndOffset-p or periodicity AndOffset-sp. The terminal expects that SRS resources with different slot level periods will not be configured in the same SRS resource set SRS-ResourceSet. When the upper layer parameter resourceType for SRS-ResourceSet is configured to ‘aperiodic’, the slot level offset is defined by the upper layer parameter slotOffset.
The number of OFDM symbols in the SRS resource, the starting OFDM symbol in the slot, and the repetition factor R are configured by the upper layer parameter resourceMapping. If R is not configured, R is equal to the number of OFDM symbols in the SRS resource.
SRS bandwidths B_SRS and C_SRS are configured by the upper layer parameter freqHopping. If not configured, B_SRS becomes 0.
Frequency hopping bandwidth b_hop is configured by the upper layer parameter freqHopping. If not configured, b_hop becomes 0.
The frequency domain position and configurable shift are configured by the upper layer parameters freqDomainPosition and freqDomainShift, respectively. If freqDomainPosition is not configured, its value is 0.
The cyclic shift is configured by the upper layer parameters cyclicShift-n2, cyclicShift-n4 or cyclicShift-n8 for transmission comb values 2, 4 and 8 respectively.
The transmission comb value is configured by the upper layer parameter transmissionComb.
The transmission comb offset is configured by the upper layer parameters combOffset-n2, combOffset-n4 or combOffset-n8 for transmission comb values 2, 4 and 8 respectively.
The SRS sequence ID is configured by the upper layer parameter sequenceID.
The adjacent symbols of Nₛ=1, 2, or 4 within the last 6 symbols of a slot may be configured as SRS resources of the terminal using the upper layer parameter resourceMapping in SRS-Resource. At this time, each symbol of the resource is mapped to all SRS antenna ports.
Through the upper layer parameter resourceMapping-r16 in the SRS resource, the base station may configure as many as Nₛ=1, 2, or 4 adjacent symbols in all symbol positions in the slot as the SRS time resource of the terminal. In addition, repetitionFactor-r16 may have one of R=1, 2, or 4 values, and R may be a divisor of Nₛ.
Through the upper layer parameter resourceMapping-r17 in the SRS resource, the base station may configure as many as Nₛ=1, 2, 4, 8, 10, 12, 14 adjacent symbols in all symbol positions in the slot as the SRS time resource of the terminal. In addition, repetitionFactor-r17 may have one of the values 1, 2, 4, 5, 6, 7, 8, 10, 12, 14, and R may be a divisor of Nₛ.

The spatialRelationInfo configuration information of the above [Table 29] refers to one reference signal and applies the beam information of the reference signal to the beam used for the SRS transmission. For example, the configuration of spatialRelationInfo may include information such as [Table 30] below.

TABLE 30
SRS-SpatialRelationInfo ::= SEQUENCE {

| | | |
|---|---|---|
| servingCellId | ServCellindex | OPTIONAL, -- Need S |

| | |
|---|---|
| referenceSignal | CHOICE { |

| | |
|---|---|
| ssb-Index | SSB-Index, |
| csi-RS-Index | NZP-CSI-RS-ResourceId, |
| srs | SEQUENCE { |

| | |
|---|---|
| resourceId | SRS-ResourceId, |
| uplinkBWP | BWP-Id |

```
        }
    }
}
```

With reference to the above spatialRelationInfo configuration, the index of the reference signal to be referenced in order to use the beam information of a specific reference signal, that is, the SS/PBCH block index, the CSI-RS index, or the SRS index may be configured. The upper signaling referenceSignal is configuration information indicating which beam information of a reference signal is to be referenced for the corresponding SRS transmission, and ssb-Index means the index of the SS/PBCH block, csi-RS-Index means the index of the CSI-RS, and srs means the index of the SRS, respectively. If the value of the upper signaling referenceSignal is configured to ‘ssb-Index’, the terminal may apply the reception beam used when receiving the SS/PBCH block corresponding to ssb-Index as the transmission beam of the corresponding SRS transmission. If the value of the upper signaling referenceSignal is configured to ‘csi-RS-Index’, the terminal may apply the reception beam used when receiving the CSI-RS corresponding to csi-RS-Index as the transmission beam of the corresponding SRS transmission. If the value of the upper signaling referenceSignal is configured to ‘srs’, the terminal may apply the transmission beam used when transmitting the SRS corresponding to the srs as the transmission beam for the corresponding SRS transmission.

It has been explained that TCI state is used for beam indication of downlink channel (indication of reception spatial filter value/type of terminal) and SpatialRelationInfo is used for beam indication of uplink channel (indication of transmission spatial filter value/type of terminal). However, it should be noted that this does not imply a limitation according to the type of uplink and downlink, and that mutual expansion is possible in the future. For example, the conventional downlink TCI state (DL TCI state) may be extended to the uplink TCI state (UL TCI state) by adding an uplink channel or signal to the type of target RS that can refer to the TCI state, or adding an uplink channel or signal to the type of referenceSignal (reference RS) included in the TCI state or QCL-Info. As an example, the base station may notify the terminal of the information of the transmission beam of the SRS using the TCI state instead of spatialrelationinfo by configuring an upper layer signaling parameter such as srs-TCIState-r17 in [Table 29] described above. There are various extension methods such as DL-UL joint TCI state, but not all methods are described so as not to obscure the main point of the explanation.

An SRS may be composed of a CAZAC (Constant Amplitude Zero Auto Correlation) sequence. In addition, the CAZAC sequences constituting each SRS transmitted from multiple terminals have different cyclic shift values. In addition, the CAZAC sequences generated through the cyclic shift in one CAZAC sequence have a feature of having a zero correlation value with sequences having different cyclic shift values from themselves. By utilizing this feature, SRSs simultaneously allocated to the same frequency domain may be distinguished according to the CAZAC sequence cyclic shift value configured for each SRS by the base station.

SRSs of multiple terminals may be distinguished by frequency positions as well as cyclic shift values. Frequency positions may be distinguished by SRS subband unit allocation or Comb. 5G or NR systems may support Comb2, Comb4, and Comb8. In the case of Comb2, one SRS may be allocated only to even-numbered or odd-numbered subcarriers within an SRS subband. In this case, each of the even-numbered and odd-numbered subcarriers may constitute one Comb.

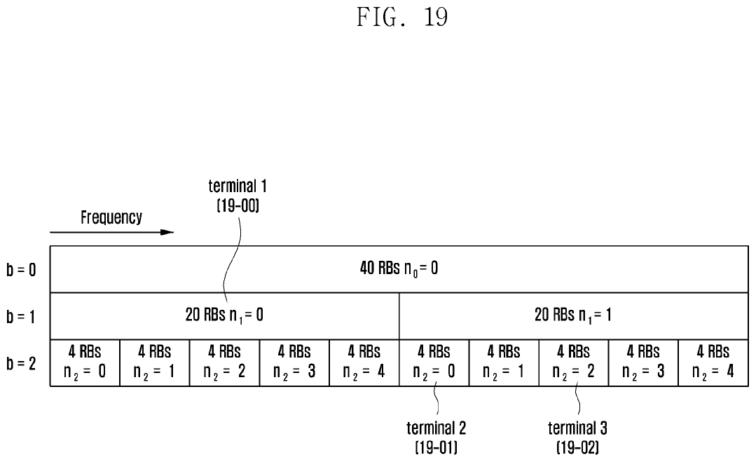

Each terminal may be assigned an SRS subband on the basis of a tree structure. And the terminal may perform hopping to the SRS assigned to each subband at each SRS transmission time. Accordingly, all transmission antennas of the terminal may transmit SRS using the entire uplink data transmission bandwidth. FIG. 19 is a diagram illustrating a structure in which SRS is allocated for each subband.

With reference to FIG. 19, an example is shown in which SRS is allocated to each terminal according to a tree structure configured by a base station when a data transmission band corresponding to 40 RB in frequency is provided.

In FIG. 19, when the level index of the tree structure is b, the top level (b=0) of the tree structure may be composed of one SRS subband with a 40 RB bandwidth. At the second level (b=1), two SRS subbands with a 20 RB bandwidth may be generated from the SRS subband of level b=0. Therefore, two SRS subbands may exist in the entire data transmission band of the second level (b=1). At the third level (b=2), five 4 RB SRS subbands are generated from one 20 RB SRS subband of the level immediately above (b=1), and a structure may be formed in which ten 4 RB SRS subbands exist within one level.

The configuration of this tree structure may have various levels, SRS subband sizes, and SRS subband numbers per level depending on the configurations of the base station. Here, the number of SRS subbands at level b generated from one SRS subband of a higher level may be defined as N_{b}, and the indices for these N_{b} SRS subbands may be defined as n_{b}={0, . . . , N_{b}−1}. As the subbands per level change in this way, terminals may be allocated to each subband per level, as illustrated in FIG. 19. For example, terminal 1 19-00 may be assigned to the first SRS subband n₁=0 among two SRS subbands having a 20 RB bandwidth at the b=1 level, and terminal 2 19-01 and terminal 3 19-02 may be assigned to the first SRS subband n₂=0 and the third SRS subband n₂=2 below the second 20 RB SRS subband, respectively. Through these processes, the terminal may simultaneously transmit SRS through multiple Component Carriers (CCs), and may simultaneously transmit SRS through multiple SRS subbands within one CC.

Specifically, for the SRS subband configurations described above, NR supports the SRS bandwidth configurations shown in [Table 31] below.

TABLE 31

| | B_{SRS} = 0 | | B_{SRS} = 1 | | B_{SRS} = 2 | | B_{SRS} = 3 | |
|---|---|---|---|---|---|---|---|---|
| C_{SRS} | m_{SRS,0} | N₀ | m_{SRS,1} | N₁ | m_{SRS,2} | N₂ | m_{SRS,3} | N₃ |
| 0 | 4 | 1 | 4 | 1 | 4 | 1 | 4 | 1 |
| 1 | 8 | 1 | 4 | 2 | 4 | 1 | 4 | 1 |
| 2 | 12 | 1 | 4 | 3 | 4 | 1 | 4 | 1 |
| 3 | 16 | 1 | 4 | 4 | 4 | 1 | 4 | 1 |
| 4 | 16 | 1 | 8 | 2 | 4 | 2 | 4 | 1 |
| 5 | 20 | 1 | 4 | 5 | 4 | 1 | 4 | 1 |
| 6 | 24 | 1 | 4 | 6 | 4 | 1 | 4 | 1 |
| 7 | 24 | 1 | 12 | 2 | 4 | 3 | 4 | 1 |
| 8 | 28 | 1 | 4 | 7 | 4 | 1 | 4 | 1 |
| 9 | 32 | 1 | 16 | 2 | 8 | 2 | 4 | 2 |
| 10 | 36 | 1 | 12 | 3 | 4 | 3 | 4 | 1 |
| 11 | 40 | 1 | 20 | 2 | 4 | 5 | 4 | 1 |
| 12 | 48 | 1 | 16 | 3 | 8 | 2 | 4 | 2 |
| 13 | 48 | 1 | 24 | 2 | 12 | 2 | 4 | 3 |
| 14 | 52 | 1 | 4 | 13 | 4 | 1 | 4 | 1 |
| 15 | 56 | 1 | 28 | 2 | 4 | 7 | 4 | 1 |
| 16 | 60 | 1 | 20 | 3 | 4 | 5 | 4 | 1 |
| 17 | 64 | 1 | 32 | 2 | 16 | 2 | 4. | 4 |
| 18 | 72 | 1 | 24 | 3 | 12 | 2 | 4 | 3 |
| 19 | 72 | 1 | 36 | 2 | 12 | 3 | 4 | 3 |
| 20 | 76 | 1 | 4 | 19 | 4 | 1 | 4 | 1 |
| 21 | 80 | 1 | 40 | 2 | 20 | 2 | 4 | 5 |
| 22 | 88 | 1 | 44 | 2 | 4 | 11 | 4 | 1 |
| 23 | 96 | 1 | 32 | 3 | 16 | 2 | 4 | 4 |
| 24 | 96 | 1 | 48 | 2 | 24 | 2 | 4 | 6 |
| 25 | 104 | 1 | 52 | 2 | 4 | 13 | 4 | 1 |
| 26 | 112 | 1 | 56 | 2 | 28 | 2 | 4 | 7 |
| 27 | 120 | 1 | 60 | 2 | 20 | 3 | 4 | 5 |
| 28 | 120 | 1 | 40 | 3 | 8 | 5 | 4 | 2 |
| 29 | 120 | 1 | 24 | 5 | 12 | 2 | 4 | 3 |
| 30 | 128 | 1 | 64 | 2 | 32 | 2 | 4 | 8 |
| 31 | 128 | 1 | 64 | 2 | 16 | 4 | 4 | 4 |
| 32 | 128 | 1 | 16 | 8 | 8 | 2 | 4 | 2 |
| 33 | 132 | 1 | 44 | 3 | 4 | 11 | 4 | 1 |
| 34 | 136 | 1 | 68 | 2 | 4 | 17 | 4 | 1 |
| 35 | 144 | 1 | 72 | 2 | 36 | 2 | 4 | 9 |
| 36 | 144 | 1 | 48 | 3 | 24 | 2 | 12 | 2 |
| 37 | 144 | 1 | 48 | 3 | 16 | 3 | 4 | 4 |
| 38 | 144 | 1 | 16 | 9 | 8 | 2 | 4 | 2 |
| 39 | 152 | 1 | 76 | 2 | 4 | 19 | 4 | 1 |
| 40 | 160 | 1 | 80 | 2 | 40 | 2 | 4 | 10 |
| 41 | 160 | 1 | 80 | 2 | 20 | 4 | 4 | 5 |
| 42 | 160 | 1 | 32 | 5 | 16 | 2 | 4 | 4 |
| 43 | 168 | 1 | 84 | 2 | 28 | 3 | 4 | 7 |
| 44 | 176 | 1 | 88 | 2 | 44 | 2 | 4 | 11 |
| 45 | 184 | 1 | 92 | 2 | 4 | 23 | 4 | 1 |
| 46 | 192 | 1 | 96 | 2 | 48 | 2 | 4 | 12 |
| 47 | 192 | 1 | 96 | 2 | 24 | 4 | 4 | 6 |
| 48 | 192 | 1 | 64 | 3 | 16 | 4 | 4 | 4 |
| 49 | 192 | 1 | 24 | 8 | 8 | 3 | 4 | 2 |
| 50 | 208 | 1 | 104 | 2 | 52 | 2 | 4 | 13 |
| 51 | 216 | 1 | 108 | 2 | 36 | 3 | 4 | 9 |
| 52 | 224 | 1 | 112 | 2 | 56 | 2 | 4 | 14 |
| 53 | 240 | 1 | 120 | 2 | 60 | 2 | 4 | 15 |
| 54 | 240 | 1 | 80 | 3 | 20 | 4 | 4 | 5 |
| 55 | 240 | 1. | 48 | 5 | 16 | 3 | 8 | 2 |
| 56 | 240 | 1 | 24 | 10 | 12 | 2 | 4 | 3 |
| 57 | 256 | 1 | 128 | 2 | 64 | 2 | 4 | 16 |
| 58 | 256 | 1 | 128 | 2 | 32 | 4 | 4 | 8 |
| 59 | 256 | 1 | 16 | 16 | 8 | 2 | 4 | 2 |
| 60 | 264 | 1 | 132 | 2 | 44 | 3 | 4 | 11 |
| 61 | 272 | 1 | 136 | 2 | 68 | 2 | 4 | 17 |
| 62 | 272 | 1 | 68 | 4 | 4 | 17 | 4 | 1 |
| 63 | 272 | 1 | 16 | 17 | 8 | 2 | 4 | 2 |

In addition, NR supports SRS frequency hopping on the basis of the values in Table 31 above, and the detailed procedure follows Table 32 below.

```
TABLE 32
  When SRS is transmitted on a given SRS resource, the sequence
r^{(p}^{ᵢ}⁾(n, l′) for each OFDM symbol l′ and for each of the antenna ports of the
SRS resource shall be multiplied with the amplitude scaling factor β_{SRS} in
order to conform to the transmit power specified in [5, 38.213] and mapped
in sequence starting with r^{(p}^{ᵢ}⁾(0, l′) to resource elements (k, l) in a slot for
each of the antenna ports Pᵣ according to
  ${a}_{{K}_{TC} {k}^{′} + {k}_{0}^{( {p}_{i} )} {l}^{′} + {l}_{0}}^{( {p}_{i} )} = \{ \begin{matrix}\frac{1}{\sqrt{{N}_{ap}}} {β}_{SRS} {r}^{( {p}_{i} )} ( {k}^{′} , {l}^{′} ) & {k}^{′} = 0 , 1 , … , {M}_{sc , b}^{SRS} - 1 {l}^{′} = 0 , 1 , … , {N}_{symb}^{SRS} - 1 \\ 0 & otherwise\end{matrix}$
  The length of the sounding reference signal sequence is given by
      ${M}_{sc , b}^{SRS} = {m}_{SRS , b} {N}_{sc}^{RB} / {K}_{TC}$
  where m_{SRS,b} is given by a selected row of Table 6.4.1,4.3-1 with b = B_{SRS} where B_{SRS} ∈ {0, 1, 2, 3}
is given by the field b-SRS contained in the higher-layer parameter freqHopping. The row of the table
is selected according to the index C_{SRS} ∈ {0, 1, . . . , 63} given by the field c-SRS contained in
the higher-layer parameter freqHopping.
  $The frequency - domain starting position {k}_{0}^{( {p}_{i} )} is defined by {k}_{0}^{( {p}_{i} )} = {\overline{k}}_{0}^{( {p}_{i} )} + {{\sum }^{{B}_{SRS}}}_{b = 0} {K}_{TC} {M}_{sc , b}^{SRS} {n}_{b}$
  where
  ${\overline{k}}_{0}^{( {p}_{i} )} = {n}_{shift} {N}_{sc}^{RB} + {k}_{TC}^{( {p}_{i} )}$
  ${k}_{TC}^{( {p}_{i} )} = \{ \begin{matrix}( {\overline{k}}_{TC} + {K}_{TC} / 2 ) mod {K}_{TC} & if {n}_{SRS}^{cs} ∈ \{ {n}_{SRS}^{cs , max} / 2 , … , {n}_{SRS}^{cs , max} - 1 \} and {N}_{ap}^{SRS} = 4 \\ {\overline{k}}_{TC} & otherwise\end{matrix} and {p}_{i} ϵ \{ 1001 , 1003 \}$
  $If {N}_{BWP}^{start} \leq {n}_{shift} the reference point for {k}_{0}^{( {p}_{i} )} = 0 is subcarrier 0 in$
common resource block 0, otherwise the reference point is the lowest subcarrier of the BWP.
  The frequency domain shift value n_{shift} adjusts the SRS allocation with respect to the reference point grid
and is contained in the higher-layer parameter freqDomainShift in the SRS-Config IE. The transmission
comb offset k̅_{TC} ∈ {0, 1, . . . , K_{TC} − 1} is contained in the higher-layer parameter transmissionComb
in the SRS-Config IE and n_{b} is a frequency position index.
  Frequency hopping of the sounding reference signal is configured by the parameter bₕₒₚ ∈ {0, 1, 2, 3} ,
given by the field b-hop contained in the higher-layer parameter freqHopping.
  If bₕₒₚ ≥ B_{SRS}, frequency hopping is disabled and the frequency position index n_{b} remains
constant (unless re-configured) and is defined by
  ${n}_{b} = ⌊ 4 {n}_{RRC} / {m}_{SRS , b} ⌋ mod {N}_{b}$
  $for all {N}_{symb}^{SRS} OFDM symbols of the SRS resource . The quantity {n}_{RRC} is$
given by the higher-layer parameter freqDomainPosition and the values of m_{SRS,b} and
N_{b} for b = B_{SRS} are given by the selected row of Table 6.4.1.4.3-1
corresponding to the configured value of C_{SRS}.
  If bₕₒₚ < B_{SRS}, frequency hopping is enabled and the frequency position indices n_{b} are defined by
  ${n}_{b} = \{ \begin{matrix}⌊ 4 {n}_{RRC} / {m}_{SRSb} ⌋ mod {N}_{b} & b \leq {b}_{hop} \\ \{ {F}_{b} ( {n}_{SRS} ) + ⌊ 4 {n}_{RRC} / {m}_{SRSb} ⌋ \} mod {N}_{b} & otherwise\end{matrix}$
  where n_{b} is given by Table 6.4.1.4.3-1,
  ${F}_{b} ( {n}_{SRS} ) = \{ \begin{matrix}( {N}_{b} / 2 ) ⌊ \frac{{n}_{SRS} mod {\prod }_{{b}^{′} = {b}_{hop}}^{b} {N}_{{b}^{′}}}{{\prod }_{{b}^{′} = {b}_{hop}}^{b - 1} {N}_{{b}^{′}}} ⌋ + ⌊ \frac{{n}_{SRS} mod {\prod }_{{b}^{′} = {b}_{hop}}^{b} {N}_{{b}^{′}}}{2 {\prod }_{{b}^{′} = {b}_{hop}}^{b - 1} {N}_{{b}^{′}}} ⌋ & if {N}_{b} even \\ ⌊ {N}_{b} / 2 ⌋ ⌊ {n}_{SRS} / {\prod }_{{b}^{′} = {b}_{hop}}^{b - 1} {N}_{{b}^{′}} ⌋ & if {N}_{n} odd\end{matrix}$
  and where N_{b}_{ₕₒₚ} = 1 regardless of the value of N_{b}. The quantity n_{SRS} counts the number of SRS
transmissions. For the case of an SRS resource configured as aperiodic by the higher-layer parameter
resourceType, it is
$given by {n}_{SRS} = ⌊ {l}^{′} / R ⌋ within the slot in which the {N}_{symb}^{SRS} symbol SRS resource is$
$transmitted . The quantity R \leq {N}_{symb}^{SRS} is the repetition factor given by the$
field repetitionFactor contained in the higher-layer parameter resourceMapping.
```

As mentioned above, 5G or NR terminals support SU-MIMO (Single User) technique and have up to 4 transmission antennas. In addition, NR terminals may simultaneously transmit SRSs to multiple CCs or multiple SRS subbands within a CC. Unlike LTE system, 5G or NR system supports various numerologies, SRS transmission symbols may be configured in multiple ways, and repeated transmission for SRS transmission through repetition factor may also be allowed.

Therefore, it is necessary to count SRS transmissions considering this. Counting SRS transmissions may be utilized in various ways. For example, counting SRS transmissions may be utilized to support antenna switching according to SRS transmissions. Specifically, which SRS corresponding to which antenna is transmitted in which band at which SRS transmission time may be determined by counting SRS transmissions.

The terminal does not expect that SRS resources within the same SRS resource set are configured with different time domain operations. Also, the terminal does not expect that SRS resource sets associated with an SRS resource are configured with different time domain operations. The SRS request fields included in DCI formats 0_1, 1_1, 0_2 (when an SRS request field exists) and 1_2 (when an SRS request field exists) indicate a triggered SRS resource set as shown in [Table 33] below. If the upper layer parameter srs-TPC-PDCCH-Group for the terminal is configured to ‘typeB’, the 2-bit SRS request field included in DCI format 2_3 indicates a triggered SRS resource set. Or, if the upper layer parameter srs-TPC-PDCCH-Group for the terminal is configured to ‘typeA’, the 2-bit SRS request field included in DCI format 2_3 indicates SRS transmission for a set of support cells configured by the upper layer.

TABLE 33

| Value | Triggered aperiodic SRS resource set(s) for DCI | Triggered aperiodic SRS resource set(s) for |
|---|---|---|
| of SRS | format 0_1, 0_2, 1_1, 1_2, and 2_3 configured | DCI format 2_3 configured with higher layer |
| request | with higher layer parameter | parameter srs-TPC-PDCCH-Group set to |
| field | srs-TPC-PDCCH-Group set to 'typeB' | 'typeA* |
| 00 | No aperiodic SRS resource set triggered | No aperiodic SRS resource set triggered |
| 01 | SRS resource set(s) configured by SRS-ResourceSet | SRS resource set(s) configured with higher layer |
| | with higher layer parameter | parameter usage in SRS-ResourceSet set to |
| | aperiodicSRS-ResourceTrigger set to I or an entry | 'antennaSwitching' and resourceType in |
| | in aperiodicSRS-ResourceTriggerList set to 1 | SRS-ResourceSet set to 'aperiodic' for a 1st |
| | SRS resource set(s) configured by | set of serving cells configured by higher layers |
| | SRS-PosResourceSet with an entry in | |
| | aperiodicSRS-ResourceTriggerList set to 1 when | |
| | triggered by DCI formats 0_1, 0_2, 1_1, and 1_2 | |
| 10 | SRS resource set(s) configured by SRS-ResourceSet | SRS resource set(s) configured with higher layer |
| | with higher layer parameter | parameter usage in SRS-ResourceSet set to |
| | aperiodicSRS-ResourceTrigger set to 2 or an entry | 'antennaSwitching' and resourceType in |
| | in aperiodic SRS-ResourceTriggerList set to 2 | SRS-ResourceSet set to 'aperiodic' for a 2nd |
| | SRS resource set(s) configured by | set of serving cells configured by higher layers |
| | SRS-PosResourceSet with an entry in | |
| | aperiodicSRS-ResourceTriggerList set to 2 when | |
| | triggered by DCI formats 0_1, 0_2, 1_1, and 1_2 | |
| 11 | SRS resource set(s) configured by SRS-ResourceSet | SRS resource set(s) configured with higher layer |
| | with higher layer parameter | parameter usage in SRS-ResourceSet set to |
| | aperiodicSRS-ResourceTrigger set to 3 or an entry | 'antennaSwitching' and resourceType in |
| | in aperiodicSRS-ResourceTriggerList set to 3 | SRS-ResourceSet set to 'aperiodic' for a 3rd |
| | SRS resource set(s) configured by | set of serving cells configured by higher layers |
| | SRS-PosResourceSet with an entry in | |
| | aperiodicSRS-ResourceTriggerList set to 3 when | |
| | triggered by DCI formats 0_1, 0_2, 1_1, and 1_2 | |

For PUCCH and SRS scheduled on the same carrier, when a semi-persistent SRS and a periodic SRS are configured to the same symbol as a PUCCH including only a CSI report, only a L1-RSRP report, or only a L1-SINR report, the terminal does not transmit SRS. When a semi-persistent SRS or a periodic SRS is configured to the same symbol as a PUCCH including HARQ-ACK, link restoration request, and/or SR, or an aperiodic SRS is triggered to be transmitted in the same symbol as a PUCCH including the above information, the terminal does not transmit SRS. If an SRS could not be transmitted while overlapping with a PUCCH, only the SRS symbol(s) overlapping with the PUCCH are dropped. When an aperiodic SRS is triggered to be overlapped with a PUCCH including only a semi-persistent/periodic CSI report, or only a semi-persistent/periodic L1-RSRP report, or only a L1-SINR report, the PUCCH is not transmitted.

For band-band combinations that do not allow simultaneous transmission of SRS and PUCCH/PUSCH for intra-band or inter-band carrier aggregation, the terminal does not expect that PUSCH/UL DM-RS/UL PT-RS/PUCCH formats will be configured from a carrier different from the carrier on which SRS is configured in the same symbol.

For band-band combinations that do not allow simultaneous transmission of SRS and PRACH for intra-band or inter-band carrier aggregation, simultaneous transmission of SRS from one carrier and PRACH from another carrier is not permitted.

When an SRS resource with the upper layer parameter resourceType configured to ‘aperiodic’ is triggered on OFDM symbol(s) for periodic/semi-persistent SRS transmission, the terminal transmits an aperiodic SRS resource, the periodic/semi-persistent SRS symbol(s) overlapping with the symbol(s) are dropped, and the non-overlapping periodic/semi-persistent SRS symbol(s) are transmitted. When an SRS resource with the upper layer parameter resourceType configured to ‘semi-persistent’ is triggered on OFDM symbol(s) for periodic SRS transmission, the terminal transmits a semi-persistent SRS resource, the periodic SRS symbol(s) during the overlapped symbol are dropped, and the non-overlapping periodic SRS symbol(s) are transmitted.

When a terminal has the upper layer parameter usage in the SRS-ResourceSet configured to ‘antennaSwitcing’ and the guard period of the Y symbol is configured, the terminal follows the same priority rules defined above as if the SRS was configured during the guard period.

When activating or updating the upper layer parameter spatialRelationInfo of a semi-persistent or aperiodic SRS resource with MAC CE for the CC/bandwidth parts indicated by a set of upper layer parameters applicableCellList, the spatialRelationInfo is applied to the semi-persistent or aperiodic SRS resource(s) having the same SRS resource ID for all bandwidth parts within the indicated CCs.

When the upper layer parameter enableDefaultBeamPlForSRS is configured to ‘enable’, the upper layer parameter spatialRelationInfo for SRS resource is not configured in FR2 except that the upper layer parameter usage of SRS resource is configured to ‘beamManagement’ or configured to ‘nonCodebook’ together with the associatedCSI-RS configuration, and the upper layer parameter pathlossReferenceRS for the terminal is not configured, the terminal transmits the target SRS resource according to the configurations below.
It transmits the target SRS resource with the same spatial domain transmission filter as the one received by the CORESET with the lowest controlResoureSetID in the activated DL bandwidth part within the CC.
If the terminal has not configure any CORESET in the CC, it transmits the target SRS resource with the same spatial domain transmission filter that received the activated TCI state with the lowest ID applicable to the PDSCH in the activated DL bandwidth part of the CC.

Table 34 indicates the UE capabilities containing resource-related information of the uplink reference signal for positioning.

TABLE 34

| Index | Feature group | Components |
|---|---|---|
| 13-8 | SRS Resources | 1. Max number of SRS Resource Sets for positioning supported by UE per BWP. |
| | for Positioning | Values = {1, 2, 4, 8, 12, 16}. |
| | | 2. Max number of P/SP/AP SRS Resources for positioning per BWP. |
| | | Values = {1, 2, 4, 8, 16, 32, 64} |
| | | 3. Max number of P/SP/AP SRS Resources including the SRS |
| | | resources for positioning per BWP per slot. |
| | | Values = {1, 2, 3, 4, 5, 6, 8, 10, 12, 14} |
| | | Note: |
| | | Max number of P/SP/AP SRS Resources in Component 3 include |
| | | both SRS resources configured by SRS-Resource and SRS resources |
| | | configured by SRS-PosResource-r16 supported by UE |
| | | 4. Max number of periodic SRS Resources for positioning per BWP. |
| | | Values = {1, 2, 4, 8, 16, 32, 64} |
| | | 5. Max number of periodic SRS Resources for positioning per BWP per slot. |
| | | Values = {1, 2, 3, 4, 5, 6, 8, 10, 12, 14} |
| | | OLPC for SRS for positioning based on SSB from serving cell is part of FG13-8 |
| | | Note: |
| | | no dedicated capability signaling is intended for this component |

A terminal that reports the UE capability of Table 34 above (hereinafter expressed as FG 13-8) may transmit an uplink reference signal at any OFDM symbol position within any slot when transmitting an uplink reference signal.

Table 35 indicates the UE capability containing information on the position of transmission symbols within a slot of an uplink reference signal in an unlicensed band.

TABLE 35

| Index | Feature group | Components |
|---|---|---|
| 10-11 | SRS starting position at any | 1. Support transmitting |
| | OFDM symbol in a slot | SRS starting in all symbols |
| | | (0, . . . , 13) of a slot |

A terminal reporting the UE capability of Table 35 above (hereinafter referred to as FG 10-11) may transmit an uplink reference signal at any OFDM symbol position within any slot in both an unlicensed band and a licensed band when transmitting an uplink reference signal.

Hereinafter, embodiments of the present disclosure will be described in detail with reference to the attached drawings. The contents of the present disclosure may be applied to FDD and TDD systems. In the present disclosure below, upper signaling (or upper layer signaling) refers to a signal transmission method in which a base station transmits a signal to a terminal using a downlink data channel of a physical layer, or a terminal transmits a signal to a base station using an uplink data channel of a physical layer, and may also be referred to as RRC signaling, PDCP signaling, or medium access control (MAC) control element (MAC control element; MAC CE).

In the present disclosure below, when determining whether cooperative communication is applied, the terminal may use various methods, such as having a specific format for the PDCCH(s) that allocate the PDSCH to which cooperative communication is applied, or including a specific indicator that indicates whether cooperative communication is applied, or having scrambled a specific RNTI for the PDCCH(s) that allocate the PDSCH to which cooperative communication is applied, or assuming the application of cooperative communication in a specific section indicated by a higher layer. For the convenience of the following description, a case in which the terminal receives a PDSCH to which cooperative communication is applied on the basis of similar conditions as above will be referred to as an NC-JT case.

In the present disclosure below, determining the priority between A and B may be referred to in various ways, such as selecting a higher priority according to a predetermined priority rule and performing an action corresponding to it, or omitting or dropping an action for a lower priority.

In the following disclosure, the above examples are described through a number of embodiments, but they are not independent, and one or more embodiments may be applied simultaneously or in combination.

In the description of the present disclosure below, for convenience, cells, transmission points, panels, beams, and/or transmission directions, which may be distinguished through upper layer/L1 parameters such as TCI state or spatial relation information, or indicators such as cell ID, TRP ID, and panel ID, may be uniformly described as TRP (transmission reception point), beam, or TCI state. Therefore, in actual application, TRP, beam, or TCI state may be appropriately replaced with one of the above terms.

In the present disclosure below, when determining whether cooperative communication is applied, the terminal may use various methods, such as having a specific format for the PDCCH(s) that allocate the PDSCH to which cooperative communication is applied, or including a specific indicator that indicates whether cooperative communication is applied, or having scrambled a specific RNTI for the PDCCH(s) that allocate the PDSCH to which cooperative communication is applied, or assuming the application of cooperative communication in a specific section indicated by a higher layer. For the convenience of the following description, a case in which the terminal receives a PDSCH to which cooperative communication is applied on the basis of similar conditions as above will be referred to as an NC-JT case.

Hereinafter, embodiments of the present disclosure will be described in detail with reference to the attached drawings. Hereinafter, a base station is a subject that performs resource allocation of a terminal, and may be at least one of a gNode B, a gNB, an eNode B, a Node B, a Base Station (BS), a wireless access unit, a base station controller, or a node on a network. The terminal may include a User Equipment (UE), an Mobile Station (MS), a cellular phone, a smartphone, a computer, or a multimedia system capable of performing a communication function. Hereinafter, embodiments of the present disclosure will be described using a 5G system as an example, but embodiments of the present disclosure may be applied to other communication systems having similar technical backgrounds or channel types. For example, LTE or LTE-A mobile communication and mobile communication technologies developed after 5G may be included here. Therefore, embodiments of the present disclosure may be applied to other communication systems with some modifications without significantly departing from the scope of the present disclosure as judged by a person skilled in the art. The contents of the present disclosure may be applied to FDD and TDD systems.

In addition, when describing the present disclosure, if it is judged that a specific description of a related function or configuration may unnecessarily obscure the gist of the present disclosure, the detailed description will be omitted. In addition, the terms described below are terms defined in consideration of the functions in the present disclosure, and these may vary depending on the intention or custom of the user or operator. Therefore, the definitions should be made on the basis of the contents throughout this specification.

In describing the present disclosure below, upper layer signaling may be signaling corresponding to at least one or a combination of one or more of the following signaling.
Master Information Block (MIB)
System Information Block (SIB) or SIB X (X=1, 2, . . . )
Radio Resource Control (RRC)
Medium Access Control (MAC) Control Element (CE)

In addition, L1 signaling may be a signaling corresponding to at least one or a combination of one or more of the following physical layer channels or signaling methods.
Physical Downlink Control Channel (PDCCH)
Downlink Control Information (DCI)
UE-specific DCI
Group common DCI
Common DCI
Scheduling DCI (e.g. DCI used for scheduling downlink or uplink data)
Non-scheduled DCI (e.g. DCI not intended for scheduling downlink or uplink data)
Physical Uplink Control Channel (PUCCH)
Uplink Control Information (UCI)

In the present disclosure below, determining the priority between A and B may be referred to in various ways, such as selecting a higher priority according to a predetermined priority rule and performing an action corresponding to it, or omitting or dropping an action for a lower priority.

The term “slot” used in the present disclosure below is a general term that may refer to a specific time unit corresponding to a TTI (Transmit Time Interval), and specifically may mean a slot used in a 5G NR system, or a slot or subframe used in a 4G LTE system.

In the following disclosure, the above examples are described through a number of embodiments, but they are not independent, and one or more embodiments may be applied simultaneously or in combination.

### First Embodiment: SRS Resource Configuration and Instruction Method

As one embodiment of the present disclosure, a method for configuring and indicating an SRS resource is described. As described above, a conventional SRS resource supports up to 4 ports, and may perform transmission for all ports for each symbol for positions of all SRS resource transmission symbols determined on the basis of upper layer signaling. For example, if a terminal receives a 4-port SRS resource, in which the number of transmission symbols is 4, from a base station through upper layer signaling, the terminal may perform transmission for 4 ports for each symbol.

In the future, advanced releases of NR are expected to support improved specifications by considering up to 8 antenna ports of the terminal. The relevant functions are currently being discussed in NR release 18, and in future releases or even in the 6th generation mobile communication system, there is a possibility that the terminal side may consider more than 8 antenna ports. However, if SRS transmits on all the ports configured for each symbol transmitted, as is currently supported, the increased number of ports will reduce the transmission power for each port when transmitting SRS, which may limit base station reception performance in cases where coverage may be poor, such as terminals on cell boundaries. Therefore, the base station and the terminal may consider various methods for transmitting SRS with N antenna ports, which is an arbitrary number greater than 4, on the terminal side, as follows.

### [Method 1-1] Method 1 for Using a Single SRS Resource

In order to transmit an SRS having N antenna ports, a terminal may be configured with a single SRS resource from a base station. The base station may configure a single SRS resource having N antenna ports for the terminal, and at this time, the N antenna ports may be mapped to each symbol and transmitted when transmitting a single or multiple symbols of the corresponding SRS resource. For example, if the terminal transmits an SRS resource having N antenna ports where Nₛ is configured to 4, all N antenna ports may be transmitted for each symbol.

Method 1-1 may use the definitions of various time and frequency resource allocation related parameters in [Table 29] as they are because the current standard support for 1, 2, and 4 antenna ports is all on the basis of a single SRS resource, and thus Method 1-1 may be a natural extension when the number of antenna ports of a terminal increases. However, since the terminal transmits all antenna ports in one symbol on the basis of Method 1-1, there may be a problem that the transmission power for each antenna port in one symbol is reduced.

### [Method 1-2] Method 2 for Using a Single SRS Resource

In order to transmit an SRS having N antenna ports, a terminal may be configured with a single SRS resource from a base station. The base station may configure a single SRS resource having N antenna ports for the terminal, and when transmitting one or more symbols configured in the corresponding SRS resource, the number of antenna ports mapped and transmitted for each symbol may be less than or equal to N, and the number of symbols required to transmit all N antenna ports may be greater than or equal to 1.

Since Method 1-2 transmits some of the N antenna ports for each symbol, the transmission power of the antenna port for each symbol may be increased compared to Method 1-1 that transmits all N antenna ports for each symbol. However, since the definition of antenna port transmission in Method 1-2 is different from the definition of the existing standard that all antenna ports configured for a specific SRS resource are transmitted for each symbol, some of the definitions of various time and frequency resource allocation-related parameters in the above-mentioned [Table 29] may need to be changed or newly defined.

### [Method 1-3] Method for Using Multiple SRS Resources

In order to transmit an SRS having N antenna ports, a terminal may be configured with multiple SRS resources from a base station. In order to support SRS transmission corresponding to the N antenna ports from the terminal, the base station may configure M (M>1) SRS resources having antenna ports with a value less than or equal to N to the terminal, and at this time, antenna ports with a number less than or equal to N configured in each SRS resource may all be mapped and transmitted in each symbol when transmitting a single or multiple symbols of the corresponding SRS resource. For example, if the terminal is configured with two SRS resources each having four antenna ports for SRS transmission of eight antenna ports and Nₛ is configured to 4 for both resources, all four antenna ports may be transmitted for each symbol for the two SRS resources. In this case, the multiple SRS resources may be included in the same SRS resource set or may be included in different SRS resource sets, respectively. The number N of antenna ports that may be expressed by multiple SRS resources may be the number of antenna ports greater than 4, such as 6, 8, 12, or 16, and may be expressed by SRS resources having 1, 2, or 4 antenna ports. The terminal may expect that all SRS resources included in each SRS resource group, which may be configured by the base station or determined by the above-described predetermined rule, have the same number of antenna ports. In addition, the case where they have different numbers of antenna ports may not be excluded. For example, if 2 SRS resources are configured to express N=8 antenna ports, each SRS resource may have 4 antenna ports.

Method 1-3, unlike the method on the basis of a single SRS resource supported by the current specification, enables transmission to N antenna ports through multiple SRS resources, so some of the definitions of various time and frequency resource allocation-related parameters in [Table 29] described above may need to be changed or newly defined. However, similar to Method 1-2, since the number of antenna ports transmitted for each symbol of each SRS resource is less than or equal to N, which is the total number of antenna ports, the power transmitted for each port may increase.

### [Method 1-4] Method for Selecting One of the Above-Described [Method 1-1] to [Method 1-3]

The terminal may be instructed by the base station, either statically or dynamically, to use one of the above-described [Methods 1-1] to [Methods 1-3] to transmit an SRS having N antenna ports. For example, the terminal may use one of the above-described [Methods 1-1] to [Methods 1-3] by receiving it as a higher layer signaling from the base station, or may be instructed dynamically through L1 signaling. One of the two methods, such as one of [Methods 1-1] and [Methods 1-2], one of [Methods 1-1] and [Methods 1-3], or one of [Methods 1-2] and [Methods 1-3], may be used by receiving it as a higher layer signaling from the base station, or may be instructed dynamically through L1 signaling. If the terminal is located inside the cell and the coverage is sufficient, the base station may configure SRS transmission for N antenna ports to the terminal on the basis of [Method 1-1] through upper layer signaling or dynamically instruct through L1 signaling. For example, the method of dynamically instructing through L1 signaling may be instructed through a new field in the DCI format or by using a reserved codepoint of an existing DCI field. As an example, the SRS request field may be used.

The terminal may report to the base station as a UE capability whether it supports at least one combination of [Method 1-1] to [Method 1-4] described above. The UE capability report may be reported differently according to a frequency range (FR), and may be reported by band, by band combination, by feature set, or by feature set per CC. In addition, the UE capabilities described above may be independent UE capabilities, or support for each method may be defined as multiple components within a single UE capability.

If the terminal supports at least one combination of [Method 1-1] to [Method 1-4] described above, usage, which is an upper layer signaling of the SRS resource set, may enable codebook and antenna switching. In addition, cases where usage is non-codebook and beam management may not be excluded.

If the terminal has multiple SRS resources configured in the same SRS resource set according to the above-described [Method 1-3], the maximum number of SRS resources in the SRS resource set that the terminal may be configured to through upper layer signaling may be 4 or more. If the terminal has multiple SRS resources configured in different SRS resource sets, the terminal may be configured to 2 or more SRS resource sets whose usage is codebook through upper layer signaling.

Since the terminal uses multiple SRS resources for SRS transmission with N antenna ports when following the above-described [Method 1-3], the definition of codepoints in the SRS resource indicator (SRI) in DCI format 0_1, 0_2 transmitted from the base station for scheduling of codebook-based PUSCH transmission may need to be changed. Currently, whereas each codepoint of the SRI indicates a single SRS resource, if the terminal is configured to use the above-described [Method 1-3] from the base station, the definition of codepoints in the SRI field may be changed according to the following methods.

### [Method 1-3-1] SRS Resource Group Instruction

The terminal may assume that each codepoint of the SRI field in the DCI format 0_1 and 0_2 indicated from the base station indicates a group of SRS resources including multiple SRS resources. For example, if there are two codepoints of SRI, the first codepoint may indicate SRS resource group 0, and the second codepoint may indicate SRS resource group 1. In this case, SRS resource group 0 may include SRS resources 0 and 1, and SRS resource group 1 may include SRS resources 2 and 3. The terminal may be configured as an upper layer from the base station for such SRS resource groups. In addition, when multiple SRS resources are configured in the same SRS resource configured from the base station, the terminal may determine a specific number from a low SRS resource index in the SRS resource set as one group, and the total number of antenna ports expressed through the multiple SRS resources may be configured for each SRS resource set. For example, if the number of antenna ports in an SRS resource set is configured to 8, the total number of SRS resources is configured to 4, and the index of each SRS resource is 0 to 3, SRS resource indexes 0 and 1 may be the first SRS resource group, and SRS resource indexes 2 and 3 may be the second SRS resource group. In this case, the first codepoint of the SRI field may correspond to the first SRS resource group, and the second codepoint may correspond to the second SRS resource group.

### [Method 1-3-2] Combination Instructions for Multiple SRS Resources Similar to Noncodebook

The terminal may assume that each codepoint of the SRI field in the DCI formats 0_1 and 0_2 indicated by the base station represents a combination of single or multiple SRS resources. This may be similar to the meaning of the SRI field in the DCI formats 0_1 and 0_2 for scheduling noncodebook-based PUSCH transmission. If four SRS resources are configured in the SRS resource set in which usage is configured to noncodebook, each codepoint of the SRI field in the DCI formats 0_1 and 0_2 for scheduling noncodebook-based PUSCH transmission may require a total of 2⁴−1=15 codepoints, expressing all methods for selecting one to four of the four SRS resources. Similar to the noncodebook method that considers all methods for selecting a subset from all the configured SRS resources, method 1-3-2 may use a method including some or all of the noncodebook method. For example, assuming that the total number of configured SRS resources is M, if it is assumed that all M SRS resources have the same number of antenna ports, only combinations of a specific number of SRS resources among the M SRS resources may be considered. For example, only a method of selecting two SRS resources among the M SRS resources may be considered. If it is assumed that the M SRS resources may have different numbers of antenna ports, it is possible to generate a case where each combination of SRS resources has the same total number of antenna ports by considering combinations of a specific number or another specific number of SRS resources among the M SRS resources. For example, if four SRS resources each having two antenna ports and two SRS resources each having four antenna ports are configured in one SRS resource set, and a total of eight antenna ports are to be expressed using multiple SRS resources, a combination of two SRS resources each having four antenna ports may be used, or a combination of one SRS resource each having four antenna ports and two SRS resources each having two antenna ports may be used.

### [Method 1-3-3] One SRS Resource Indication and Implicit Indication for Other SRS Resources Linked to the Indicated SRS Resource

The terminal may assume that each codepoint of the SRI field in the DCI format 0_1 and 0_2 indicated by the base station represents a single SRS resource, and the single SRS resource indicated by each codepoint may be connected with multiple other SRS resources. The connection may be established through upper layer signaling. The base station and the terminal may indicate one SRS resource to the terminal while simultaneously indicating multiple SRS resources connected to the SRS resource through upper layer signaling without changing the definition of each codepoint of the SRI field.

The terminal may report to the base station as a UE capability whether it supports at least one combination of [Method 1-3-1] to [Method 1-3-3] described above. The UE capability report may be reported differently according to a frequency range (FR), and may be reported by band, by band combination, by feature set, or by feature set per CC. In addition, the UE capabilities described above may be independent UE capabilities, or support for each method may be defined as multiple components within a single UE capability.

For the above-described [Method 1-3], if the terminal receives upper layer signaling from the base station for multiple SRS resources in order to use the above-described [Method 1-3-1] to [Method 1-3-3], etc., the terminal may distinguish, from the base station, among various upper layer signaling configuration information in the SRS resources mentioned in the above [Table 29], upper layer signaling configuration information that must be configured identically for all of the multiple SRS resources required to transmit an SRS having N antenna ports, and information that may be identical or different.

The terminal may expect that parameters such as groupOrSequenceHopping and sequenceId, which are parameters related to the transmission sequence of the SRS among the parameters in [Table 29], and resourceType, which indicates periodic, semi-static, and aperiodic transmission of the SRS resource, are all configured to the same value for multiple SRS resources required to transmit an SRS having N antenna ports.

The terminal may expect that among the parameters in [Table 29], information related to time resource allocation of SRS, such as resourceMapping, resourceMapping-r16, and resourceMa pping-17, and information related to frequency resource allocation, such as freqDomainPosition, freqDomainShift, and freqHopping, are configured to be the same or different for multiple SRS resources required to transmit an SRS having N antenna ports. In addition, transmissionComb and transmissionComb-n8-r17, which determine the frequency and position of transmission REs of the SRS, may be expected to have the same Comb value for multiple SRS resources, and Comb offset may be expected to be configured to be the same or different. In addition, the partial factor configured for the RB level partial frequency sounding operation of the SRS may also be expected to have the same value for multiple SRS resources.

The terminal may expect that information such as spatialrelationinfo and srs-TCIState-r17, which are information for determining the transmission beam of the SRS among the parameters in [Table 29], are configured to be the same or different for multiple SRS resources. In particular, when multiple SRS resources are configured to different SRS resource sets, the terminal may expect that the two parameters related to determining the transmission beam are configured differently for the multiple SRS resources.

### Second Embodiment: SRS Time Resource Allocation, Repetition Transmission, and Frequency Hopping Method

As an example of the present disclosure, a method of SRS time resource allocation, repeated transmission, and frequency hopping according to the SRS resource configuration and indication method described in the above embodiment is described.

According to the above [Table 29], the terminal may determine the time domain transmission resource position during frequency hopping of the SRS resource through upper layer signaling such as startPosition, which means the transmission start symbol within the slot of the SRS resource, nrofSymbols, which means the number of symbols transmitted consecutively from the transmission start symbol within the slot, and repetitionFactor, which means the number of consecutive symbols having frequency resources at the same position when performing frequency hopping.

In the above embodiment, when using [Method 1-1], that is, when one SRS resource is configured to all N antenna ports and all N antenna ports are transmitted for each transmission symbol, the terminal may perform the following operations depending on the combination of startPosition, nrofSymbols, and repetitionFactor, which are upper layer signalings, for periodic/semi-persistent/aperiodic SRS transmission.
The terminal may have nrofSymbols-r17 (herein after referred to as Nₛ), which is the upper layer signaling for aperiodic SRS, configured to 2, 4, 8, 10, 12, or 14 and the repetitionFactor-r17 (hereinafter referred to as R) configured to 1. When performing frequency hopping, only frequency hopping within a slot may be possible, and when performing frequency hopping, the number of consecutive symbols having frequency resources at the same location may be 1 (=R).
The terminal may have Nₛ, which is the upper layer signaling for aperiodic SRS, configured to a value greater than or equal to 4, and R configured to a value greater than or equal to 2, where R may be a divisor of Nₛ, and when performing frequency hopping, only frequency hopping within a slot may be possible, and when performing frequency hopping, the number of consecutive symbols having frequency resources at the same location may be R.
The terminal may have Nₛ configured to 1 for periodic/semi-persistent SRS, and R configured to 1, and when performing frequency hopping, only slot-to-slot frequency hopping is possible, and when performing frequency hopping, the number of consecutive symbols having frequency resources at the same location may be 1 (=R).
The terminal may have Nₛ, which is the upper layer signaling for periodic/semi-persistent SRS, configured to a value greater than or equal to 4, and R configured to a value greater than or equal to 2, where R may be a divisor of Nₛ, and when performing frequency hopping, frequency hopping within a slot or between slots may be possible, and when performing frequency hopping, the number of consecutive symbols having frequency resources at the same location may be R.
The terminal may have Nₛ, which is the upper layer signaling for periodic/semi-persistent SRS, configured to a value greater than or equal to 4, and R configured to a value equal to Nₛ, and when performing frequency hopping, frequency hopping within a slot or between slots may be possible, and when performing frequency hopping, the number of consecutive symbols having frequency resources at the same location may be R (=Nₛ).

In the above embodiment, when using [Method 1-2], that is, when one SRS resource is configured with N antenna ports and some of the N antenna ports are transmitted for each transmission symbol, the terminal may perform the following operation by considering the definitions of startPosition, nrofSymbols, and repetitionFactor, which are upper layer signaling, as follows.

### [Time Resource Operation 2-1]

The terminal may regard the definition of Nₛ as meaning the number of consecutive symbols over which the corresponding SRS resource is transmitted, as before. If the terminal assumes that one SRS resource is configured with N antenna ports, and some of the N antenna ports are transmitted for each transmission symbol, and if M symbols are required for all N antenna ports to be transmitted, the terminal may expect to be configured with Nₛ that has M as a divisor for the corresponding SRS resource. For example, if the terminal is configured with N=8 antenna ports, 4 antenna ports are transmitted for each transmission symbol, and all N=8 antenna ports are transmitted through M=2 symbols, the terminal may be configured with one of Nₛ=2, 4, 8, 10, 12, 14 that has M=2 as a divisor for the corresponding SRS resource. If Nₛ is 4, the number of consecutive symbols over which the corresponding SRS resource is transmitted is 4, and it may be expected that some 4 out of the total 8 antenna ports (for example, SRS antenna ports 0 to 3) are transmitted in the first and third symbols, and some 4 out of the total 8 antenna ports (for example, SRS antenna ports 4 to 7) are transmitted in the second and fourth symbols. This method of mapping and transmitting all N antenna ports in M consecutive symbols and then mapping and transmitting all N antenna ports in the next M consecutive symbols may be named a cyclical transmission method. Alternatively, it may be expected that some 4 out of the total 8 antenna ports (for example, SRS antenna ports 0 to 3) are transmitted in the first two symbols, and some 4 out of the total 8 antenna ports (for example, SRS antenna ports 4 to 7) are transmitted in the remaining two symbols. A method of repeatedly mapping and transmitting some of N antenna ports in consecutive symbols and repeatedly mapping and transmitting some of the remaining N antenna ports in the next consecutive symbol may be named a sequential transmission method. The present disclosure may not be limited to the above-described examples, and as another example, a case in which some 4 of a total of 8 antenna ports are configured as SRS antenna ports 0, 2, 4, and 6 may not be excluded.

The terminal may assume that the definition of R means the number of consecutive symbols having the same frequency resources at the same location where the corresponding SRS resource is transmitted, as before. Therefore, as described above, the R value that the terminal may be configured may be a divisor of Nₛ. In this case, if the terminal assumes that M symbols are required for all N antenna ports to be transmitted in the case that one SRS resource is configured with N antenna ports and some of the N antenna ports are transmitted for each transmission symbol, the minimum value of R may be 1 or M.
If the minimum value of R that the terminal may configure is 1 and the terminal configures the value of R to 1, it means that the number of consecutive symbols having the same frequency resource is 1, and at this time, only some of the N antenna ports may be transmitted in one symbol, so the SRS corresponding to the corresponding antenna ports may be transmitted at different frequency positions for each group of specific some of the N antenna ports. Accordingly, since the SRS corresponding to all the N antenna ports may not be transmitted at the same frequency position, when the base station receives the corresponding SRS and performs channel estimation, the channel information of a specific antenna port may be absent at some frequency resource positions, and thus the channel information of a frequency position where the channel information does not exist may have to be estimated by utilizing the frequency position where the channel information exists. In this case, the frequency band of the SRS transmission that the base station can estimate may be widened, but the channel estimation performance at the frequency position where the channel information of a specific antenna port is absent may be degraded.
If the minimum value of R that the terminal may configure is M and the terminal configures the value of R to M, it means that the number of consecutive symbols having the same frequency resource is M. At this time, since all N antenna ports may be transmitted during M symbols, SRSs corresponding to N antenna ports may be transmitted at the same frequency position. Accordingly, when the base station receives the corresponding SRS and performs channel estimation, it may obtain channel information for all N antenna ports at all frequency positions. In this case, the frequency band of SRS transmission that the base station can estimate is reduced compared to the case where the minimum value of R is 1, but since all antenna ports transmit at all frequency positions, channel estimation performance may be improved.
The minimum value of R that the terminal may be configured to is 1 or M, which may be configured by upper layer signaling, indicated by L1 signaling, notified by a combination of upper layer signaling and L1 signaling, activated/deactivated through MAC-CE signaling, or may operate as defined within the specification.

On the basis of the time resource operation 2-1, the terminal may perform the following operations depending on the combination of startPosition, nrofSymbols, and repetitionFactor, which are upper layer signaling, for periodic/semi-persistent/aperiodic SRS transmission.
The terminal may be configured to Nₛ as 2, 4, 8, 10, 12, or 14 for the aperiodic SRS, and may be configured to R as 1 or M, where M may be a divisor of Nₛ. When frequency hopping is performed, only frequency hopping within a slot may be possible, and when frequency hopping is performed, the number of consecutive symbols having frequency resources at the same location may be 1 or M (=R). The determination of the R value may follow one of the methods described above.
The terminal may configure Nₛ, which is an upper layer signaling for aperiodic SRS, to a value greater than or equal to 4, and may configure R to a value greater than or equal to 2 or a value greater than or equal to M, where R or M may be a divisor of Nₛ. When performing frequency hopping, only frequency hopping within a slot may be possible, and when performing frequency hopping, the number of consecutive symbols having frequency resources at the same location may be R.
The terminal may configure Nₛ to M for periodic/semi-persistent SRS, and may configure R to M. When performing frequency hopping, only frequency hopping between slots may be possible, and when performing frequency hopping, the number of consecutive symbols having frequency resources at the same location may be M (=R).
The terminal may configure Nₛ, which is an upper layer signaling for periodic/semi-persistent SRS, to a value greater than or equal to 4, and may configure R to a value greater than or equal to 2 or a value greater than or equal to M, where R or M may be a divisor of Nₛ. When performing frequency hopping, frequency hopping within a slot or between slots may be possible, and when performing frequency hopping, the number of consecutive symbols having frequency resources at the same location may be R.
The terminal may configure Nₛ, which is an upper layer signaling for periodic/semi-persistent SRS, to a value greater than or equal to 4, and may configure R to a value equal to Nₛ. When performing frequency hopping, frequency hopping within a slot or between slots may be possible, and when performing frequency hopping, the number of consecutive symbols having frequency resources at the same location may be R (=Nₛ).

### [Time Resource Operation 2-2]

If the number of symbols required for all antenna ports of the corresponding SRS resource to be transmitted is defined as M, the terminal may understand the definition of Nₛ as the value of how many times the M symbols are used to transmit the corresponding SRS resource. In other words, rather than the existing definition of the number of consecutive symbols used to transmit the SRS resource, it may be defined as information on how many times the M symbol units used to transmit all N antenna ports configured in the SRS resource are used consecutively. For example, if a terminal is configured with N=8 antenna ports, and 4 antenna ports are transmitted for each transmission symbol, and all N=8 antenna ports are transmitted through M=2 symbols, the terminal may be configured with one of Nₛ=1, 2, 4, 5, 6, 7 as information on how many times M=2 symbol units are used consecutively for the corresponding SRS resource, and if Nₛ is 2, the total number of consecutive symbols transmitted for the corresponding SRS resource is 4, which may mean that M=2 symbol units are used consecutively twice. In addition, it may be expected that some 4 out of the total 8 antenna ports (for example, SRS antenna ports 0 to 3) are transmitted in the first and third symbols, and some other 4 out of the total 8 antenna ports (for example, SRS antenna ports 4 to 7) are expected to be transmitted in the second and fourth symbols. In this way, a method of transmitting by mapping all N antenna ports in M consecutive symbols, and then transmitting by mapping all N antenna ports in the next consecutive M symbols may be named a cyclical transmission method. In another way, it may be expected that some 4 out of a total of 8 antenna ports (for example, SRS antenna ports 0 to 3) are transmitted in the first two symbols, and some 4 out of a total of 8 antenna ports (for example, SRS antenna ports 4 to 7) are transmitted in the remaining two symbols. In this way, a method of repeatedly mapping some of N antenna ports in consecutive symbols and transmitting, and then repeatedly mapping some of the remaining N antenna ports in the next consecutive symbols may be named a sequential transmission method. The present disclosure may not be limited to the examples described above, and as another example, it may not be excluded that some 4 out of a total of 8 antenna ports are configured as SRS antenna ports 0, 2, 4, and 6.

The terminal may assume that the definition of R means the number of consecutive symbols having the same frequency resources at the same location where the corresponding SRS resource is transmitted, as before. Therefore, as described above, the R value that the terminal may be configured may be a divisor of Nₛ. In this case, if the terminal assumes that M symbols are required for all N antenna ports to be transmitted in the case that one SRS resource is configured with N antenna ports and some of the N antenna ports are transmitted for each transmission symbol, the minimum value of R may be 1 or M.
If the minimum value of R that the terminal may configure is 1 and the terminal configures the value of R to 1, it means that the number of consecutive symbols having the same frequency resource is 1, and at this time, only some of the N antenna ports may be transmitted in 1 symbol, so the SRS corresponding to the corresponding antenna ports may be transmitted at different frequency positions for each group of specific some of the N antenna ports. Accordingly, since the SRS corresponding to all the N antenna ports may not be transmitted at the same frequency position, when the base station receives the corresponding SRS and performs channel estimation, the channel information of a specific antenna port may be absent at some frequency resource positions, and thus the channel information of a frequency position where the channel information does not exist may have to be estimated by utilizing the frequency position where the channel information exists. In this case, the frequency band of the SRS transmission that the base station can estimate may be widened, but the channel estimation performance at the frequency position where the channel information of a specific antenna port is absent may be degraded.
If the minimum value of R that the terminal may configure is M and the terminal configures the value of R to M, it means that the number of consecutive symbols having the same frequency resource is M. At this time, since all N antenna ports may be transmitted during M symbols, SRSs corresponding to N antenna ports may be transmitted at the same frequency position. Accordingly, when the base station receives the corresponding SRS and performs channel estimation, channel information for all N antenna ports at all frequency positions may be obtained. In this case, the frequency band of SRS transmission that the base station can estimate is reduced compared to the case where the minimum value of R is 1, but since all antenna ports transmit at all frequency positions, channel estimation performance may be improved.
The minimum value of R that a terminal may be configured to is 1 or M, which may be configured by upper layer signaling, indicated by L1 signaling, notified by a combination of upper layer signaling and L1 signaling, activated/deactivated through MAC-CE signaling, or may operate as defined in the specification.

On the basis of the time resource operation 2-2, the terminal may perform the following operations depending on the combination of startPosition, nrofSymbols, and repetitionFactor, which are upper layer signaling, for periodic/semi-persistent/aperiodic SRS transmission.
The terminal may be configured to Nₛ as 1, 2, 4, 5, 6, or 7 for aperiodic SRS, and may be configured to R as 1 or M. When performing frequency hopping, only frequency hopping within a slot may be possible, and when performing frequency hopping, the number of consecutive symbols having frequency resources at the same location may be 1 or M (=R). The determination of the R value may follow one of the methods described above.
The terminal may configure Nₛ, which is an upper layer signaling for aperiodic SRS, to a value greater than or equal to 2 (=one of 2, 4, 5, 6, and 7), and may configure R to a value greater than or equal to 2 or a value greater than or equal to M. When performing frequency hopping, only frequency hopping within a slot may be possible, and when performing frequency hopping, the number of consecutive symbols having frequency resources at the same location may be R.
The terminal may configure Nₛ to M for periodic/semi-persistent SRS, and may configure R to M. When performing frequency hopping, only frequency hopping between slots may be possible, and when performing frequency hopping, the number of consecutive symbols having frequency resources at the same location may be M (=R).
The terminal may configure Nₛ, which is an upper layer signaling for periodic/semi-persistent SRS, to a value greater than or equal to 2 (=one of 2, 4, 5, 6, and 7), and may configure R to a value greater than or equal to 2 or a value greater than or equal to M. When performing frequency hopping, frequency hopping within a slot or between slots may be possible, and when performing frequency hopping, the number of consecutive symbols having frequency resources at the same location may be R.
The terminal may be configured to a value greater than or equal to 2 (=one of 2, 4, 5, 6, 7) for Nₛ, which is an upper layer signaling for periodic/semi-persistent SRS, and may configure R to a value equal to M*Nₛ. When performing frequency hopping, frequency hopping within a slot or between slots may be possible, and when performing frequency hopping, the number of consecutive symbols having frequency resources in the same location may be R (=M*Nₛ).

In the above embodiment, when using [Method 1-3], that is, when N antenna ports are configured for the entirety of multiple SRS resources and some of the N antenna ports are configured and transmitted for each SRS resource, the terminal may perform the following operation by considering the definitions of startPosition, nrofSymbols, and repetitionFactor, which are upper layer signaling, as follows.

### [Time Resource Operation 3-1]

The terminal may configure the total number of symbols over which multiple SRS resources are transmitted as Nₛ of each SRS resource. If each of n SRS resources is transmitted in M symbols, Nₛ may be n*M, and Nₛ may be configured to the same value within each SRS resource. If the terminal is configured with N antenna ports for multiple SRS resources and some of the N antenna ports are transmitted for each SRS resource, and if it is assumed that m (m may be less than or equal to M) symbols are required for each SRS resource to be transmitted for all N antenna ports, the terminal may expect to be configured with Nₛ that has m and M as divisors for each SRS resource. For example, if a terminal is configured with two SRS resources capable of expressing N=8 antenna ports and each SRS resource is transmitted in M=2 symbols, the terminal may be configured with one of Nₛ=2, 4, 8, 10, 12, 14, which has M=2 as a divisor, for each of the multiple SRS resources, and if Nₛ is 4, the total number of symbols over which the multiple SRS resources are transmitted is 4, and it may be expected that four out of the total eight antenna ports (for example, SRS antenna ports 0 to 3) are configured for the first SRS resource among the two SRS resources and transmitted in the first and third symbols, and another four out of the total eight antenna ports (for example, SRS antenna ports 4 to 7) are configured for the second SRS resource and transmitted in the second and fourth symbols. In this way, a method of transmitting by mapping all N antenna ports in M consecutive symbols, and then transmitting by mapping all N antenna ports in the next M consecutive symbols may be named a cyclical transmission method. In another way, it may be expected that some 4 out of a total of 8 antenna ports (for example, SRS antenna ports 0 to 3) are transmitted in the first two symbols, and some 4 out of a total of 8 antenna ports (for example, SRS antenna ports 4 to 7) are transmitted in the remaining two symbols. In this way, a method of repeatedly mapping some of N antenna ports in consecutive symbols and transmitting, and then repeatedly mapping some of the remaining N antenna ports in the next consecutive symbols may be named a sequential transmission method. The present disclosure may not be limited to the above-described examples, and as another example, it may not be excluded that some 4 out of a total of 8 antenna ports are configured as SRS antenna ports 0, 2, 4, and 6.

The terminal may assume that the definition of R means the number of consecutive symbols having the same frequency resources at the same location where the corresponding SRS resource is transmitted, as before. Therefore, as described above, the R value that the terminal may be configured may be a divisor of Nₛ. In this case, if the terminal is configured with multiple SRS resources for N antenna ports and some of the N antenna ports are transmitted for each SRS resource, and if it is assumed that m symbols are required for all N antenna ports to be transmitted, the minimum value of R may be 1 or m.
If the minimum value of R that the terminal may configure is 1 and the terminal configures the value of R to 1, it means that the number of consecutive symbols having the same frequency resource is 1, and at this time, only some of the N antenna ports may be transmitted in 1 symbol, so the SRS corresponding to the corresponding antenna ports may be transmitted at different frequency positions for each group of specific some of the N antenna ports. Accordingly, since the SRS corresponding to all the N antenna ports may not be transmitted at the same frequency position, when the base station receives the corresponding SRS and performs channel estimation, the channel information of a specific antenna port may be absent at some frequency resource positions, and thus the channel information of a frequency position where the channel information does not exist may have to be estimated by utilizing the frequency position where the channel information exists. In this case, the frequency band of the SRS transmission that the base station can estimate may be widened, but the channel estimation performance at the frequency position where the channel information of a specific antenna port is absent may be degraded.
If the minimum value of R that the terminal may configure is m and the terminal sets the value of R to m, it means that the number of consecutive symbols having the same frequency resource is m. At this time, since all N antenna ports may be transmitted during the m symbols, SRSs corresponding to N antenna ports may be transmitted at the same frequency position. Accordingly, when the base station receives the corresponding SRS and performs channel estimation, channel information for all N antenna ports at all frequency positions may be obtained. In this case, the frequency band of SRS transmission that the base station can estimate is reduced compared to the case where the minimum value of R is 1, but since all antenna ports transmit at all frequency positions, channel estimation performance may be improved.
The minimum value of R that a terminal may be configured to is 1 or m, which may be configured by upper layer signaling, indicated by L1 signaling, notified by a combination of upper layer signaling and L1 signaling, activated/deactivated through MAC-CE signaling, or may operate as defined within the specification.

On the basis of the time resource operation 3-1, the terminal may perform the following operations depending on the combination of startPosition, nrofSymbols, and repetitionFactor, which are upper layer signaling, for periodic/semi-persistent/aperiodic SRS transmission.
The terminal may be configured to Nₛ as 2, 4, 8, 10, 12, or 14 for the aperiodic SRS, and may be configured to R as 1 or m, where m may be a divisor of Nₛ. When frequency hopping is performed, only frequency hopping within a slot may be possible, and when frequency hopping is performed, the number of consecutive symbols having frequency resources at the same location may be 1 or m (=R). The determination of the R value may follow one of the methods described above.
The terminal may configure Nₛ, which is an upper layer signaling for aperiodic SRS, to a value greater than or equal to 4, and may set R to a value greater than or equal to 2 or a value greater than or equal to m, where R or m may be a divisor of Nₛ. When performing frequency hopping, only frequency hopping within a slot may be possible, and when performing frequency hopping, the number of consecutive symbols having frequency resources at the same location may be R.
The terminal may configure Nₛ to m for periodic/semi-persistent SRS, and may configure R to m. When performing frequency hopping, only slot-to-slot frequency hopping is possible, and when performing frequency hopping, the number of consecutive symbols having frequency resources in the same location may be m (=R).
The terminal may configure Nₛ, which is an upper layer signaling for periodic/semi-persistent SRS, to a value greater than or equal to 4, and may configure R to a value greater than or equal to 2 or a value greater than or equal to m, where R or m may be a divisor of Nₛ. When performing frequency hopping, frequency hopping within a slot or between slots may be possible, and when performing frequency hopping, the number of consecutive symbols having frequency resources at the same location may be R.
The terminal may configure Nₛ, which is an upper layer signaling for periodic/semi-persistent SRS, to a value greater than or equal to 4, and may configure R to a value equal to Nₛ. When performing frequency hopping, frequency hopping within a slot or between slots may be possible, and when performing frequency hopping, the number of consecutive symbols having frequency resources at the same location may be R (=Nₛ).

### [Time Resource Operation 3-2]

The terminal may configure the number of symbols transmitted for each of multiple SRS resources as Nₛ of each SRS resource. If the terminal is configured with N antenna ports for m SRS resources and some of the N antenna ports are transmitted for each SRS resource, and if it is assumed that m symbols are required for the m SRS resources in total for all the N antenna ports to be transmitted, the terminal may expect that N antenna ports are transmitted in a total of m*Nₛ symbols for all SRS resources. For example, if the terminal is configured with m=2 SRS resources that can express N=8 antenna ports and 4 antenna ports are transmitted in Nₛ symbols for each SRS resource, the terminal may configure one of Nₛ=1, 2, 4, 5, 6, 7 for each of the multiple SRS resources. If Nₛ is 2, the total number of symbols over which the two SRS resources are transmitted is 4, and it may be expected that some 4 out of the total 8 antenna ports (for example, SRS antenna ports 0 to 3) are configured for the first SRS resource among the two SRS resources and transmitted in the first and third symbols, and another some 4 out of the total 8 antenna ports (for example, SRS antenna ports 4 to 7) are configured for the second SRS resource and transmitted in the second and fourth symbols. In this way, a method of mapping and transmitting all N antenna ports in M consecutive symbols and then mapping and transmitting all N antenna ports in the next M consecutive symbols may be named a cyclical transmission method. In another way, it may be expected that some 4 out of the total 8 antenna ports (for example, SRS antenna ports 0 to 3) are transmitted in the first two symbols, and another 4 out of the total 8 antenna ports (for example, SRS antenna ports 4 to 7) are transmitted in the remaining two symbols. In this way, a method of repeatedly mapping and transmitting some of the N antenna ports in consecutive symbols, and repeatedly mapping and transmitting the remaining some of the N antenna ports in the next consecutive symbols may be named a sequential transmission method. The present disclosure may not be limited to the above-described examples, and may not exclude that, as another example, some 4 out of the total 8 antenna ports are configured as SRS antenna ports 0, 2, 4, and 6.

The terminal may assume that the definition of R means the number of consecutive symbols having the same frequency resources at the same location where the corresponding SRS resource is transmitted, as before. Therefore, as described above, the R value that the terminal may be configured may be a divisor of Nₛ. In this case, if the terminal is configured with multiple SRS resources for N antenna ports and some of the N antenna ports are transmitted for each SRS resource, and if it is assumed that m symbols are required for all N antenna ports to be transmitted, the minimum value of R may be 1 or m.
If the minimum value of R that the terminal may configure is 1 and the terminal configures the value of R to 1, it means that the number of consecutive symbols having the same frequency resource is 1, and at this time, only some of the N antenna ports may be transmitted in 1 symbol, so the SRS corresponding to the corresponding antenna ports may be transmitted at different frequency positions for each group of specific some of the N antenna ports. Accordingly, since the SRS corresponding to all the N antenna ports may not be transmitted at the same frequency position, when the base station receives the corresponding SRS and performs channel estimation, the channel information of a specific antenna port may be absent at some frequency resource positions, and thus the channel information of a frequency position where the channel information does not exist may have to be estimated by utilizing the frequency position where the channel information exists. In this case, the frequency band of the SRS transmission that the base station can estimate may be widened, but the channel estimation performance at the frequency position where the channel information of a specific antenna port is absent may be degraded.
If the minimum value of R that the terminal may configure is m and the terminal sets the value of R to m, it means that the number of consecutive symbols having the same frequency resource is m. At this time, since all N antenna ports may be transmitted during the m symbols, SRSs corresponding to N antenna ports may be transmitted at the same frequency position. Accordingly, when the base station receives the corresponding SRS and performs channel estimation, channel information for all N antenna ports at all frequency positions may be obtained. In this case, the frequency band of SRS transmission that the base station can estimate is reduced compared to the case where the minimum value of R is 1, but since all antenna ports transmit at all frequency positions, channel estimation performance may be improved.
The minimum value of R that a terminal may be configured to is 1 or m, which may be configured by upper layer signaling, indicated by L1 signaling, notified by a combination of upper layer signaling and L1 signaling, activated/deactivated through MAC-CE signaling, or may operate as defined within the specification.

On the basis of the time resource operation 3-2, the terminal may perform the following operations depending on the combination of startPosition, nrofSymbols, and repetitionFactor, which are upper layer signaling, for periodic/semi-persistent/aperiodic SRS transmission.
The terminal may be configured to Nₛ as 1, 2, 4, 5, 6, or 7 for aperiodic SRS, and may be configured to R as 1 or m. When performing frequency hopping, only frequency hopping within a slot may be possible, and when performing frequency hopping, the number of consecutive symbols having frequency resources at the same location may be 1 or m (=R). The determination of the R value may follow one of the methods described above.
The terminal may configure Nₛ, which is an upper layer signaling for aperiodic SRS, to a value greater than or equal to 2 (=one of 2, 4, 5, 6, and 7), and may configure R to a value greater than or equal to 2 or a value greater than or equal to m. When performing frequency hopping, only frequency hopping within a slot may be possible, and when performing frequency hopping, the number of consecutive symbols having frequency resources at the same location may be R.
The terminal may configure Nₛ to 1 for periodic/semi-persistent SRS, and may configure R to 1. When performing frequency hopping, only slot-to-slot frequency hopping may be possible, and when performing frequency hopping, the number of consecutive symbols having frequency resources at the same location may be R.
The terminal may configure Nₛ, which is an upper layer signaling for periodic/semi-persistent SRS, to a value greater than or equal to 2 (=one of 2, 4, 5, 6, and 7), and may configure R to a value greater than or equal to 2 or a value greater than or equal to m. When performing frequency hopping, frequency hopping within a slot or between slots may be possible, and when performing frequency hopping, the number of consecutive symbols having frequency resources at the same location may be R.
The terminal may be configured to a value greater than or equal to 2 (=1 of 2, 4, 5, 6, 7) for Nₛ, which is an upper layer signaling for periodic/semi-persistent SRS, and may be configured to a value equal to m*Nₛ. When performing frequency hopping, frequency hopping within a slot or between slots may be possible, and when performing frequency hopping, the number of consecutive symbols having frequency resources in the same location may be R (=m*Nₛ).

The terminal may report to the base station as a UE capability whether it supports at least one combination of [Time Resource Operation 2-1], [Time Resource Operation 2-2], [Time Resource Operation 3-1], and [Time Resource Operation 3-2] described above. The UE capability report may be reported differently according to a frequency range (FR), and may be reported by band, by band combination, by feature set, or by feature set per CC. In addition, the UE capabilities described above may be independent UE capabilities, or support for each method may be defined as multiple components within a single UE capability.

The terminal may be configured by a higher layer signaling from the base station, indicated by L1 signaling, notified by a combination of higher layer signaling and L1 signaling, activated/deactivated through MAC-CE signaling, or may operate as defined in the specification for at least one combination of [Time Resource Operation 2-1], [Time Resource Operation 2-2], [Time Resource Operation 3-1], and [Time Resource Operation 3-2] described above.

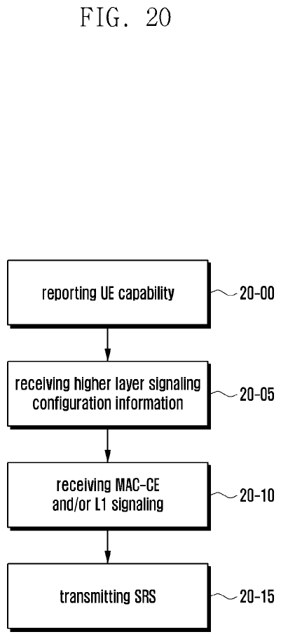

FIG. 20 is a diagram illustrating the operation of a terminal for SRS transmission according to one embodiment of the present disclosure.

The terminal may report UE capability to the base station (20-00). The UE capability report may be a combination of at least one of the UE capabilities mentioned in the above-described embodiments. For example, the UE capability reported by the terminal may include at least one of the UE capabilities indicating whether to support [Method 1-1] to [Method 1-4], whether to support [Method 1-3-1] to [Method 1-3-3], and whether to support [Time Resource Operation 2-1], [Time Resource Operation 2-2], [Time Resource Operation 3-1], and [Time Resource Operation 3-2]. Thereafter, the terminal may receive upper layer signaling configuration information from the base station (20-05). The upper layer signaling may be a combination of at least one of the upper layer signaling configuration information mentioned in the above-described embodiments. For example, it may be related upper layer signaling for at least one of the above-described [Method 1-1] to [Method 1-4], [Method 1-3-1] to [Method 1-3-3], [Time Resource Operation 2-1], [Time Resource Operation 2-2], [Time Resource Operation 3-1], and [Time Resource Operation 3-2]. The terminal may additionally receive MAC-CE and/or L1 signaling from the base station (20-10). For example, it may be related MAC-CE and/or L1 signaling for at least one of the above-described [Method 1-1] to [Method 1-4], [Method 1-3-1] to [Method 1-3-3], [Time Resource Operation 2-1], [Time Resource Operation 2-2], [Time Resource Operation 3-1], and [Time Resource Operation 3-2]. The terminal may transmit an SRS having N antenna ports on the basis of an instruction from a base station received through the above-described upper layer signaling and MAC-CE and/or L1 signaling (20-15).

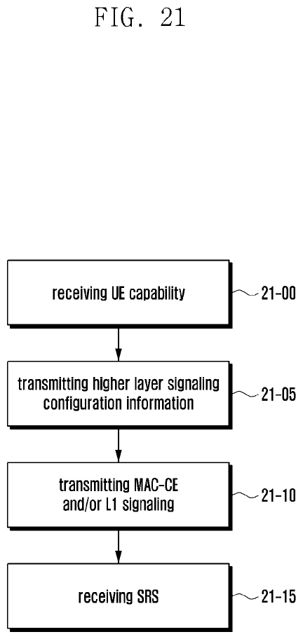

FIG. 21 is a diagram illustrating the operation of a base station for SRS reception according to one embodiment of the present disclosure.

The base station may receive UE capability from the terminal (21-00). The UE capability report may be a combination of at least one of the UE capabilities mentioned in the above-described embodiments. For example, the UE capability reported by the terminal may include at least one of the UE capabilities indicating whether [Method 1-1] to [Method 1-4] are supported, whether [Method 1-3-1] to [Method 1-3-3] are supported, and whether [Time Resource Operation 2-1], [Time Resource Operation 2-2], [Time Resource Operation 3-1], and [Time Resource Operation 3-2] are supported. Thereafter, the base station may transmit upper layer signaling configuration information to the terminal (21-05). The upper layer signaling may be a combination of at least one of the upper layer signaling configuration information mentioned in the above-described embodiments. For example, it may be related upper layer signaling for at least one of the above-described [Method 1-1] to [Method 1-4], [Method 1-3-1] to [Method 1-3-3], [Time Resource Operation 2-1], [Time Resource Operation 2-2], [Time Resource Operation 3-1], and [Time Resource Operation 3-2]. The base station may additionally transmit MAC-CE and/or L1 signaling to the terminal (21-10). For example, it may be related MAC-CE and/or L1 signaling for at least one of the above-described [Method 1-1] to [Method 1-4], [Method 1-3-1] to [Method 1-3-3], [Time Resource Operation 2-1], [Time Resource Operation 2-2], [Time Resource Operation 3-1], and [Time Resource Operation 3-2]. The base station may receive an SRS having N antenna ports transmitted by a terminal on the basis of the information indicated through the above-described upper layer signaling and MAC-CE and/or L1 signaling (21-15).

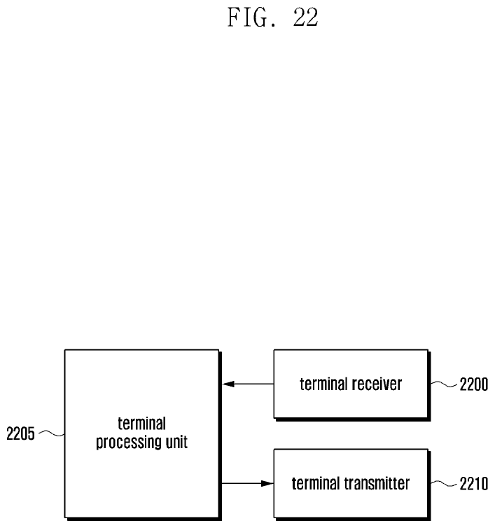

FIG. 22 is a diagram illustrating the structure of a terminal in a wireless communication system according to one embodiment of the present disclosure.

With reference to FIG. 22, the terminal may include a transceiver, which refers to a terminal receiving unit 2200 and a terminal transmitting unit 2210, a memory (not shown), and a terminal processing unit 2205 (or a terminal control unit or processor). Depending on the communication method of the terminal described above, the transceiver 2200 and 2210, the memory, and the terminal processing unit 2205 of the terminal may operate. However, the components of the terminal are not limited to the examples described above. For example, the terminal may include more or fewer components than the components described above. In addition, the transceiver, the memory, and the processor may be implemented in the form of a single chip.

The transceiver may transmit and receive signals with the base station. Here, the signals may include control information and data. To this end, the transceiver may be configured with an RF transmitter that up-converts and amplifies the frequency of a transmitted signal, an RF receiver that low-noise amplifies a received signal and down-converts the frequency, etc. However, this is only one embodiment of the transceiver, and the components of the transceiver are not limited to the RF transmitter and the RF receiver.

Additionally, the transceiver may receive a signal through a wireless channel and output it to the processor, and transmit a signal output from the processor through the wireless channel.

The memory may store programs and data necessary for the operation of the terminal. In addition, the memory may store control information or data included in signals transmitted and received by the terminal. The memory may be composed of a storage medium such as ROM, RAM, a hard disk, CD-ROM, and DVD, or a combination of storage media. In addition, there may be multiple memories.

In addition, the processor may control a series of processes so that the terminal can operate according to the above-described embodiment. For example, the processor may control components of the terminal to receive DCI consisting of two layers and simultaneously receive multiple PDSCHs. There may be multiple processors, and the processor may perform component control operations of the terminal by executing a program stored in a memory.

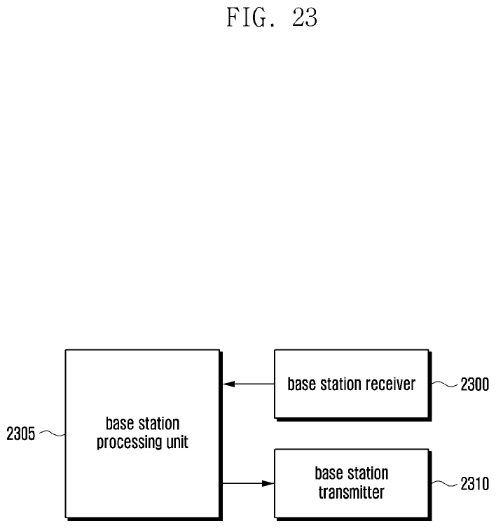

FIG. 23 is a diagram illustrating the structure of a base station in a wireless communication system according to one embodiment of the present disclosure. With reference to FIG. 23, the base station may include a transceiver, which refers to a base station receiver 2300 and a base station transmitter 2310, a memory (not shown), and a base station processing unit 2305 (or a base station control unit or processor). According to the communication method of the base station described above, the transceiver 2300 and 2310, the memory, and the base station processing unit 2305 of the base station may operate. However, the components of the base station are not limited to the examples described above. For example, the base station may include more or fewer components than the components described above. In addition, the transceiver, the memory, and the processor may be implemented in the form of a single chip.

The transceiver may transmit and receive signals with the terminal. Here, the signals may include control information and data. To this end, the transceiver may be configured with an RF transmitter that up-converts and amplifies the frequency of a transmitted signal, and an RF receiver that low-noise amplifies and frequency-down-converts a received signal. However, this is only one embodiment of the transceiver, and the components of the transceiver are not limited to the RF transmitter and the RF receiver.

Additionally, the transceiver may receive a signal through a wireless channel and output it to the processor, and transmit a signal output from the processor through the wireless channel.

The memory may store programs and data required for the operation of the base station. In addition, the memory may store control information or data included in signals transmitted and received by the base station. The memory may be composed of a storage medium or a combination of storage media such as a ROM, a RAM, a hard disk, a CD-ROM, and a DVD. In addition, there may be multiple memories.

The processor may control a series of processes so that the base station can operate according to the embodiments of the present disclosure described above. For example, the processor may configure two layers of DCIs including allocation information for multiple PDSCHs and control each component of the base station to transmit them. There may be multiple processors, and the processor may perform the component control operation of the base station by executing a program stored in a memory.

The methods according to the embodiments described in the claims or specification of the present disclosure may be implemented in the form of hardware, software, or a combination of hardware and software.

In the case of software implementation, a computer-readable storage medium storing one or more programs (software modules) may be provided. The one or more programs stored in the computer-readable storage medium are configured for execution by one or more processors in an electronic device. The one or more programs include instructions that cause the electronic device to execute methods according to the embodiments described in the claims or specification of the present disclosure.

These programs (software modules, software) may be stored in a non-volatile memory including a random access memory, a flash memory, a ROM (Read Only Memory), an Electrically Erasable Programmable Read Only Memory (EEPROM), a magnetic disc storage device, a Compact Disc-ROM (CD-ROM), a Digital Versatile Discs (DVDs) or other forms of optical storage devices, a magnetic cassette. Alternatively, they may be stored in a memory composed of a combination of some or all of these. In addition, each configuration memory may be included in multiple numbers.

Additionally, the program may be stored in an attachable storage device that is accessible through a communications network, such as an Internet, an Intranet, a Local Area Network (LAN), a Wide LAN (WLAN), or a Storage Area Network (SAN), or a combination thereof. The storage device may be connected to a device performing one embodiment of the present disclosure through an external port. Additionally, a separate storage device on the communications network may be connected to a device performing one embodiment of the present disclosure.

In the specific embodiments of the present disclosure described above, the components included in the invention are expressed in the singular or plural form according to the specific embodiments presented. However, the singular or plural expressions are selected appropriately for the presented situation for the convenience of explanation, and the present disclosure is not limited to the singular or plural components, and even if a component is expressed in the plural form, it may be composed of the singular form, or even if a component is expressed in the singular form, it may be composed of the plural form.

Meanwhile, the embodiments of the present disclosure disclosed in this specification and drawings are only specific examples presented to easily explain the technical contents of the present disclosure and help in understanding the present disclosure, and are not intended to limit the scope of the present disclosure. In other words, it is obvious to a person having ordinary skill in the art to which the present disclosure pertains that other modified examples on the basis of the technical idea of the present disclosure are possible. In addition, each of the above embodiments may be combined and operated as needed. For example, parts of one embodiment of the present disclosure and parts of another embodiment may be combined and operated to operate a base station and a terminal. For example, parts of the first embodiment and the second embodiment of the present disclosure may be combined and operated to operate a base station and a terminal. In addition, although the above embodiments have been presented on the basis of the FDD LTE system, other modified examples on the basis of the technical idea of the above embodiments may be implemented in other systems such as a TDD LTE system, a 5G or NR system.

Meanwhile, the order of description in the drawings explaining the method of the present invention does not necessarily correspond to the order of execution, and the order of precedence may be changed or executed in parallel.

Alternatively, the drawings illustrating the method of the present invention may omit some components and include only some components, provided that the essence of the present invention is not compromised.

Furthermore, the method of the present invention may be implemented by combining some or all of the elements included in each embodiment, provided that the essence of the invention is not compromised.

Various embodiments of the present disclosure have been described above. The above description of the present disclosure is for illustrative purposes, and the embodiments of the present disclosure are not limited to the disclosed embodiments. Those skilled in the art to which the present disclosure pertains will understand that the present disclosure may be easily modified into other specific forms without changing the technical idea or essential features of the present disclosure. The scope of the present disclosure is indicated by the claims described below rather than the detailed description above, and all changes or modifications derived from the meaning and scope of the claims and their equivalent concepts should be interpreted as being included in the scope of the present disclosure.

1-15. (canceled)

16. A method performed by a terminal of a communication system, the method comprising:
transmitting, to a base station, capability information associated with an sounding reference signal (SRS) transmission with N antenna ports, wherein Nis greater than or equal to 8;
receiving, from the base station via higher layer signaling, configuration information for an SRS resource with N antenna ports, wherein the configuration information includes a number of orthogonal frequency division multiplexing (OFDM) symbols associated with the SRS resource;
identifying antenna ports mapped to each OFDM symbol of the OFDM symbols associated with the SRS resource according to a first configuration or a second configuration, wherein one of the first configuration and the second configuration is indicated by the higher layer signaling; and
transmitting, to the base station, an SRS in the OFDM symbols associated with the SRS resource based on the antenna ports mapped to each OFDM symbol.

17. The method of claim 16, wherein the N antenna ports are mapped to each OFDM symbol associated with the SRS resource based on the first configuration being indicated by the higher layer signaling.

18. The method of claim 16, wherein:
the N antenna ports are partitioned into a first subset and a second subset based on the second configuration being indicated by the higher layer signaling;
the first subset and the second subset comprise different antenna ports;
antenna ports included in the first subset is mapped to a first set of OFDM symbols from the OFDM symbols associated with the SRS resource; and
antenna ports included in the second subset is mapped to a second set of OFDM symbols from the OFDM symbols associated with the SRS resource.

19. The method of claim 18, wherein:
the first set of OFDM symbol comprises a first symbol of the OFDM symbols associated with the SRS resource; and
the second set of OFDM symbol comprises a second symbol of the OFDM symbols associated with the SRS resource.

20. A method performed by a base station of a communication system, the method comprising:
receiving, from a terminal, capability information associated with an sounding reference signal (SRS) transmission with N antenna ports, wherein N is greater than or equal to 8;
transmitting, to the terminal via higher layer signaling, configuration information for an SRS resource with N antenna ports, wherein the configuration information includes a number of orthogonal frequency division multiplexing (OFDM) symbols associated with the SRS resource;
identifying antenna ports mapped to each OFDM symbol of the OFDM symbols associated with the SRS resource according to a first configuration or a second configuration, wherein one of the first configuration and the second configuration is indicated by the higher layer signaling; and
receiving, from the terminal, an SRS in the OFDM symbols associated with the SRS resource based on the antenna ports mapped to each OFDM symbol.

21. The method of claim 20, wherein the N antenna ports are mapped to each OFDM symbol associated with the SRS resource based on the first configuration being indicated by the higher layer signaling.

22. The method of claim 20, wherein:
the N antenna ports are partitioned into a first subset and a second subset based on the second configuration being indicated by the higher layer signaling;
the first subset and the second subset comprise different antenna ports;
antenna ports included in the first subset is mapped to a first set of OFDM symbols from the OFDM symbols associated with the SRS resource; and
antenna ports included in the second subset is mapped to a second set of OFDM symbols from the OFDM symbols associated with the SRS resource.

23. The method of claim 22, wherein
the first set of OFDM symbol comprises a first symbol of the OFDM symbols associated with the SRS resource; and
the second set of OFDM symbol comprises a second symbol of the OFDM symbols associated with the SRS resource.

24. A terminal of a communication system comprising:
a transceiver; and
a controller configured to:
transmit, to a base station, capability information associated with an sounding reference signal (SRS) transmission with N antenna ports, wherein N is greater than or equal to 8;
receive, from the base station via higher layer signaling, configuration information for an SRS resource with N antenna ports, wherein the configuration information includes a number of orthogonal frequency division multiplexing (OFDM) symbols associated with the SRS resource;
identify antenna ports mapped to each OFDM symbol of the OFDM symbols associated with the above SRS resource according to a first configuration or a second configuration, wherein one of the first configuration and the second configuration is indicated by the higher layer signaling; and
transmit, to the base station, an SRS in the OFDM symbols associated with the SRS resource based on the antenna ports mapped to each OFDM symbol.

25. The terminal of claim 24, wherein the N antenna ports are mapped to each OFDM symbol associated with the SRS resource based on the first configuration being indicated by the higher layer signaling.

26. The terminal of claim 25, wherein:
the N antenna ports are partitioned into a first subset and a second subset based on the second configuration being indicated by the higher layer signaling;
the first subset and the second subset comprise different antenna ports;
antenna ports included in the first subset is mapped to a first set of OFDM symbols from the OFDM symbols associated with the SRS resource; and
antenna ports included in the second subset is mapped to a second set of OFDM symbols from the OFDM symbols associated with the SRS resource.

27. The terminal of claim 26, wherein
the first set of OFDM symbols comprises a first symbol of the OFDM symbols associated with the SRS resource; and
the second set of OFDM symbol comprises a second symbol of the OFDM symbols associated with the SRS resource.

28. A base station of a communication system comprising:
a transceiver; and
a controller configured to:
receive, from a terminal, capability information associated with an sounding reference signal (SRS) transmission with N antenna ports, wherein Nis greater than or equal to 8;
transmit, to the terminal via higher layer signaling, configuration information for an SRS resource with N antenna ports, wherein the configuration information includes a number of orthogonal frequency division multiplexing (OFDM) symbols associated with the SRS resource;
identify antenna ports mapped to each OFDM symbol of the OFDM symbols associated with the above SRS resource according to a first configuration or a second configuration, wherein one of the first configuration and the second configuration is indicated by the higher layer signaling; and
receive, from the terminal, an SRS in the OFDM symbols associated with the SRS resource based on the antenna ports mapped to each OFDM symbol.

29. The base station of claim 28, wherein the N antenna ports are mapped to each OFDM symbol associated with the SRS resource based on the first configuration being indicated by the higher layer signaling.

30. The base station of claim 28, wherein:
the N antenna ports are partitioned into a first subset and a second subset based on the second configuration being indicated by the higher layer signaling;
the first subset and the second subset comprise different antenna ports;
antenna ports included in the first subset is mapped to a first set of OFDM symbols from the OFDM symbols associated with the SRS resource; and
antenna ports included in the second subset is mapped to a second set of OFDM symbols from the OFDM symbols associated with the SRS resource.
